(19) United States
(12) Patent Application Publication
(10) Pub. No.: US 2022/0115714 A1
(43) Pub. Date: Apr. 14, 2022

(54) BATTERY PACK

(71) Applicant: BLACK & DECKER, INC., New Britain, CT (US)

(72) Inventors: Bryce William Davey, Hampstead, MD (US); Craig Armacost, Parkton, MD (US)

(21) Appl. No.: 17/507,541

(22) Filed: Oct. 21, 2021

Related U.S. Application Data
(63) Continuation-in-part of application No. 17/396,207, filed on Aug. 6, 2021.
Application No. 17/396,207 is a continuation of application No. PCT/US2020/046974, filed on Aug. 19, 2020.
(60) Provisional application No. 62/889,616, filed on Aug. 21, 2019.

(51) Int. Cl. H01M 10/42; H01M 50/211; H01M 50/247; H01M 50/543; H01M 50/533

(52) U.S. Cl. CPC H01M 10/425; H01M 50/211; H01M 50/247; H01M 2010/4271; H01M 50/533; H01M 2220/30; H01M 50/543

(57) ABSTRACT

The battery pack includes a battery pack housing operably connectable to a power tool, at least two pouch-type battery cells disposed in a cell holder, a set of battery pack terminals electrically connectable to a set of power tool terminals of the power tool and electrically connected to the at least two pouch-type battery cells, and a lead collection printed circuit board. The lead collection printed circuit board is configured to be disposed forward of a front wall of the cell holder and positioned at a predetermined distance, along a longitudinal axis of the battery pack, from the set of battery pack terminals. The battery pack also includes a state of charge printed circuit board configured to determine a state of charge of one or more battery cells in the battery pack, and a battery management system printed circuit board configured to control the operation of the battery pack.

### RELATED APPLICATIONS

This application is a continuation-in-part of U.S. patent application Ser. No. 17/396,207, filed Aug. 6, 2021, entitled, “Battery Pack,” which is a continuation of and claims priority to Patent Cooperation Treaty Application No. PCT/US2020/046974, filed Aug. 19, 2020, which in turn claims the benefit of priority from U.S. Provisional Patent Application No. 62/889,616, filed Aug. 21, 2019, the contents all of which are incorporated herein in their entireties by reference.

### TECHNICAL FIELD

The present patent application relates to a battery pack and a method for manufacturing a battery pack. In one implementation, the battery pack includes a plurality of pouch battery cells.

### BACKGROUND

Battery packs for cordless power tools are well known. The battery packs may be integral battery packs or removable battery packs. The battery packs may include rechargeable battery cells, making the battery packs rechargeable battery packs, also referred to as secondary battery packs.

Conventional secondary battery packs for cordless power tools, such as drills, circular saws, reciprocating saws, strings trimmers, leaf blowers, lawn mowers and vacuum cleaners, use cylindrical battery cells, as are well known in the art.

Conventional secondary battery packs for portable electronic devices, such as cellular phones and laptop computers have been known to use pouch type, or simply pouch, battery cells. U.S. Pat. No. 9,040,190 describes an example of such a secondary battery pack using an example pouch battery cell.

As illustrated in FIGS. 1 and 2, the example pouch battery cell 10 includes an electrode assembly 1 and a pouch case 11 in which the electrode assembly 1 is received. The electrode assembly 1 includes a positive electrode plate 2 of which both side surfaces are coated with a positive electrode active material, a separator 3, and a negative electrode plate 4 of which both side surfaces are coated with a negative electrode active material.

Further, a positive electrode tap (or tab) 5 connected with the positive electrode plate 2 is extended from the positive electrode plate 2 by a length (that may be predetermined) to act as a positive electrode, while a negative electrode tap (or tab) 6 connected with the negative electrode plate 4 is extended from the negative electrode plate 4 by a length (that may be predetermined) to act as a negative electrode. Further, the pouch battery cell 10 includes an electrical insulation tape 7 for preventing (or protecting from) an electrical short between the positive electrode and negative electrode taps 5 and 6 and the pouch case 11. Further, the positive electrode and negative electrode taps 5 and 6 are drawn (or led) outwardly through one side of the pouch case 11. Upper and lower insulation plates are further adhered to the top and bottom of the electrode assembly 1, in order to prevent (or protect) the electrode assembly 1 from contacting with the pouch case 11.

The pouch case 11 is composed of a front surface 12 and a rear surface 13 by folding a pouch in half, where the rear surface 13 is connected with the front surface 12. A cavity 14, which receives the electrode assembly 1, is formed on the front surface 12 by a suitable press process. The cavity 14 is defined by a base 12a and four sides 12b of the front surface 12, as illustrated in FIG. 1. The positive electrode plate 2, the separator 3, and the negative electrode plate 4 are arranged respectively and then wound together in one direction to form the electrode assembly 1 with a jelly-roll structure. The electrode assembly 1 with the jelly-roll structure is placed in the front surface 12 of the pouch case 11 in the cavity 14.

In this case, each end of the positive electrode and negative electrode taps 5 and 6, which are drawn outwardly from each of the electrode plates 2 and 4 of the electrode assembly, is exposed to the exterior of the pouch case 11 which seals portions of the positive electrode and negative electrode taps 5 and 6.

The present patent application describes an example battery pack for use with power tools utilizing pouch battery cells and an example method of manufacturing such a battery pack.

### SUMMARY

The present patent application provides improvements in the battery packs.

An aspect of the present patent application includes a battery, comprising a printed circuit board (PCB) having an array of slots extending from a first side of the PCB to a second side of the PCB, the array having a first column of slots and a second column of slots generally parallel to and adjacent to the first column of slots, the slots of the first column of slots being offset from the slots of the second column of slots in a direction of the columns; the first column of slots having at least a first slot and a second slot and the second column of slots having at least a first slot and a second slot; wherein a distance between the first slot of the first column and a second slot of the first column is greater than a distance between the first slot of the second column and the second slot of the second column.

One aspect of the present patent application provides a battery pack. The battery pack includes a battery pack housing operably connectable to a power tool, at least two pouch-type battery cells disposed in the battery pack housing, and a set of battery pack terminals electrically connectable to a set of power tool terminals of the power tool and electrically connected to the at least two pouch-type battery cells. The set of battery pack terminals comprises a first battery pack power terminal and a second battery pack power terminal. The at least two pouch-type battery cells may include a first battery cell and a second battery cell. Each of the first battery cell and the second battery cell has a first tab and a second tab. The first battery pack power terminal is aligned with a first tab of the first battery cell and a second tab of the second battery cell. The second battery pack power terminal is aligned with a second tab of the first battery cell and a first tab of the second battery cell.

In one example embodiment, the first battery pack power terminal is aligned with the first tab of the first battery cell and the second tab of the second battery cell along a first axis in a direction generally perpendicular to a length and a width of the battery cells. In one example embodiment, the second battery pack power terminal is aligned with the second tab of the first battery cell and the first tab of the second battery cell along a second axis in a direction generally perpendicular to the length and the width of the battery cells. In one example embodiment, the first axis and the second axis are generally parallel to each other.

In one example embodiment, the first tab of the first battery cell is a negative tab, the second tab of the first battery cell is a positive tab, the first tab of the second battery cell is a negative tab and the second tab of the second battery cell is a positive tab.

In one example embodiment, the first tab of the first battery cell is a positive tab, the second tab of the first battery cell is a negative tab, the first tab of the second battery cell is a positive tab and the second tab of the second battery cell is a negative tab.

In one example embodiment, a distance between the first axis and the second axis is in a range from approximately 20.7 millimeter (mm) to approximately 25.3 mm. In one example embodiment, the distance between the first axis and the second axis is in a range from approximately 21.8 mm to approximately 24.2 mm. In one example embodiment, the distance between the first axis and the second axis is approximately 23.0 mm.

In one example embodiment, the first tab and the second tab of each of the first and second battery cells are adjacent to each other in a first direction. In one example embodiment, the first direction is generally perpendicular to the first axis and the second axis.

In one example embodiment, the battery pack further comprises a printed circuit board (PCB). In one example embodiment, the PCB includes an array of PCB slots extending from a first side of the PCB to a second side of the PCB. In one example embodiment, the array of PCB slots includes a first column of PCB slots along the first axis and a second column of PCB slots along the second axis and generally parallel to and adjacent to the first column of PCB slots. In one example embodiment, the PCB is a lead collection printed circuit board (LCPCB). In one example embodiment, the array of PCB slots of the LCPCB is configured to receive a corresponding tab of the first and second battery cells.

In one example embodiment, a width, along the first direction, from a first end of the first tab to a second end of the second tab of each of the first and second battery cells is smaller than a width, along the first direction, of the LCPCB.

In one example embodiment, the width, along the first direction, from the first end of the first tab to the second end of the second tab of each of the first and second battery cells is smaller than the width, along the first direction, of the LCPCB by approximately 17.0 mm.

In one example embodiment, the width, along the first direction, from the first end of the first tab to the second end of the second tab of each of the first and second battery cells is in a range from approximately 33.2 mm to approximately 40.6 mm. In one example embodiment, the width, along the first direction, from the first end of the first tab to the second end of the second tab of each of the first and second battery cells is in a range from approximately 35.0 mm to approximately 38.7 mm. In one example embodiment, the width, along the first direction, from the first end of the first tab to the second end of the second tab of each of the first and second battery cells is approximately 36.9 mm.

In one example embodiment, the width, along the first direction, of the LCPCB is in a range from approximately 48.6 mm to approximately 59.4 mm. In one example embodiment, the width, along the first direction, of the LCPCB is in a range from approximately 51.3 mm to approximately 56.7 mm. In one example embodiment, the width, along the first direction, of the LCPCB is approximately 54.0 mm.

In one example embodiment, one of the first battery pack power terminal and the second battery pack power terminal is a positive power terminal and the other of the first battery pack power terminal and the second battery pack power terminal is a negative power terminal.

Another aspect of the present patent application provides a battery pack. The battery pack includes a battery pack housing operably connectable to a power tool, a cell holder comprising at least a front wall and a rear wall, at least two pouch-type battery cells disposed in the cell holder; a set of battery pack terminals electrically connectable to a set of power tool terminals of the power tool and electrically connected to the at least two pouch-type battery cells, and a lead collection printed circuit board (LCPCB). The at least two pouch-type battery cells includes a first battery cell and a second battery cell. Each of the first battery cell and the second battery cell has a first tab and a second tab. The LCPCB has an array of LCPCB slots extending from a first side of the LCPCB to a second side of the LCPCB. The tabs of the first battery cell and the second battery cell are received in the array of LCPCB slots. The LCPCB is configured to be disposed forward of the front wall of the cell holder and positioned at a predetermined distance, along a longitudinal axis of the battery pack, from the battery pack terminals. In one example embodiment, the predetermined distance is in a range from approximately 3.7 millimeters (mm) to approximately 4.5 mm. In one example embodiment, the predetermined distance is in a range from approximately 3.9 mm to approximately 4.3 mm. In one example embodiment, the predetermined distance is approximately 4.1 mm.

In one example embodiment, the battery pack also includes a battery management system printed circuit board (BMSPCB) that is configured to control the operation of the battery pack. In one example embodiment, BMSPCB includes a first end portion and a second end portion opposing the first end portion. In one example embodiment, the set of battery pack terminals are disposed on the first end portion of the BMSPCB.

In one example embodiment, the LCPCB is positioned at a second predetermined distance, along the longitudinal axis of the battery pack, from the first end portion of the BMSPCB. In one example embodiment, the second predetermined distance is approximately equivalent to the predetermined distance. In one example embodiment, the second predetermined distance is in a range from approximately 3.7 mm to approximately 4.5 mm. In one example embodiment, the second predetermined distance is in a range from approximately 3.9 mm to approximately 4.3 mm. In one example embodiment, the second predetermined distance is approximately 4.1 mm. In one example embodiment, the second predetermined distance is different from the predetermined distance.

In one example embodiment, the battery pack further includes a state of charge printed circuit board (SOCPCB) that is configured to determine a state of charge of one or more of the battery cells in the battery pack. In one example embodiment, the SOCPCB is configured to be disposed forward of the LCPCB and the front wall of the cell holder.

In one example embodiment, the SOCPCB and the LCPCB are generally parallel to each other and are separated by a predetermined distance from each other. In one example embodiment, the predetermined distance between the SOCPCB and the LCPCB is in a range from approximately 11.9 mm to approximately 14.5 mm. In one example embodiment, the predetermined distance between the SOCPCB and the LCPCB is in a range from approximately 12.6 mm to approximately 13.9 mm. In one example embodiment, the predetermined distance between the SOCPCB and the LCPCB is approximately 13.2 mm.

Yet another aspect of the present patent application provides a battery pack. The battery pack includes a battery pack housing operably connectable to a power tool, at least two pouch-type battery cells disposed in the battery pack housing, a lead collection printed circuit board (LCPCB), a state of charge printed circuit board (SOCPCB) configured to determine a state of charge of one or more battery cells in the battery pack; and a battery management system printed circuit board (BMSPCB) configured to control the operation of the battery pack. The at least two pouch-type battery cells include a first battery cell and a second battery cell. Each of the first battery cell and the second battery cell has a first tab and a second tab. The LCPCB has an array of LCPCB slots extending from a first side of the LCPCB to a second side of the LCPCB. The tabs of the first battery cell and the second battery cell are received in the array of LCPCB slots.

In one example embodiment, the SOCPCB is configured to be disposed forward of the LCPCB.

In one example embodiment, the SOCPCB and the LCPCB are generally parallel to each other and are perpendicular to the BMSPCB.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one example embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one example embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 is an isometric view of a conventional pouch battery cell prior to sealing a pouch case.

FIG. 2 is an isometric view of the conventional pouch battery cell of FIG. 1 after sealing the pouch case.

FIG. 3 is an isometric view of an example battery pack, according to an embodiment of the present patent application.

FIG. 4 is another isometric view of the example battery pack of FIG. 1.

FIG. 5 is another isometric view of the example battery pack of FIG. 1.

FIG. 6 is a first side elevation view of the example battery pack of FIG. 1.

FIG. 7 is a second side elevation view of the example battery pack of FIG. 1.

FIG. 8 is a top plan view of the example battery pack of FIG. 1.

FIG. 9A is a first isometric view of a pair of example pouch cells, according to an embodiment of the present patent application.

FIG. 9B is a second isometric view of the pair of example pouch cells of FIG. 9A.

FIG. 9C is a first side elevation view of the pair of example pouch cells of FIG. 9A.

FIG. 9D is a second side elevation view of the pair of example pouch cells of FIG. 9A.

FIG. 10 is an exploded isometric view of the example battery pack of FIG. 3.

FIG. 11A is a front elevation view of an example core pack of the example battery pack of FIG. 3.

FIG. 11B is a first side elevation view of the example core pack of FIG. 11A.

FIG. 11C is a second side elevation view of the example core pack of FIG. 11A.

FIG. 12A is a section view of the example core pack of FIG. 11A taken along section line A-A.

FIG. 12B is a section view of the example core pack of FIG. 11A taken along section line B-B.

FIG. 13 is an elevation view of a portion of an example cell holder of the core pack of FIG. 11A.

FIG. 14 is a side view of the example cell holder of FIG. 13 with a side wall removed.

FIG. 15A is a cross-section view of a first portion of a first rib of the cell holder of FIG. 13 and FIG. 15B is a cross-section view of a second portion of the first rib of the cell holder of FIG. 13.

FIG. 16A is a cross-section view of a first portion of a second rib of the cell holder of FIG. 13 and FIG. 16B is a cross-section view of a second portion of the second rib of the cell holder of FIG. 13.

FIGS. 17A and 17B are isometric views of the example cell holder of FIG. 14.

FIGS. 18A and 18B are isometric views of the example cell holder of FIG. 14 after a first step of an example manufacturing process of the core pack of FIG. 11A.

FIGS. 19A and 19B are isometric views of the example cell holder of FIG. 14 after a second step of the example manufacturing process of the core pack of FIG. 11A.

FIGS. 20A and 20B are isometric views of the example cell holder of FIG. 14 after a third step of the example manufacturing process of the core pack of FIG. 11A.

FIG. 21A is a first isometric view of two pouch battery cells after being inserted into the cell holder of FIG. 13.

FIG. 21B is a second isometric view of the two pouch battery cells of FIG. 21A.

FIG. 21C is a first side elevation view of the two pouch battery cells of FIG. 21A.

FIG. 21D is a second side elevation view of the two pouch battery cells of FIG. 21A.

FIGS. 22A and 22B are isometric views of the example cell holder of FIG. 14 after a fourth step of the example manufacturing process of the core pack of FIG. 11A.

FIGS. 23A and 23B are isometric views of the example cell holder of FIG. 14 after a fifth step of the example manufacturing process of the core pack of FIG. 11A.

FIGS. 24A and 24B are isometric views of the example cell holder of FIG. 14 after a sixth step of the example manufacturing process of the core pack of FIG. 11A.

FIGS. 25A and 25B are isometric views of the example cell holder of FIG. 14 after a seventh step of the example manufacturing process of the core pack of FIG. 11A.

FIGS. 26A and 26B are isometric views of the example cell holder of FIG. 14 after an eighth step of the example manufacturing process of the core pack of FIG. 11A.

FIG. 27 is an elevation view of an example printed circuit board according to an embodiment of the present patent application.

FIG. 28A is an elevation view of the printed circuit board mounted on the cell holder of FIG. 14 in a ninth step of the example manufacturing process of the core pack of FIG. 11A.

FIGS. 28B and 28C are isometric views of the example cell holder of FIG. 14 after the ninth step of the example manufacturing process of the core pack of FIG. 11A.

FIGS. 28D and 28E are first side and second side elevation views of the example cell holder of FIG. 14 after the ninth step of the example manufacturing process of the core pack of FIG. 11A.

FIG. 28F is a detail elevation view of FIG. 28D.

FIGS. 29A and 29B are isometric views of the example cell holder of FIG. 14 after a tenth step of the example manufacturing process of the core pack of FIG. 11A.

FIGS. 29C and 29D are first side and second side elevation views of the example cell holder of FIG. 14 after the eleventh step of the example manufacturing process of the core pack of FIG. 11A.

FIGS. 30A and 30B are isometric views of the example cell holder of FIG. 14 after an eleventh step of the example manufacturing process of the core pack of FIG. 11A.

FIGS. 31A-31L are isometric views of an alternate example manufacturing process of an alternate example cell holder of the core pack of FIG. 11A.

FIG. 32 is a side, section elevation view of an alternate embodiment of a core pack, in accordance with the present disclosure.

FIG. 33 is an isometric view of an example battery pack, according to another embodiment of the present patent application.

FIG. 34 is another isometric view of the example battery pack of FIG. 33.

FIG. 35 is another isometric view of the example battery pack of FIG. 33.

FIG. 36 is a first side elevation view of the example battery pack of FIG. 33.

FIG. 37 is a second side elevation view of the example battery pack of FIG. 33.

FIG. 38 is a top plan view of the example battery pack of FIG. 33.

FIG. 39A is an isometric, section view taken along line C-C of FIG. 38.

FIG. 39B is an isometric, section view taken along line D-D of FIG. 38.

FIG. 39C is a side, elevation section view taken along line D-D of FIG. 38.

FIG. 40 is an exploded isometric view of the example battery pack of FIG. 33.

FIG. 41 is a front elevation view of an example core pack of the example battery pack of FIG. 33, where some components of the battery pack are not shown for the sake of clarity and to better illustrate the other components of the battery pack.

FIGS. 42A-C are various views of an example core pack of the example battery pack of FIG. 33, where some components of the battery pack are not shown for the sake of clarity and to better illustrate the other components of the battery pack.

FIG. 43 is a top isometric view of an example core pack of the example battery pack of FIG. 33, where some components of the battery pack are not shown for the sake of clarity and to better illustrate the other components of the battery pack.

FIG. 44a is a first side elevation view of an example core pack of the example battery pack of FIG. 33, where some components of the battery pack are not shown for the sake of clarity and to better illustrate the other components of the battery pack. FIG. 44B is a second side elevation view of an example core pack of the example battery pack of FIG. 33, where some components of the battery pack are not shown for the sake of clarity and to better illustrate the other components of the battery pack.

FIG. 45 is a first side, elevation section view taken along line E-E of FIG. 41, where some components of the battery pack are not shown for the sake of clarity and to better illustrate the other components of the battery pack.

FIG. 46 is a second side, elevation section view taken along line F-F of FIG. 41, where some components of the battery pack are not shown for the sake of clarity and to better illustrate the other components of the battery pack.

FIG. 47 is a front view of an example state of charge printed circuit board (SOCPCB) of the example battery pack of FIG. 33, where some components of the battery pack are not shown for the sake of clarity and to better illustrate the other components of the battery pack.

FIG. 48 is a rear view of the example SOCPCB of the example battery pack of FIG. 33, where some components of the battery pack are not shown for the sake of clarity and to better illustrate the other components of the battery pack.

FIG. 49 is a front isometric view of the example SOCPCB of the example battery pack of FIG. 33, where some components of the battery pack are not shown for the sake of clarity and to better illustrate the other components of the battery pack.

FIG. 50 is a rear isometric view of the example SOCPCB of the example battery pack of FIG. 33, where some components of the battery pack are not shown for the sake of clarity and to better illustrate the other components of the battery pack.

FIG. 51 is a front elevation view of the example corepack of FIG. 41 without the example SOCPCB.

FIG. 52 is a partial, side isometric view of the example corepack of FIG. 51, with a side wall removed from illustration purposes.

FIG. 53 is another partial side isometric view of the example corepack of FIG. 51.

FIG. 54 is another partial side isometric view of the example corepack of FIG. 51.

FIG. 55 is an elevation view of a portion of an example cell holder of the core pack of FIG. 41.

FIG. 56 is a side view of the example cell holder of FIG. 55 with a side wall removed.

FIGS. 57A and 57B are isometric views of the example cell holder of FIG. 56 after a first step of an example manufacturing process of the example battery pack of FIG. 33.

FIGS. 58A and 58B are isometric views of the example cell holder of FIG. 56 after a second step of an example manufacturing process of the battery pack of FIG. 33.

FIGS. 59A and 59B are isometric views of the example cell holder of FIG. 56 after a third step of the example manufacturing process of the battery pack of FIG. 33.

FIGS. 60A and 60B are isometric views of the example cell holder of FIG. 56 after a fourth step of the example manufacturing process of the battery pack of FIG. 33.

FIG. 61A is a first isometric view of two pouch battery cells after being inserted into the cell holder of FIG. 55.

FIG. 61B is a second isometric view of the two pouch battery cells of FIG. 21A.

FIG. 61C is a first side elevation view of the two pouch battery cells of FIG. 21A.

FIG. 61D is a second side elevation view of the two pouch battery cells of FIG. 21A.

FIGS. 62A and 62B are isometric views of the example cell holder of FIG. 56 after a fifth step of the example manufacturing process of the battery pack of FIG. 33.

FIGS. 63A and 63B are isometric views of the example cell holder of FIG. 56 after a sixth step of the example manufacturing process of the battery pack of FIG. 33.

FIGS. 64A and 64B are isometric views of the example cell holder of FIG. 56 after a seventh step of the example manufacturing process of the battery pack of FIG. 33.

FIGS. 65A and 65B are isometric views of the example cell holder of FIG. 56 after an eighth step of the example manufacturing process of the battery pack of FIG. 33.

FIGS. 66A and 66B are isometric views of the example cell holder of FIG. 56 after a ninth step of the example manufacturing process of the battery pack of FIG. 33.

FIGS. 67A and 67B are isometric views of the example cell holder of FIG. 56 after a tenth step of the example manufacturing process of the battery pack of FIG. 33.

FIG. 68 is an isometric view of the example cell holder of FIG. 56 after an eleventh step of the example manufacturing process of the battery pack of FIG. 33.

FIG. 69 is an isometric view of the example cell holder of FIG. 56 after a twelfth step of the example manufacturing process of the battery pack of FIG. 33.

FIG. 70 is an isometric view of the example cell holder fully populated with battery cells.

FIG. 71A is a front elevation view, FIG. 71B is a rear elevation view, FIG. 71C is a front isometric view, and FIG. 71D is a rear isometric view of an example lead collection printed circuit board (LCPCB), according to an embodiment of the present patent application.

FIG. 72A is a front elevation, FIG. 72B is a rear elevation, FIG. 72C a rear isometric view, FIG. 72D is a front isometric view, 72E is a side elevation view and FIG. 72F is a section view along line G-G of FIG.—of an example fuse of the example core pack of FIG. 41, according to an example embodiment of the present patent application.

FIG. 73A is a front elevation, FIG. 73B is a rear elevation, FIG. 73C a front isometric view, and FIG. 73D is a rear isometric view of the example fuse mounted to the example LCPCB of the example core pack of FIG. 41, according to an example embodiment of the present patent application.

FIG. 74A is a front elevation view and FIG. 74B is a rear elevation view of the example LCPCB and an example battery management system printed circuit board (BMSPCB), according to an example embodiment of the present application.

FIG. 75 is a detail isometric view of the LCPCB of FIG. 74A.

FIG. 76A is an elevation view of the LCPCB and the BMSPCB mounted on the cell holder of FIG. 69 to form the example core pack of the example manufacturing process of the battery pack of FIG. 33.

FIGS. 76B and 76C are isometric views of the example core pack of FIG. 76A.

FIGS. 76D and 76E are first side and second side elevation views of the example core pack FIG. 76A.

FIG. 77 is an isometric view of the example core pack of FIG. 76A after another step of the example manufacturing process of the battery pack of FIG. 33.

FIG. 78 is an isometric view of the example corepack of FIG. 77 with a side wall removed for illustration purposes.

FIG. 79 is a side elevation view of the example core pack of FIG. 78.

FIG. 80 is an isometric view of the example core pack of FIG. 79.

FIG. 81 is an isometric view of the example core pack of FIG. 77.

FIG. 82 is an isometric view of the example corepack of FIG. 81 with a side wall removed for illustration purposes.

FIG. 83 is an isometric view of another step of the example manufacturing process of the battery pack of FIG. 33.

FIG. 84 is an isometric view of another step of the example manufacturing process of the battery pack of FIG. 33.

FIGS. 85-91 show a power tool and a battery pack according to an example embodiment of the present patent application, wherein FIGS. 85-87 show various side views of the power tool and the battery pack and FIGS. 88-91 show various isometric views of the power tool and the battery pack.

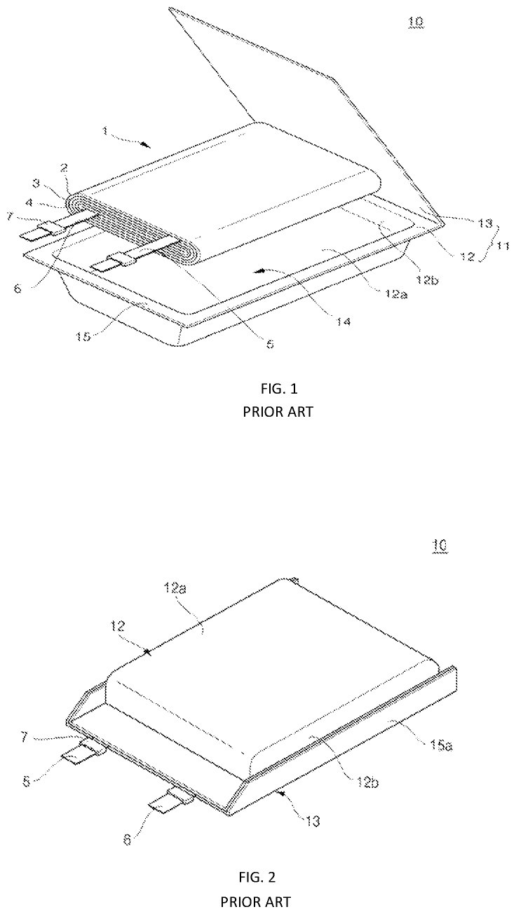

### DETAILED DESCRIPTION

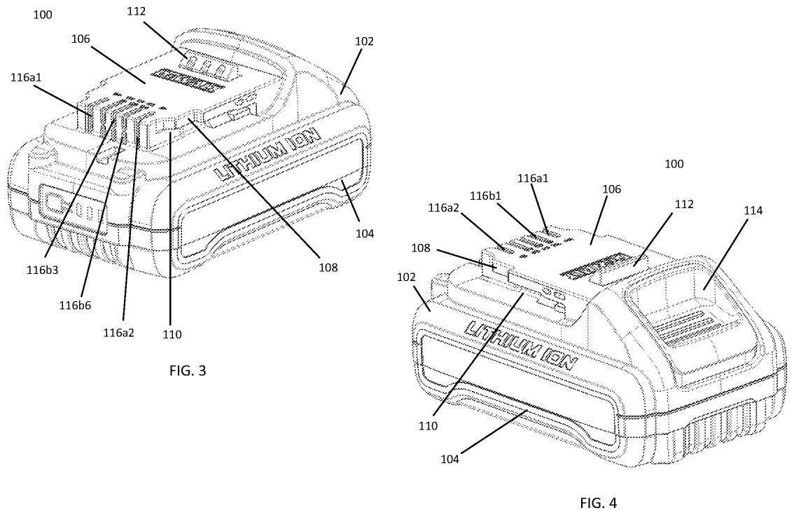

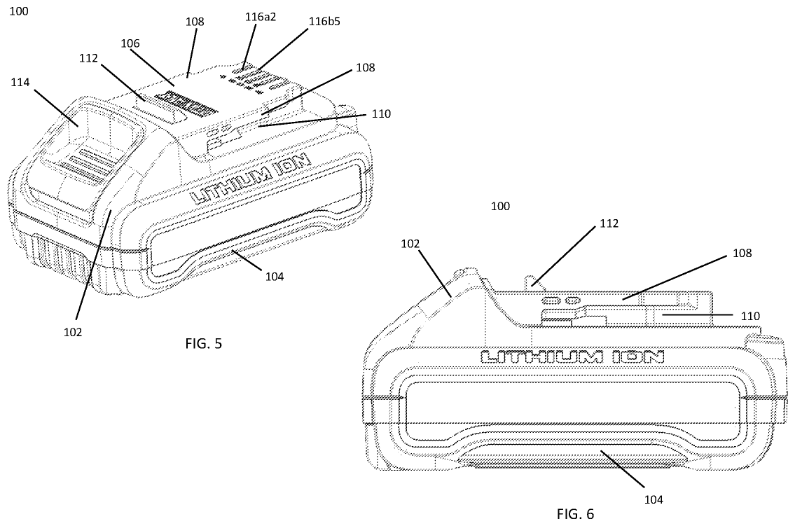

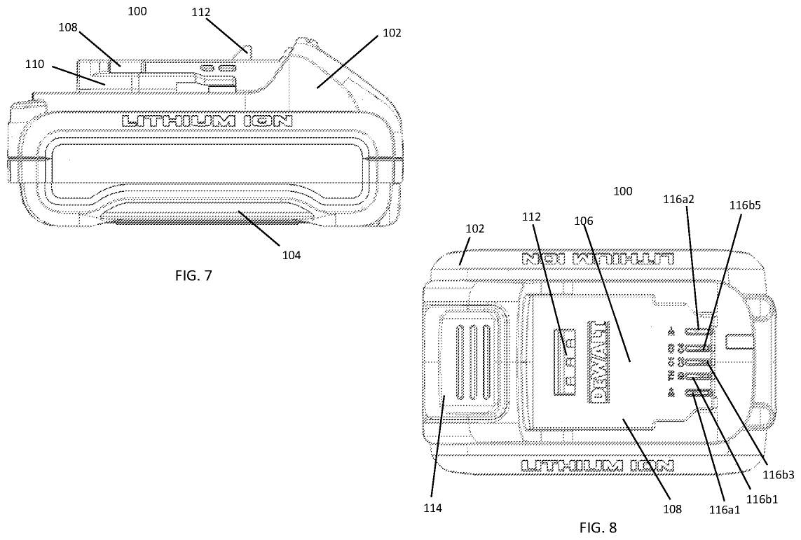

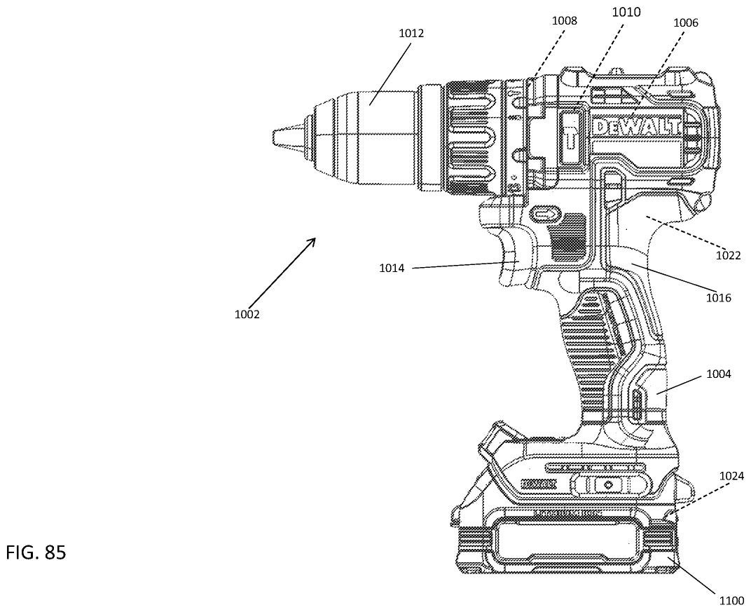

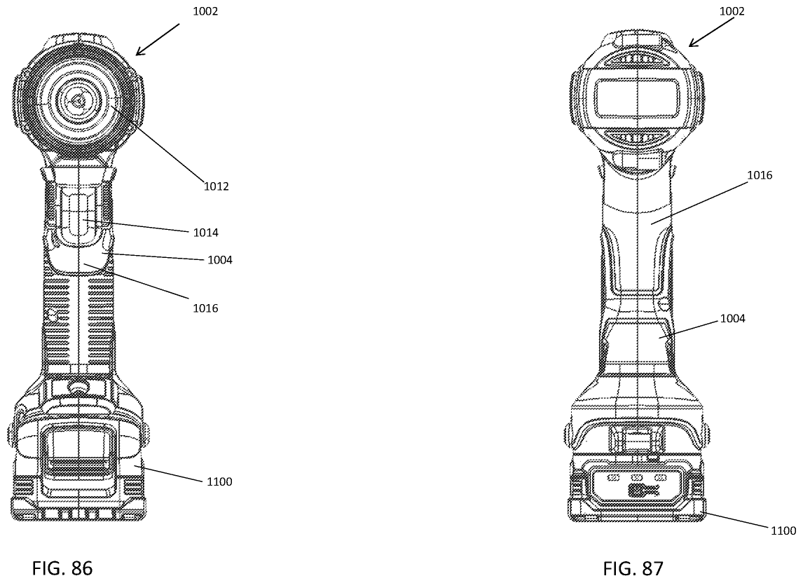

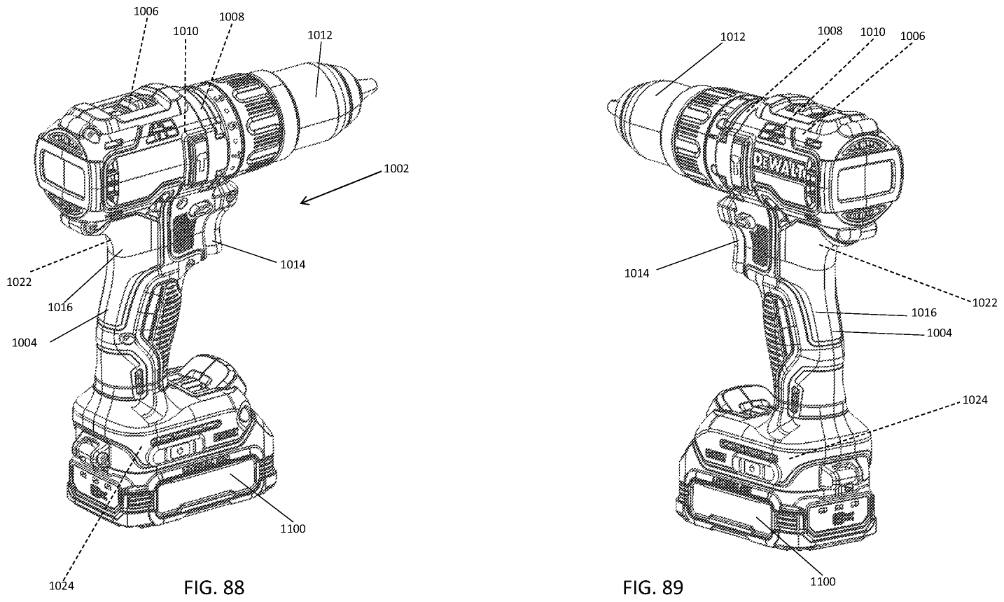

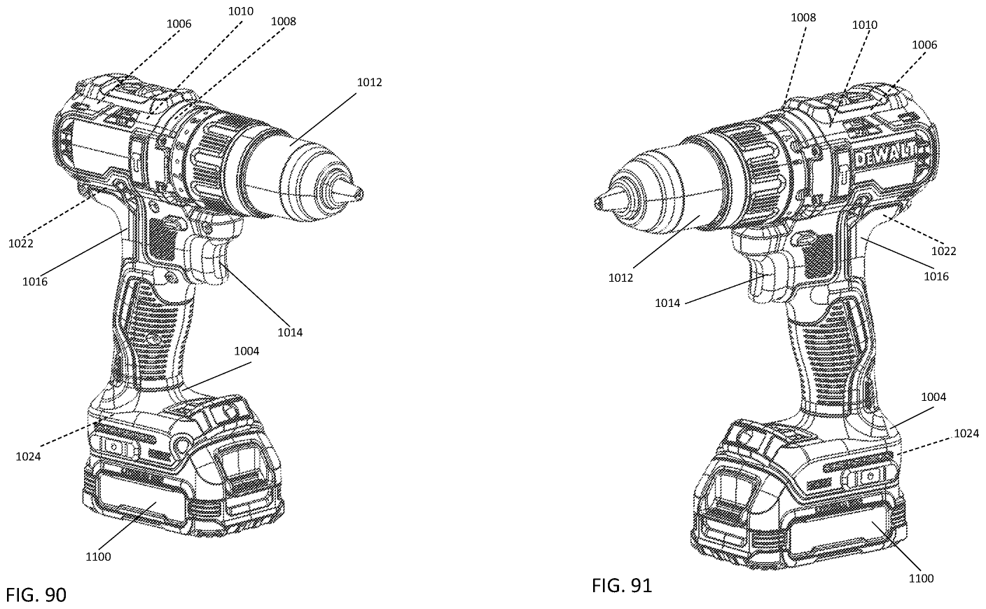

Referring to FIGS. 3-8, there is disclosed an example embodiment of a battery pack 100 according to the present patent application. The battery pack 100 includes a housing. As is well known in the art the housing may be constructed of a plastic material. The housing may include an upper portion or housing 102 and lower portion or housing 104. The upper portion 102 and the lower portion 104 may be connected by screws or other fastening means, as is well known in the art. When the upper portion 102 and the lower portion 104 are joined, an interior cavity is formed. The battery pack 100 may include an interface 106 for mechanically and electrically coupling the battery pack 100 to a power tool 1002 (as shown in FIGS. 85-91) that is to be powered by the battery pack 100. The interface 106 may include a set of rails 108 and a set of grooves 110. In the illustrated example, the battery pack 100 includes a pair of rails 108 (one rail on each side of the battery pack 100) and a pair of grooves 110 (one on each side of the battery pack 100). The grooves 110 receive corresponding rails of the power tool 1002 when the battery pack 100 slidingly engages/couples with the power tool 1002.

The interface 106 also includes a latch 112 that is configured to move into and out of the cavity upon depression of a user actuated latch button 114. The latch 112 is configured to be received in a catch of the power tool 1002 when the battery pack 100 is fully engaged with/coupled to the power tool 1002. In order to disengage/decouple the battery pack 100 from the power tool 1002, the user actuated latch button 114 is depressed to release the latch 114 from the power tool catch. The battery pack 100 can then be removed from the power tool 1002.

The interface 106 also includes a set of slots 116 in the upper housing 102. The slots 116 provide an opening in the upper housing 102 for terminals of the power tool 1002 to mate with terminals of the battery pack 100. These battery pack terminals are discussed in more detail below. The set of slots 116 includes a first subset of slots 116a which provide access to power terminals of the battery pack 100 and a second subset of slots 116b which provide access to sense (or signal) terminals of the battery pack 100. The first subset of slots 116a may include a first slot 116a1 for access to a positive battery pack power terminal and a second slot 116a2 for access to a negative battery pack power terminal. The second subset of slots 116b may include six slots 116b1, 116b2, 116b3, 116b4, 116b5, 116b6 for access to battery pack sense terminals including a thermistor (TH) terminal, an identification (ID), a first intercell terminal (C1), a second intercell terminal (C2), a third intercell terminal (C3) and a fourth intercell terminal (C4), respectively—discussed in more detail below.

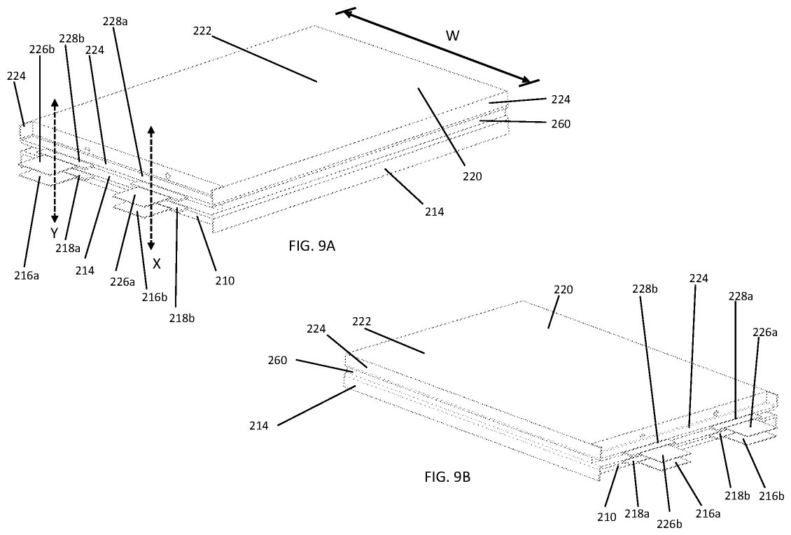

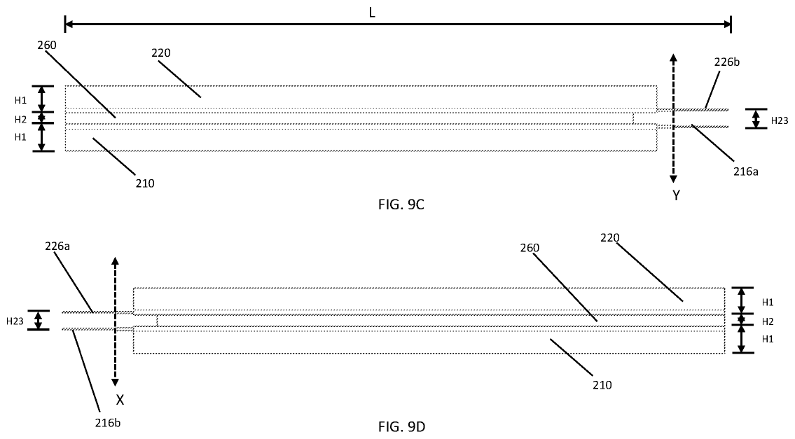

Referring to FIGS. 9A, 9B, 9C, and 9D, there is illustrated a pair of example pouch cells 210, 220. The illustrated pouch cells 210, 220 may be referred to as single cup pouch cells. The pouch cells 210, 220 are shown in a back-to-back or opposed to each other. The first pouch cell 210 may include a first pouch case (not shown). Similarly, the second pouch cell 220 may include a second pouch case 222. The first pouch case may include a first heat seal 214 along three sides of the first pouch case. Similarly, the second pouch case 222 may include a second heat seal 224 along three sides of the second pouch case 222. The first pouch cell 210 may include a first (positive) cell tab 216a and a second (negative) cell tab 216b. The second pouch cell 210 may similarly include a first (positive) cell tab 226a and a second (negative) cell tab 226b. The first pouch cell 210 may include a secondary heat seal 218a about the first cell tab 216a between the first cell tab 216a and the heat seal 214 and a secondary heat seal 218b about the second cell tab 216b between the second cell tab 216a and the heat seal 214.

Similarly, the second pouch cell 220 may include a secondary heat seal 228a about the first cell tab 226a between the first cell tab 226a and the heat seal 224 and a secondary heat seal 228b about the second cell tab 226b between the second cell tab 226a and the heat seal 224.

An insulating material 260 may be positioned between the first pouch cell 210 and the second pouch cell 220. The insulating material 260 may provide thermal insulation between the first pouch cell 210 and the second pouch cell 220. The insulating material 260 may also have compression properties to allow the first pouch cell 210 and the second pouch cell 220 to expand during charge and/or discharge of the cells. The insulating material 260, may be, for example, a polyurethane or silicone foam of the closed or open cell variety, or a ceramic textile.

As illustrated in FIGS. 9A, 9B,9C and 9D, when the pouch cells 210, 220 are arranged back-to-back, the positive tab 216a of the first pouch cell 210 is aligned with the negative tab 226b of the second pouch cell 220 in a direction perpendicular to the length and width of the cells and the negative tab 216b of the first pouch cell 210 is aligned with the positive tab 226a of the second pouch cell 220 in a direction perpendicular to the length and width of the cell.

In the context of the present disclosure, the tabs of the same cell are considered aligned in a row (and are adjacent to each other) and the tabs of different cells that are aligned are in a column. Furthermore, the tabs of adjacent cells that are aligned in a column are denoted as adjacent tabs. In other words, the positive tab 216a of the first pouch cell 210 is adjacent to the negative tab 216b of the first pouch cell 210 in a first direction, and the positive tab 226a of the second pouch cell 220 is adjacent to the negative tab 226b of the second pouch cell 220 in the first direction, and the positive tab 216a of the first pouch cell 210 is adjacent to the negative tab 226b of the second pouch cell 220 in a second direction (generally perpendicular to the first direction) and the negative tab 216b of the first pouch cell 210 is adjacent to the positive tab of the second pouch cell 220 in the second direction. The positive tab 216a of the first pouch cell 210 is not considered adjacent to the positive tab 226a of the second pouch cell 220 and the negative tab 216b of the first pouch cell 210 is not considered adjacent to the negative tab 226b of the second pouch cell 220.

As illustrated in FIGS. 9C and 9D, there is a distance (height) H23 between centerlines of adjacent tabs 216a, 226b and adjacent tabs 216b, 226a before they are placed in a cell holder (as described below).

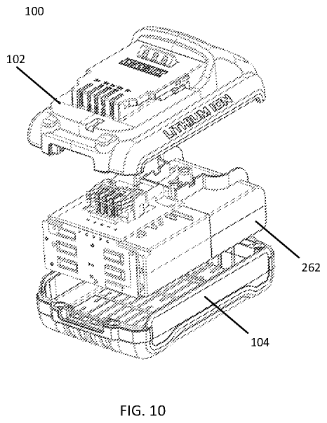

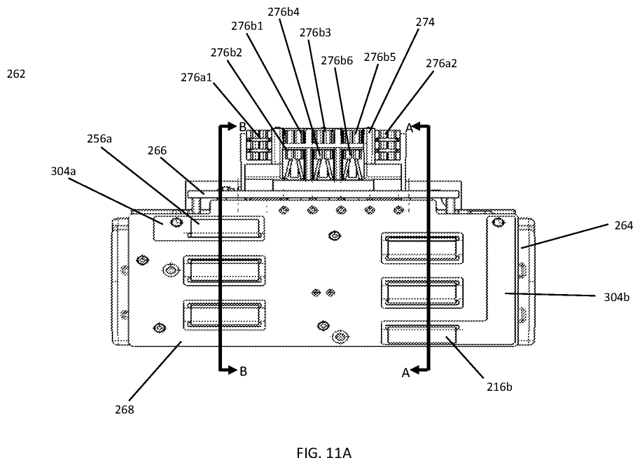

Referring to FIG. 10, there is illustrated an exploded view of an example battery pack 100 according to the present patent application. The battery pack 100 includes a core pack 262 (described in more detail below). The core pack 262 resides in the cavity created by the joining of the upper housing 102 and the lower housing 104.

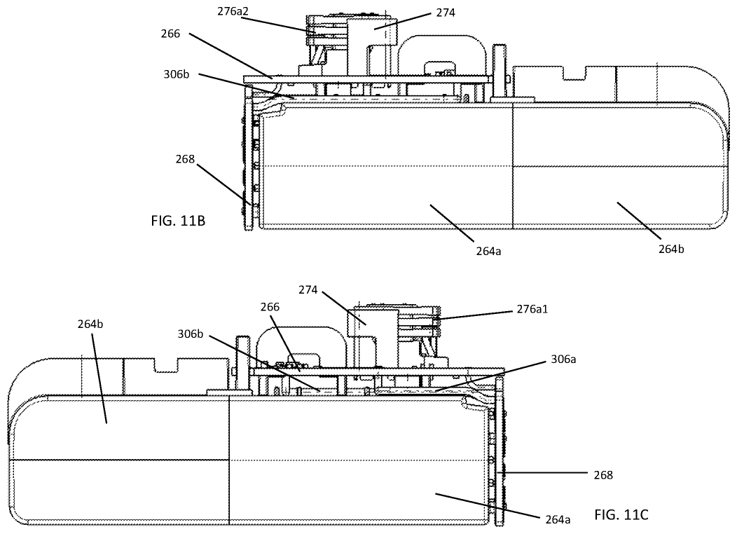

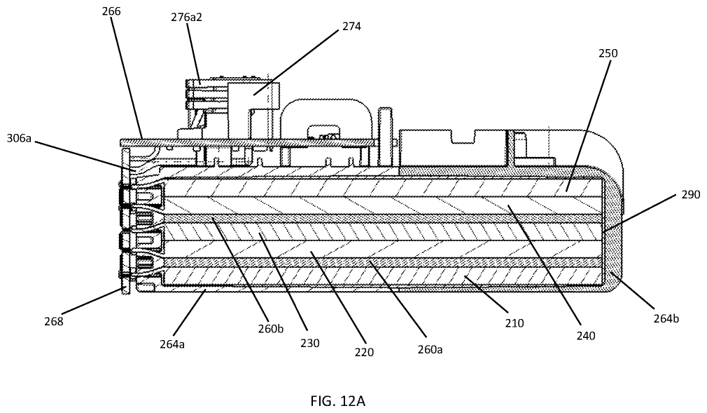

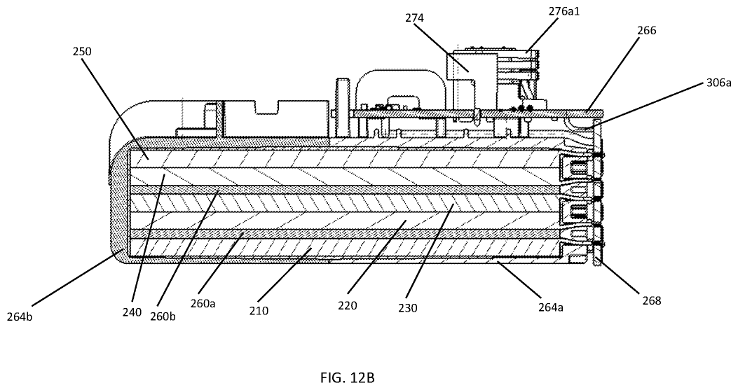

Referring to FIGS. 11A, 111B, 11C, 12A, and 12B, there is illustrated an example core pack 262, in accordance with the present disclosure. FIG. 11A illustrates a front elevation view of the core pack 262. FIG. 11B illustrates a first side elevation view of the core pack 262. FIG. 11C illustrates a second side elevation view of the core pack 262. FIG. 12A illustrates a first section view of the core pack 262 taken along section line A-A of FIG. 11A and FIG. 12B illustrates a second section view of the core pack 262 taken along section line B-B of FIG. 11A.

The core pack 262 may include a cell holder 264. The cell holder 264 may include a first, front or forward portion (or housing) 264a and a second, rear or rearward portion (or housing) 264b. The core pack 262 may include a first or primary printed circuit board (PCB) 266 and a second or secondary PCB 268. In alternate embodiments, the printed circuit boards may be replaced by other types of circuits, including but not limited to flexible printed circuits. The core pack 262 may include a terminal block 274. The terminal block 274 may be mounted to the primary PCB 266. The terminal block 274 may hold a set of battery pack terminals 276 in a fixed relation to each other. The set of battery pack terminals 276 may include a (first) subset of power terminals 276a and a (second) subset of sense (or signal) terminals 276b. The subset of power terminals 276a may include a (first) positive power terminal 276a1 and a (second) negative power terminal 276a2. The subset of sense terminals 276b may include a thermistor terminal (TH) 276b1, an identification terminal (ID) 276b1, a first intercell terminal (C1) 276b3, a second intercell terminal (C2) 276b4, a third intercell terminal (C3) 276b5, and a fourth intercell terminal (C4) 276b6.

The primary PCB 266 may include other components mounted thereto or incorporated therein.

The core pack 262 may also include a set of pouch battery cells 200. In the illustrated embodiment, the core pack 262 includes a set of five pouch battery cells 210, 220, 230, 240, 250 and two insulating layers 260a and 260b. Each battery cell of the set of battery cells 200 are as described above. Alternate embodiments of the core pack 262 may include more or fewer pouch battery cells, depending upon the requirements of the battery pack or an associated tool platform. The features and advantages of the instant disclosure are not limited by the number of battery cells in the core pack. In addition, the battery cells may be of a double cup configuration instead of the single cup configuration illustrated in the figures.

In the illustrated, example embodiment, the cell holder 264 may include a first, front (or forward) portion (or housing) 264a and a second, rear (or rearward) portion (or housing) 264b. The first portion and the second portion mate to form the cell holder housing at a mating (parting) line. The cell holder 264 may have a generally rectangular box shape having six walls. The cell holder 264 may include a front (forward) wall, a rear (rearward) wall, a top wall, a bottom wall, a first side wall and a second side wall. Each wall may include an outer surface and an inner surface. The inner surface of the walls forms a cavity of the cell holder.

The cell holder housing may have other generally similar shapes and still fall within the scope of the present patent application.

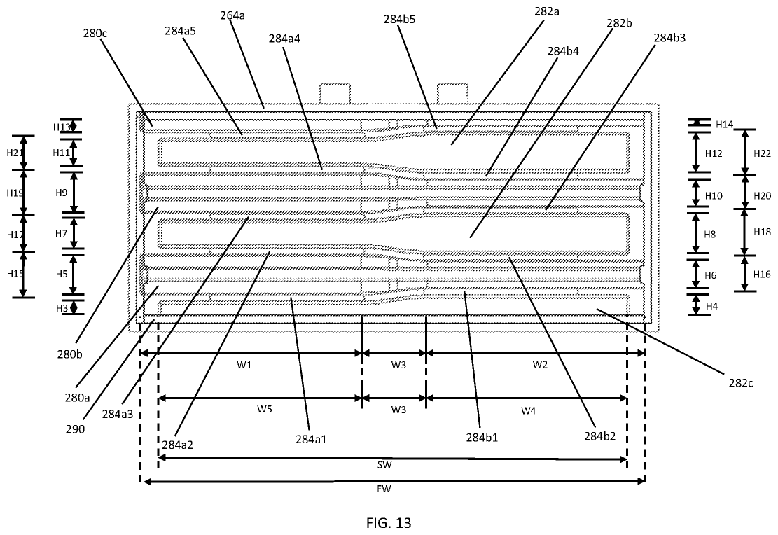

As illustrated in FIGS. 13-18B, an example embodiment of the cell holder 264 may include an array/system of ribs extending from the inner surface of the front wall into the cell holder cavity. The ribs may be formed integrally with the cell holder front wall (in other words formed when the cell holder front portion is created) or the ribs may be discrete elements that are attached to the front wall.

The example array of ribs may include a first set (system) of ribs 280 of a first type and a second set (system) of ribs 282 of a second type. The ribs of the first set of ribs 280 are interposed with the ribs of the second set of ribs 282 in an alternating fashion. As illustrated in FIGS. 13, 14, 15A, and 15B, the cell holder 264 includes a first rib 280a, a second rib 280b, and a third rib 280c of the first set of ribs 280 (the third rib 280c being a ½ rib) and a first rib 282a, a second rib 282b, and a third rib 282c of the second set of ribs 282 (the third rib 282c being a ½ rib). The first set first rib 280a is positioned between the second set third rib 282c and the second set second rib 282b, the first set second rib 280a is positioned between the second set second rib 282b and the second set first rib 282b. The second set first rib 282a is positioned between the first set second rib 280b and the first set third rib 280c and the second set second rib 282b is positioned between the first set first rib 280a and the first set second rib 280b.

The first set of ribs 280 have a width (FW). For a portion (W1) of the width FW, the first rib 280a of the first set of ribs 280 has a height (H5), the second rib 280b of the first set of ribs 280 has a height (H9), and the third rib 280c of the first set of ribs 280 has a height (H13). The height H5 may be equal to the height H9 and two times the height H13. For a portion (W2) of the width FW, the first rib 280a of the first set of ribs 280 has a height (H6), the second rib 280b of the first set of ribs 280 has a height (H10), and the third rib 280c has a height (H14).

The height H6 may be equal to the height H10 and two times the height H14. The heights H5, H9, H13 are greater than the heights H6, H10, H14, respectively. For a portion (W3) of the width FW, the first set of ribs 280 transition from the heights H5, H9, H13 to the heights H6, H10, H14, respectively.

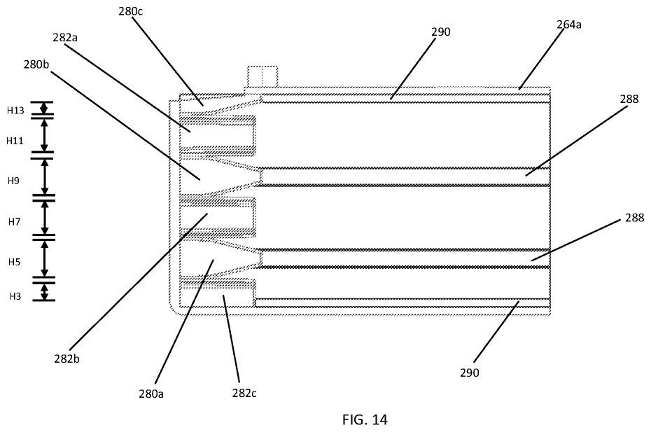

As illustrated in FIGS. 14, 15A, and 15B, the first set of ribs 280 have a tapered cross-section. FIG. 15A illustrates a cross-section view of the portion 280′ of ribs 280a, 280b, along the width W1. FIG. 15B illustrates a cross-section view of the portion 280″ of ribs 280a, 280b along the width W2. As illustrated, the ribs 280a, 280b have a height H5, H9 along the width W1. Each rib 280a, 280b along the width W1 includes a first tapered section and a second tapered section. The first and second tapered sections extend into the cell holder cavity to a rearward facing surface. The rearward facing surface has a height H2. This height H2 is the same as the foam element 260 between cells 210 and 220 and the foam element 260 between cells 230 and 240. The first and second tapered sections/walls have a height H23. As illustrated, the ribs 280a, 280b have a height H6, H10 along the width W2. Each rib 280a, 280b along the width W2 includes a third tapered section and a fourth tapered section. The third and fourth tapered sections extend into the cell holder cavity to a rearward facing surface. The rearward facing surface has a height H2. This height H2 is the same as the foam element 260 between cells 210 and 220 and the foam element 260 between cells 230 and 240. The third and fourth tapered sections/walls have a height H24.

The second set of ribs 282 have a width (SW). For a portion (W4) of the width SW, the first rib 282a of the second set of ribs 282 has a height (H12), the second rib 282b of the second set of ribs 282 has a height (H8), and the third rib 282c of the second set of ribs 282 has a height (H4). The height H12 may be equal to the height H8 and two times the height H4. For a portion (W5) of the width SW, the first rib 282a of the second set of ribs 282 has a height (H11), the second rib 282b of the second set of ribs 28 has a height (H7), and the third rib 282c of the second set of ribs 282 has a height (H3). The height H11 may be equal to the height H7 and two times the height H3. The heights H12, H8, H4 are greater than the heights H11, H7, H3, respectively. For the portion W3 of the width SW, the second set of ribs 282 transition from the heights H12, H8, H4 to the heights H11, H7, H3, respectively.

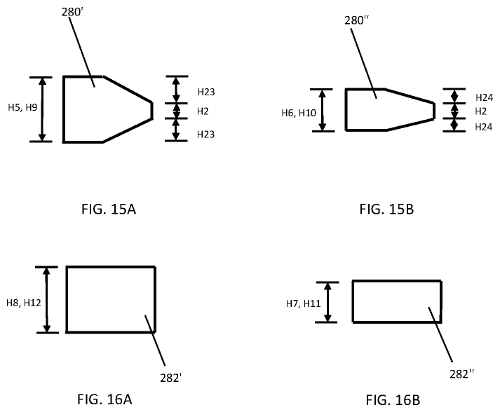

As illustrated in FIGS. 14, 16A, and 16B, the second set of ribs 282 have a rectangular cross-section. FIG. 16A illustrates a cross-section view of the portion 282′ of ribs 282a, 282b, along the width W4. FIG. 16B illustrates a cross-section view of the portion 282″ of ribs 282a, 282b along the width W5. As illustrated, the ribs 282a, 282b have a height H12, H8 along the width W4. As illustrated, the ribs 282a, 282b have a height H11, H7 along the width W5.

The forward wall also includes an array of slots 284. Each slot extends from the internal surface of the forward wall to an external surface of the forward wall. Each slot of the array of slots 284 are sized and configured to receive a tab of one of the battery cells of the set of battery cells 200 upon inserting one of the battery cells of the set of battery cells 200 into the cell holder 264. The array of slots 284 includes a first column of slots 284a and a second column of slots 284b.

As illustrated in FIG. 13, the first column of slots 284a of the array of slots 284 includes a first slot 284a1 between the second portion of the third rib 282c of the second set of ribs 282 and the first portion of the first rib 280a of the first set of ribs 280, a second slot 284a2 between the first portion of the first rib 280a of the first set of ribs 280 and the second portion of the second rib 282b of the second set of ribs 282, a third slot 284a3 between the second portion of the second rib 282b of the second set of ribs 282 and the first portion of the second rib 280b of the first set of ribs 280, a fourth slot 284a4 between the first portion of the second rib 280c of the first set of ribs 280 and the second portion of the first rib 282a of the second set of ribs 282, and a fifth slot 284a5 between the second portion of the first rib 282a of the first set of ribs 282 and the first portion of the third rib 280c of the first set of ribs 280.

As illustrated in FIG. 13, the second column of slots 284b of the array of slots 284 includes a first slot 284b1 between the first portion of the third rib 282c of the second set of ribs 282 and the second portion of the first rib 280a of the first set of ribs 280, a second slot 284b2 between the second portion of the first rib 280a of the first set of ribs 280 and the first portion of the second rib 282b of the second set of ribs 282, a third slot 284b3 between the first portion of the second rib 282b of the second set of ribs 282 and the second portion of the second rib 280b of the first set of ribs 280, a fourth slot 284b4 between the second portion of the second rib 280c of the first set of ribs 280 and the first portion of the first rib 282a of the second set of ribs 282, and a fifth slot 284b5 between the first portion of the first rib 282a of the first set of ribs 282 and the second portion of the third rib 280c of the first set of ribs 280.

The slots of the first column of slots 284a are aligned vertically. A distance (H15) separates a major axis of the first slot 284a1 of the first column of slots 284a and a major axis of the second slot 284a2 of the first column of slots 284a. A distance (H17) separates the major axis of the second slot 284a2 of the first column of slots 284a and a major axis of the third slot 284a3 of the first column of slots 284a. A distance (H19) separates the major axis of the third slot 284a3 and a major axis of the fourth slot 284a4 of the first column of slots 284a. A distance (H21) separates the major axis of the fourth slot 284a4 of the first column of slots 284a and a major axis of the fifth slot 284a5 of the first column of slots 284a. The distance H15 may be equal to the distance H19. The distance H17 may be equal to the distance H21. The distances H15 and H19 may be greater than the distances H17 and H21.

The slots of the second column of slots 284b are also aligned vertically. A distance (H16) separates a major axis of the first slot 284b1 of the second column of slots 284b and a major axis of the second slot 284b2 of the second column of slots 284b. A distance (H18) separates the major axis of the second slot 284b2 of the second column of slots 284b and a major axis of the third slot 284b3 of the second column of slots 284b. A distance (H20) separates the major axis of the third slot 284b3 and a major axis of the fourth slot 284b4 of the second column of slots 284b. A distance (H22) separates the major axis of the fourth slot 284b4 of the second column of slots 284b and a major axis of the fifth slot 284b5 of the second column of slots 284b. The distance H16 may be equal to the distance H20. The distance H18 may be equal to the distance H22. The distances H18 and H22 may be greater than the distances H16 and H20.

The first column of slots 284a is generally parallel to the second column of slots 284b.

The distance H15 may be greater than the distance H6. The distance H19 may be greater than the distance H20. The distance H18 may be greater than the distance H17. The distance H22 may be greater than the distance H21. The distance H15 may be greater than the distance H17 and the distance H19 may be greater than the distance H21. The distance H18 may be greater than the distance H16 and the distance H22 may be greater than the distance H20.

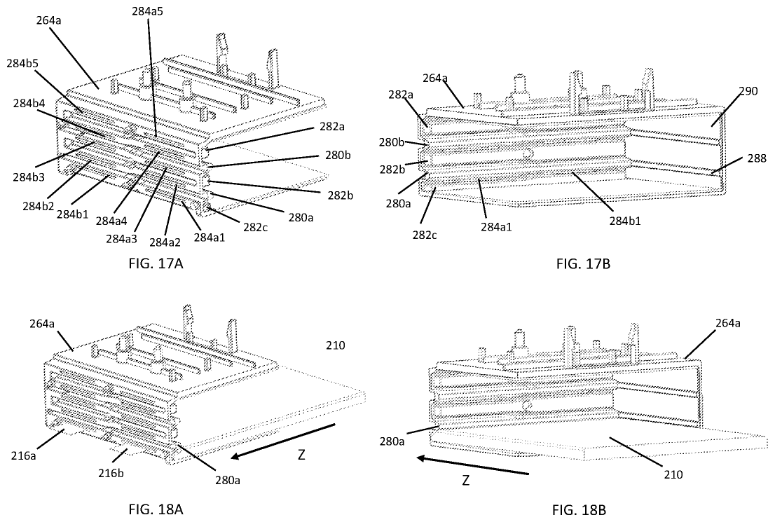

FIGS. 17-30 illustrate an assembly process of the core pack 262. The first side wall of the front housing 264a and the rear housing 264b of the cell holder 264 has been removed from these figures to better illustrate the assembly process. A second side wall 290 of the front housing 264a including side ribs (or channels) 288 is shown in these figures.

As illustrated in FIGS. 17A and 17B, the assembly process begins with providing a front portion or front housing 264a of the cell holder 264. As shown, the front portion 264a includes the array of ribs including the first set of ribs 280 and the second set of ribs 282. The front wall of the front housing 264a also includes the array of slots including the first column of slots 284a and the second column of slots 284b.

As illustrated in FIGS. 18A and 18B, a first pouch battery cell 210 is inserted or slid into the front housing 264a in a direction Z generally parallel to the bottom wall of the front housing 264a and generally perpendicular to the front wall of the front housing 264a. The first tab (the negative tab in this embodiment) 216b of the first battery cell 210 is forced the distance H23 towards the bottom wall of the front housing 264a by the lower taper section of the first portion of the first rib 280a of the first set of ribs 280 and controlled by the second portion of the third rib 282c of the second set of ribs 282 and received in the first slot 284a1 of the first column of slots 284a. Simultaneously, the second tab (the positive tab in this embodiment) 216a of the first battery cell 210 is forced the distance H24 (slightly less than the first tab 216b) towards the bottom wall of the front housing 264a by the lower taper of the second portion of the first rib 280a of the first set of ribs 280 and controlled by the first portion of the third rib 282c of the second set of ribs 282 and received in the first slot 284b1 of the second column of slots 284b. As such, the tabs 216a and 216b of the first battery cell 210 are offset from each in a direction generally perpendicular to the top and bottom walls of the cell holder 264.

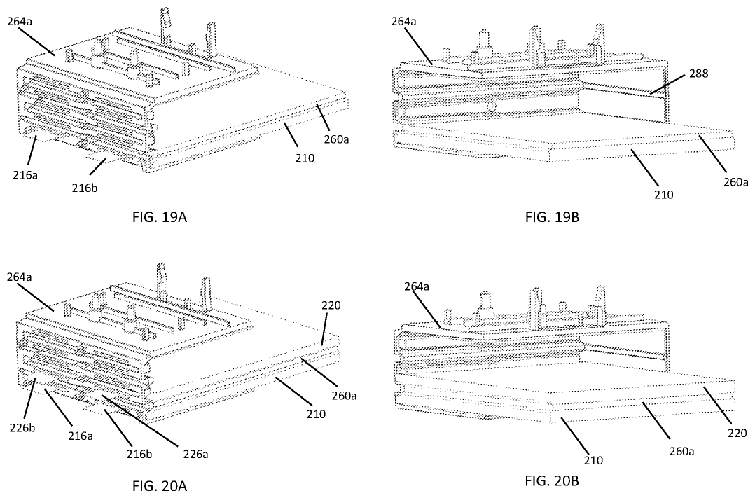

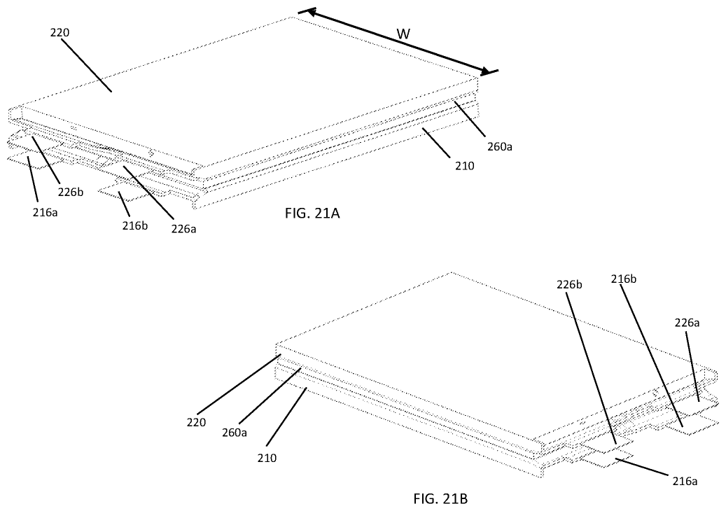

As illustrated in FIGS. 19A and 19B, a first insulating layer 260a is inserted or slid into the front housing 264a in the direction Z in engagement with slots or channels 288. The insulating layer 260a sits against the back of the first battery cell 210. The insulating layer 260a abuts the rear face/wall of the first rib 280a of the first set of ribs 280. The insulating layer 260a has a height (H2) generally equal to the height (H2) of the rear wall of the first rib 280a of the first set of ribs 280.

As illustrated in FIGS. 20A and 20B, a second pouch battery cell 220 is inserted or slid into the front housing 264a in the direction Z. The first tab (the positive tab in this embodiment) 226a of the second battery cell 220 is forced the distance H23 towards the top wall of the front housing 264a by the upper taper section of the first portion of the first rib 280a of the first set of ribs 280 and controlled by the second portion of the second rib 282b of the second set of ribs 282 and received in the second slot 284a2 of the first column of slots 284a.

Simultaneously, the second tab (the negative tab in this embodiment) 226b of the second battery cell 220 is forced the distance H24 (slightly less than the first tab 226a) towards the top wall of the front housing 264a by the upper taper of the second portion of the first rib 280a of the first set of ribs 280 and controlled by the first portion of the second rib 282b of the second set of ribs 282 and received in the second slot 284b2 of the second column of slots 284b. As such, the tabs 226a and 226b of the second battery cell 220 are offset from each in the direction generally perpendicular to the top and bottom walls of the cell holder 264.

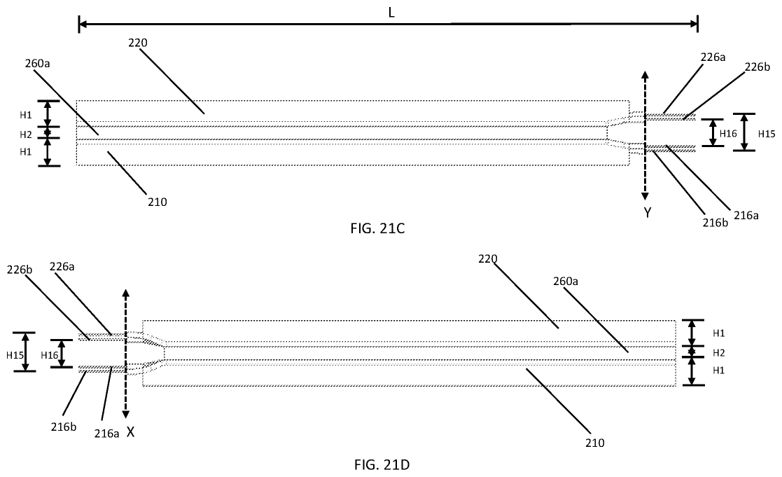

FIGS. 21, 21B, 21C, and 21D illustrate battery cells 210 and 220 and the insulating layer 260a as they are positioned in the cell holder 264 with the cell holder 264 removed. In other words, the cell tabs 216a, 216b, 226a, and 226b are shown as they are affected by the cell holder 264. More particularly, the cell tabs 216a and 226b are shown separated by the distance H16 and the cell tabs 216b and 226a are shown separated by the distance H15. As illustrated in FIGS. 21A, 21B, 21C and 21D, the first tab 216b of the first battery cell 210 and the first tab 226a of the second battery cell 220 are aligned along the axis X and the second tab 216a of the first battery cell 210 and the second tab 226b of the second battery cell 220 are aligned along the axis Y.

As illustrated in FIGS. 22A and 22B, a third pouch battery cell 230 is inserted or slid into the front housing 264a in the direction Z. The first tab (the negative tab in this embodiment) 236b of the third battery cell 230 is forced the distance H23 towards the bottom wall of the front housing 264a by the lower taper section of the first portion of the second rib 280b of the first set of ribs 280 and controlled by the second portion of the second rib 282b of the second set of ribs 282 and received in the third slot 284a3 of the first column of slots 284a. Simultaneously, the second tab (the positive tab in this embodiment) 236a of the third battery cell 230 is forced the distance H24 (slightly less than the first tab 236b) towards the bottom wall of the front housing 264a by the lower taper of the second portion of the second rib 280b of the first set of ribs 280 and controlled by the first portion of the second rib 282b of the second set of ribs 282 and received in the third slot 284b3 of the second column of slots 284b. As such, the tabs 236a and 236b of the third battery cell 230 are offset from each in a direction generally perpendicular to the top and bottom walls of the cell holder 264.

The first tab 236b of the third battery cell 230 is aligned with the first tab 226a of the second battery cell 220 and the first tab 216b of the first battery cell 210 along the axis X and the second tab 236a of the third battery cell 230 is aligned with the second tab 226b of the second battery cell 220 and the second tab 216a of the first battery cell 210 along the axis Y.

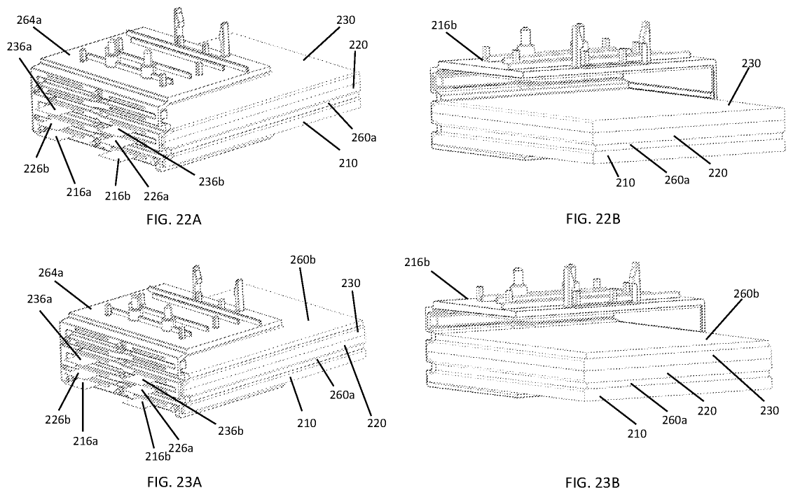

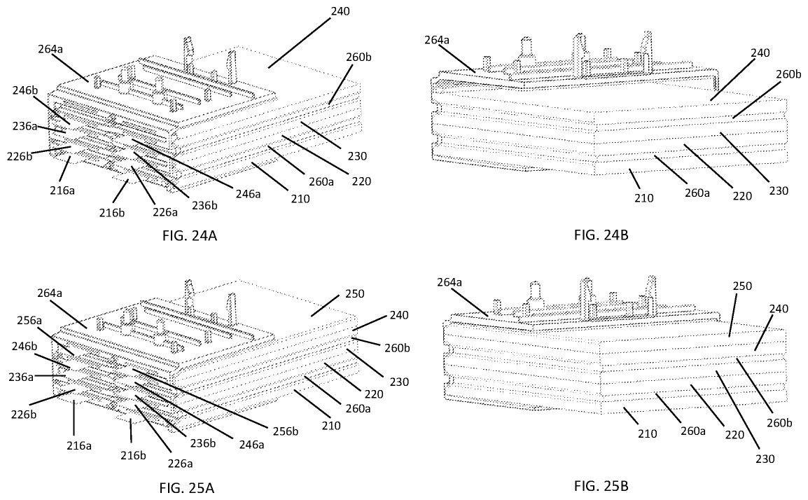

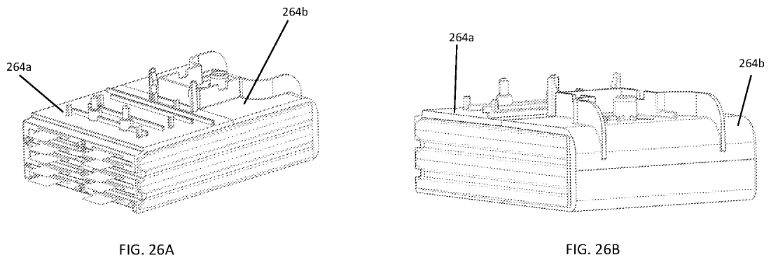

As illustrated in FIGS. 23A and 23B, a second insulating layer 260b is inserted or slid into the front housing 264a in the direction Z. The insulating layer 260b sits against the face of the third battery cell 230. The insulating layer 260b abuts the rear face/wall of the second rib 280b of the first set of ribs 280. The insulating layer 260b has a height (H2) generally equal to the height (H2) of the rear wall of the second rib 280b of the first set of ribs 280.

As illustrated in FIGS. 24A and 24B, a fourth pouch battery cell 240 is inserted or slid into the front housing 264a in the direction Z. The first tab (the positive tab in this embodiment) 246a of the fourth battery cell 240 is forced the distance H23 towards the top wall of the front housing 264a by the upper taper section of the first portion of the second rib 280b of the first set of ribs 280 and controlled by the second portion of the first rib 282a of the second set of ribs 282 and received in the fourth slot 284a4 of the first column of slots 284a.

Simultaneously, the second tab (the negative tab in this embodiment) 246b of the fourth battery cell 240 is forced the distance H24 (slightly less than the first tab 246a) towards the top wall of the front housing 264a by the upper taper of the second portion of the third rib 280a of the first set of ribs 280 and controlled by the first portion of the first rib 282a of the second set of ribs 282 and received in the fourth slot 284b4 of the second column of slots 284b. As such, the tabs 246a and 246b of the fourth battery cell 240 are offset from each in the direction generally perpendicular to the top and bottom walls of the cell holder 264.

The first tab 246a of the fourth battery cell 240 is aligned with the first tab 236b of the third battery cell 230, the first tab 226a of the second battery cell and the first tab 216b of the first battery cell 210 along the axis X and the second tab 246b of the fourth battery cell 240 is aligned with the second tab 236a of the third battery cell 230, the second tab 226b of the second battery cell 220 and the second tab 216a of the first battery cell 210 along the axis Y.

As illustrated in FIGS. 25A and 25B, a fifth pouch battery cell 250 is inserted or slid into the front housing 264a in the direction Z. The first tab (the negative tab in this embodiment) 256b of the fifth battery cell 250 is forced the distance H23 towards the bottom wall of the front housing 264a by the lower taper section of the first portion of the third rib 280c of the first set of ribs 280 and controlled by the second portion of the first rib 282a of the second set of ribs 282 and received in the fifth slot 284a5 of the first column of slots 284a.

Simultaneously, the second tab (the positive tab in this embodiment) 256a of the third battery cell 250 is forced the distance H24 (slightly less than the first tab 256b) towards the bottom wall of the front housing 264a by the lower taper of the second portion of the third rib 280c of the first set of ribs 280 and controlled by the first portion of the first rib 282a of the second set of ribs 282 and received in the fifth slot 284b5 of the second column of slots 284b. As such, the tabs 256a and 256b of the fifth battery cell 250 are offset from each in a direction generally perpendicular to the top and bottom walls of the cell holder 264.

The first tab 256b of the fifth battery cell 250 is aligned with the first tab 246a of the fourth battery cell 240, the first tab 236b of the third battery cell 230, the first tab 226a of the second battery cell 220 and the first tab 216b of the first battery cell 210 along the axis X and the second tab 256a of the fifth battery cell 250 is aligned with the second tab 246b of the fourth battery cell 240, the second tab 236a of the third battery cell 230, the second tab 226b of the second battery cell 220 and the second tab 216a of the first battery cell 210 along the axis Y.

The front portion 264a of the cell holder 264 is now full. In alternate embodiments, the set of battery cells 200 and the insulating layers 260 may be stacked prior to being inserted into the front portion of the cell holder and then inserted as stack or cartridge.

As illustrated in FIGS. 26A and 26B, the rear portion 264b is then placed over the rear ends of the battery cells of the set of battery cells 200 and the insulating portions 260 and coupled to the front portion 264a of the cell holder 264.

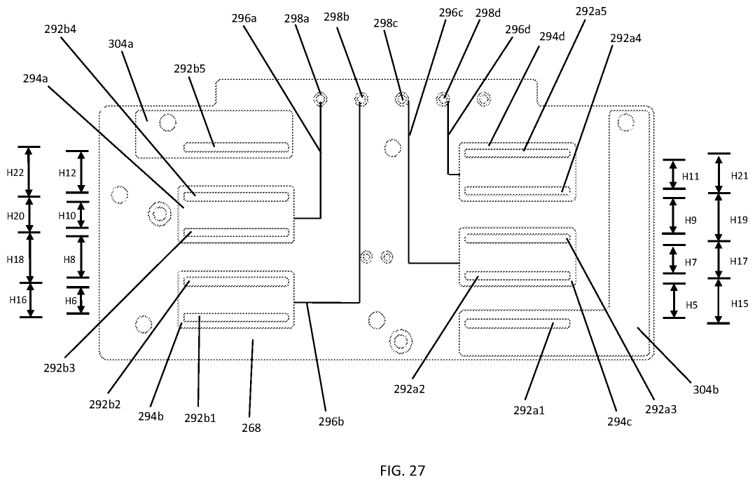

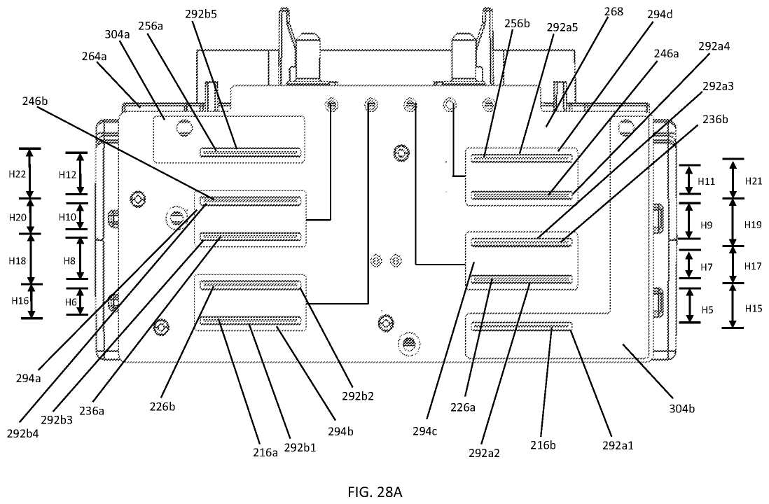

FIG. 27 illustrates an example embodiment of a secondary printed circuit board (PCB) 268 of the core pack 262. The secondary PCB 268 includes a front surface and a rear surface.

The PCB 268 includes a first column of slots 292a. The slots 292a1, 292a2, 292a3, 292a4, 292a5 of the first column of slots 292a extend from the rear surface of the PCB 268 to the front surface of the PCB 268. A distance H5 separates the first slot 292a1 and the second slot 292a2 of the first column of slots 292a. A distance H7 separates the second slot 292a2 and the third slot 292a3 of the first column of slots 292a. A distance H9 separates the third slot 292a3 and the fourth slot 292a4 of the first column of slots 292a. A distance H11 separates the fourth slot 292a4 and the fifth slot 292a5 of the first column of slots 292a.

A distance H15 separates a major axis of the first slot 292a1 and a major axis of the second slot 292a2 of the first column of slots 292a. A distance H17 separates the major axis of the second slot 292a2 and a major axis of the third slot 292a3 of the first column of slots 292a. A distance H19 separates the major axis of the third slot 292a2 and a major axis of the fourth slot 292a4 of the first column of slots 292a. A distance H21 separates the major axis of the fourth slot 292a4 and a major axis of the fifth slot 292a5 of the first column of slots 292a.

The PCB 268 includes a second column of slots 292b. The slots 292b1, 292b2, 292b3, 292b4, 292b5 of the second column of slots 292b extend from the rear surface of the PCB 268 to the front surface of the PCB 268. A distance H6 separates the first slot 292b1 and the second slot 292b2 of the second column of slots 292b. A distance H8 separates the second slot 292b2 and the third slot 292b3 of the second column of slots 292b. A distance H10 separates the third slot 292b3 and the fourth slot 292b4 of the second column of slots 292b. A distance H12 separates the fourth slot 292b4 and the fifth slot 292b5 of the second column of slots 292b.

A distance H16 separates a major axis of the first slot 292b1 and a major axis of the second slot 292b2 of the second column of slots 292b. A distance H18 separates the major axis of the second slot 292b2 and a major axis of the third slot 292b3 of the second column of slots 292b. A distance H20 separates the major axis of the third slot 292b2 and a major axis of the fourth slot 292b4 of the second column of slots 292b. A distance H22 separates the major axis of the fourth slot 292b4 and a major axis of the fifth slot 292b5 of the second column of slots 292b.

The distance H5 may equal the distance H7. The distance H7 may equal the distance H11. The distance H5 may equal the distance H9. The distance H15 may equal the distance H17. The distance H17 may equal the distance H21. The distance H15 may equal the distance H19.

The distance H12 may equal the distance H10. The distance H10 may equal the distance H6. The distance H12 may equal the distance H8. The distance H22 may equal the distance H20. The distance H20 may equal the distance H16. The distance H22 may equal the distance H18.

The distance H15 may be greater than the distance H16. The distance H18 may be greater than the distance H17. The distance H19 may be greater than the distance H20. The distance H22 may be greater than the distance H21.

The PCB 268 may also include a plurality of metallic pads. A first metallic pad 304a surrounds the fifth slot 292b5 of the second column of slots 292b. A second metallic pad 304b surrounds the first slot 292a1 of the first column of slots 292a. A third metallic pad 294a surrounds the fourth slot 292b4 and the third slot 292b3 of the second column of slots 292b. A fourth metallic pad 294b surrounds the second slot 292b2 and the first slot 292b1 of the second column of slots 292b. A fifth metallic pad 294c surrounds the second slot 292a2 and the third slot 292a3 of the first column of slots 292a. A sixth metallic pad 294d surrounds the fourth slot 292a4 and the fifth slot 292a4 of the first column of slots 292a.

The PCB 268 may also include a plurality of metallic traces. A first metallic trace 296a runs from the third metallic pad 294a to a via 298a. A second metallic trace 296b runs from the fourth metallic pad 294b to a via 298b. A third metallic trace 296c runs from the fifth metallic pad 294c to a via 298c. A fourth metallic trace 296d runs from the sixth metallic pad 294d to a via 298d.

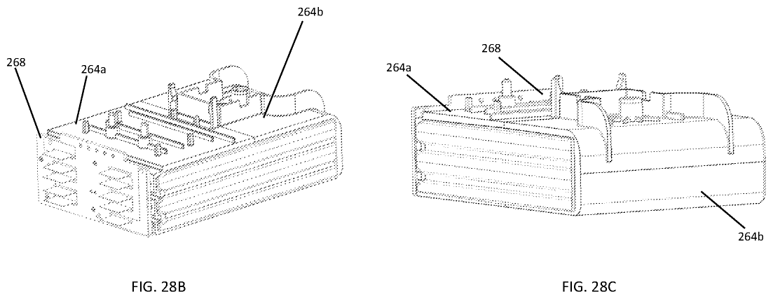

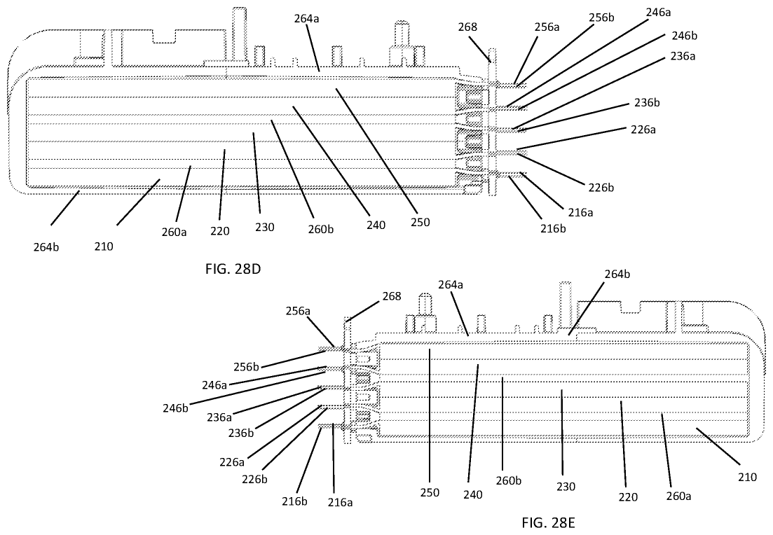

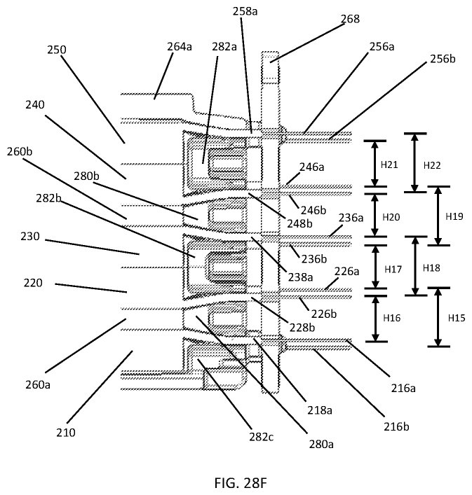

As illustrated in FIGS. 28A, 28B, 28C, 28D, 28E and 28F, the rear surface of the PCB 268 is mounted upon/affixed to the front wall of the front portion 264a of the cell holder 264. The first column of slots 292a of the PCB 268 correspond to and align with the first column of slots 284a of the front portion 264a of the cell holder 264 and the second column of slots 292b of the PCB 268 correspond to and align with the second column of slots 284b of the front portion 264a of the cell holder 264. In alternate embodiments the PCB 268 may be held in place relative to the cell holder 264 by a fixture on an internal surface of the battery pack housing.

As such, when the PCB 268 is mounted upon/affixed to the front portion 264a of the cell holder 264 the first tabs 216b, 226a, 236b, 246a and 256b of the first battery cell 210, the second battery cell 220, the third battery cell 230, fourth battery cell 240, and the fifth battery cell 250, respectively, are received in the first slot 292a1, the second slot 292a2, the third slot 292a3, the fourth slot 292a4, and the fifth slot 292a5 of the first column of slots 292 of the PCB 268, respectively. And, when the PCB 268 is mounted upon/affixed to the front portion 264a of the cell holder 264 the second tabs 216a, 226b, 236a, 246b and 256a of the first battery cell 210, the second battery cell 220, the third battery cell 230, fourth battery cell 240, and the fifth battery cell 250, respectively, are received in the first slot 292b1, the second slot 292b2, the third slot 292b3, the fourth slot 292b4, and the fifth slot 292b5 of the second column of slots 292 of the PCB 268, respectively. As shown in FIG. 28F, secondary heat seals (of which secondary heat seals 218a, 228b, 238a, 248b, and 258a are shown) are provided about the corresponding one of the first and second cell tabs.

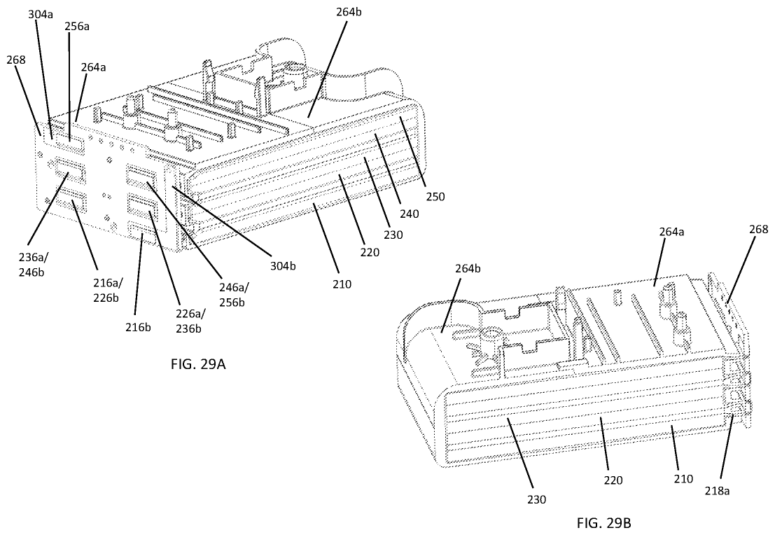

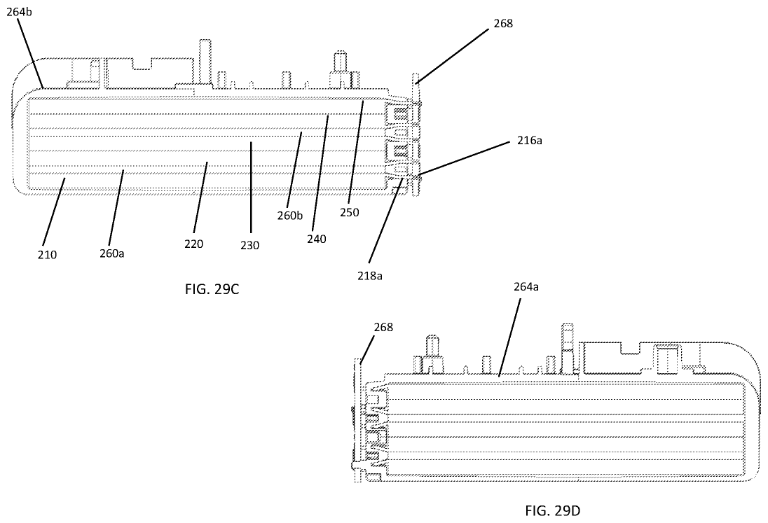

As illustrated in FIGS. 29A, 29B, 29C and 29D the ends of the cell tabs are folded to connect to an associated metallic pad. Specifically, the second cell tab 256a of the fifth battery cell 250 (the most positive cell tab once all of the battery cells of the set of battery cells 200 are connected in series) is folded to overlap the first metallic pad 304a. The first cell tab 216b of the first battery cell 210 (the most negative cell tab once all of the battery cells of the set of battery cells 200 are connected in series) is folded to overlap the second metallic pad 304b. The second cell tab 246b of the fourth battery cell 240 and the second cell tab 236a are folded to overlap each other and the third metallic pad 294a. The second cell tab 226b of the second battery cell 220 and the second cell tab 216a of the first battery cell 210 are folded to overlap each other and the fourth metallic pad 294b. The first cell tab 226a of the second battery cell 220 and the first cell tab 236b of the third battery cell 230 are folded to overlap each other and the fifth metallic pad 294c. The first cell tab 246a of the fourth battery cell 240 and the first cell tab 256b of the fifth battery cell 250 are folded to overlap each other and the sixth metallic pad 294d.

Thereafter, the folded tabs are electrically coupled to the corresponding metallic pads. Specifically, tab 256a is electrically coupled to metallic pad 204a, tab 216b is electrically coupled to metallic pad 304b, tabs 236a and 246b are electrically coupled to metallic pad 294a, tabs 216a and 226b are electrically coupled to metallic pad 294b, tabs 226a and 236b are electrically coupled to metallic pad 294c and tabs 246a and 256b are electrically coupled to metallic pad 294d. The electric coupling may be accomplished through welding, e.g., laser welding, sonic welding or by mechanical connections.

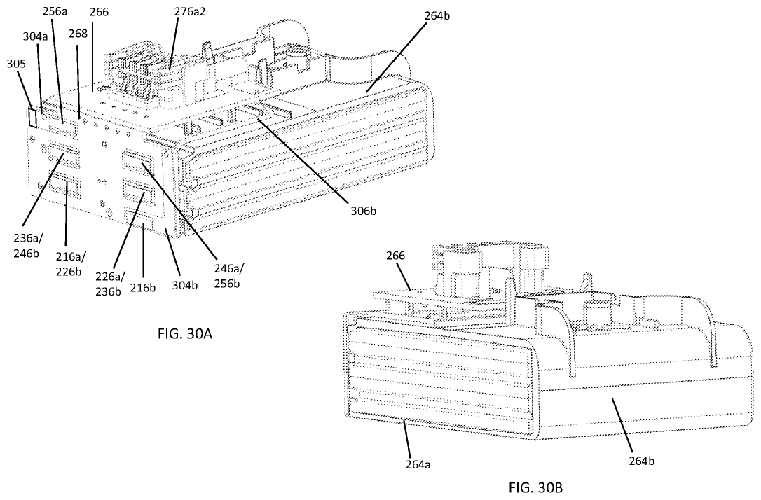

As illustrated in FIGS. 30A and 30B, the primary PCB 266 is mounted on/affixed to the cell holder 268. A connector 306a (see FIG. 11C), e.g., a wire or metal strap, connects the first metallic pad 304a to the positive power terminal 276a1 and a connector, e.g., and a connector 306b (see FIGS. 11B and 30A), e.g., also a wire or metal strap, connects the second metallic pad 304b to the negative power terminal 276a2. A fuse 305, which may be a surface-mount electronic fuse or a metal-strap fuse, may be provided on the current path of the first metallic pad 304a for overcurrent protection. A connector (not shown) connects the vias 298a, 298b, 298c, 298d of the secondary PCB 268 to corresponding first, second, third and fourth vias on the primary PCB 266. The first, second, third and fourth vias on the primary PCB 266 are electrically coupled to the third intercell terminal 276b5, the first intercell terminal 276b3, the second intercell terminal 276b4, and the fourth intercell terminal 276b6, respectively.

Once the core pack 262 is completed, it is placed in the lower housing 104. Thereafter, the upper housing 102 is placed over the core pack 262 and coupled to the lower housing 104.

This method of assembly of the battery pack 100 is but one example. The steps may be completed in an alternate order. For example, the secondary PCB 268 may be affixed to the front portion 264a of the cell holder 264 prior to inserting any of the battery cells of the set of battery cells 200. As such, upon inserting the battery cells 210, 220, 230, 240, and 250 into the front portion 264a of the cell holder 264, the various tabs would be inserted through both a corresponding slot 284 of the front portion 264a of the cell holder 264 and a corresponding slot 292 of the secondary PCB 268.

With regard to the total height of foam 260 in the battery pack and the height (H2) of a particular foam element, 260a or 260b, the total height of all of the foam elements in the pack can be calculated as the thickness of the battery cell times the number of battery cells in the battery pack. This number can be multiplied by a percentage ranging from approximately 5% to 15%, more particularly by a percentage ranging from approximately 7.5% to 12.5% and more particularly by a percentage of approximately 10%. The following are example equations:

(Cell thickness×number of cells)×10%=total height of foam EQ. 1

If all foam elements are of equal height, then

Total height of foam/number of foam elements=height of each foam element(H2) EQ. 2

The cell holder 264 according to the present disclosure configured the battery cell tabs 216 to optimize the spacing between the tabs 216 of adjacent battery cells of the set of battery cells 200 once the tabs 216 are connected taking into consideration the relative voltages of adjacent battery cells, e.g., 210, 220, 230 once the set of battery cells 200 are connected.

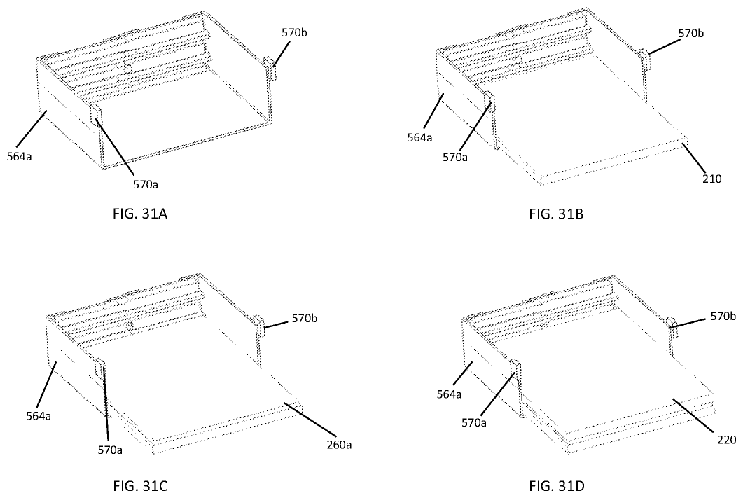

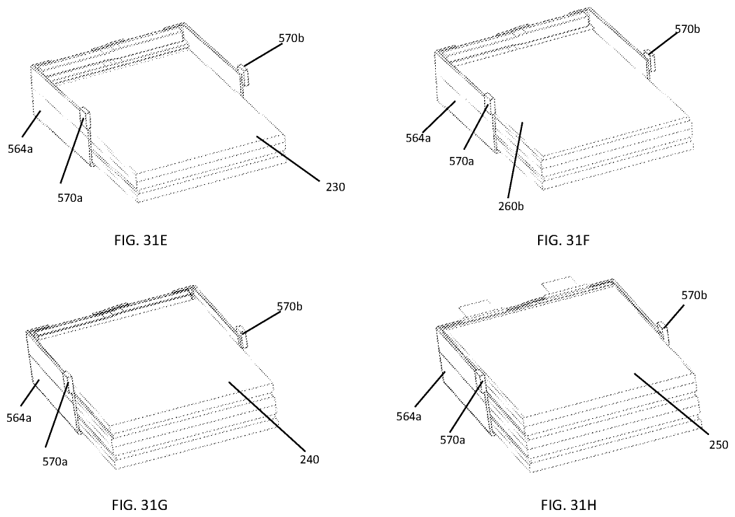

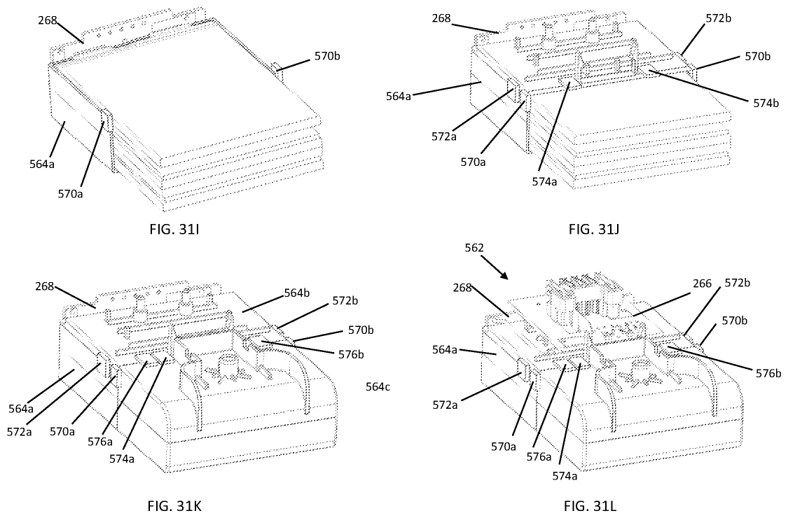

Referring to FIGS. 31A-31L, there is illustrated an alternate, example core pack 562 in accordance with the present disclosure and a method for assembling the alternate, example core pack in accordance with the present disclosure.

In this embodiment, the cell holder 564 includes a front, receiving portion 564a, a front top portion 564b, and a rear portion 564c. The front, receiving portion includes an array of ribs and slots similar to the array of ribs and slots disclosed and described above with regard to FIGS. 12-26. As such, the ribs and the slots of the cell holder 564 will not be described again. The battery cells and the insulating elements (material) of this embodiment are similar to the battery cells and insulating elements disclosed and described above with regard to FIGS. 9-30. As such, the battery cells and the insulating elements and the manner in which they are received in the cell holder will not be described again. The front, receiving portion 564a also includes a pair of mechanical, connection tabs 570a, 570b. The front top portion 564b also includes a first pair of mechanical, connection tabs 572a, 572b and a second pair of mechanical, connection tabs 574a, 574b. The rear portion 564c also includes a pair of mechanical, connection tabs 576a, 576b.

As illustrated in FIG. 31A, a first step of the method of assembling the core pack 562 includes providing an empty front, receiving portion 564a of the cell holder 564. The front, receiving portion 564a of the cell holder 564 includes a front wall, a bottom wall, a first side wall and a second side wall. Together, these walls form a receiving space for receiving the battery cells and the foam insulators.

As illustrated in FIG. 31B, a second step of the method of assembling the core pack 562 includes placing a first battery cell into the front receiving portion 564a. As illustrated in FIG. 31C, a third step of the method of assembling the core pack 562 includes placing a first foam insulating element into the front receiving portion 564a. As illustrated in FIG. 31D, a fourth step of the method of assembling the core pack 562 includes placing a second battery cell into the front receiving portion 564a.

As illustrated in FIG. 31E, a fifth step of the method of assembling the core pack 562 includes placing a third battery cell into the front receiving portion 564a. As illustrated in FIG. 31F, a sixth step of the method of assembling the core pack 562 includes placing a second foam insulating element into the front receiving portion 564a. As illustrated in FIG. 31G, a seventh step of the method of assembling the core pack 562 includes placing a fourth battery cell into the front receiving portion 564a. As illustrated in FIG. 31H, an eighth step of the method of assembling the core pack 562 includes placing a fifth battery cell into the front receiving portion 564a. As illustrated in FIG. 31I, a ninth step of the method of assembling the core pack 562 includes affixing a secondary PCB to the front receiving portion 564a.

As illustrated in FIG. 31J, a tenth step of the method of assembling the core pack 562 includes placing the front top portion 564b of the cell holder 564 onto (coupling with) the front receiving portion 564a of the cell holder 564. In this step the pair of mechanical, connection tabs 570a, 570b of the front, receiving portion 564a of the cell holder 564 are mated to and affixed to the front top portion 564b of the cell holder 564 and the first pair of mechanical, connection tabs 572a, 572b of the front top portion 564b of the cell holder 564 are mated to and affixed to the front, receiving portion 564a of the cell holder 564. The various tabs may be affixed to the mated part by friction, glue, sonic welding or a similar fastening method.

As illustrated in FIG. 31K, an eleventh step of the method of assembling the core pack 562 includes coupling the rear portion 564c of the cell holder 564 with the front receiving portion 564a and the front top portion 564b of the cell holder 564. In this step, the pair of mechanical, connection tabs 570a, 570b of the front, receiving portion 564a of the cell holder 564 are mated to and affixed to the rear receiving portion 564c of the cell holder 564 and the second pair of mechanical, connection tabs 574a, 574b of the front top portion 564b of the cell holder 564 are mated to and affixed to the rear receiving portion 564c of the cell holder 564.

Again, the various tabs may be affixed to the mated part by friction, glue, sonic welding or a similar fastening method.

As illustrated in FIG. 31L, a twelfth step of the method of assembling the core pack 562 includes coupling the primary PCB and the terminal block to the cell holder 564 to complete the core pack 562. Thereafter, the core pack 562 is placed in a battery housing, as noted above, to complete the battery pack.

This method of assembly of the core pack 562 is but one example. The steps may be completed in an alternate order. For example, the secondary PCB 268 may be affixed to the front portion 564a of the cell holder 564 prior to inserting any of the battery cells of the set of battery cells 200. As such, upon inserting the battery cells 210, 220, 230, 240, and 250 into the front portion 564a of the cell holder 564, the various tabs would be inserted through both a corresponding slot 284 of the front portion 564a of the cell holder 564 and a corresponding slot 292 of the secondary PCB 268.

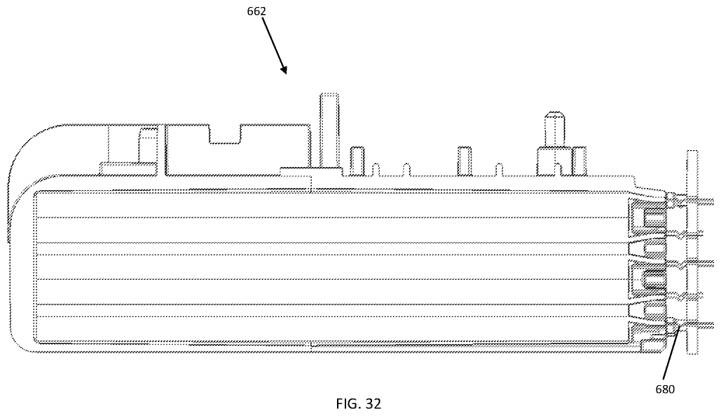

As illustrated in FIG. 32, in an alternate, example embodiment of the core pack 662, as an added layer of protection, a strain relief 680 feature may be added to the leads/tabs via a pre-kink or pre-bend. The strain relief 680 features compensate for movement of the battery cells during vibration of the battery pack or thermal expansion and contraction of the battery cells.

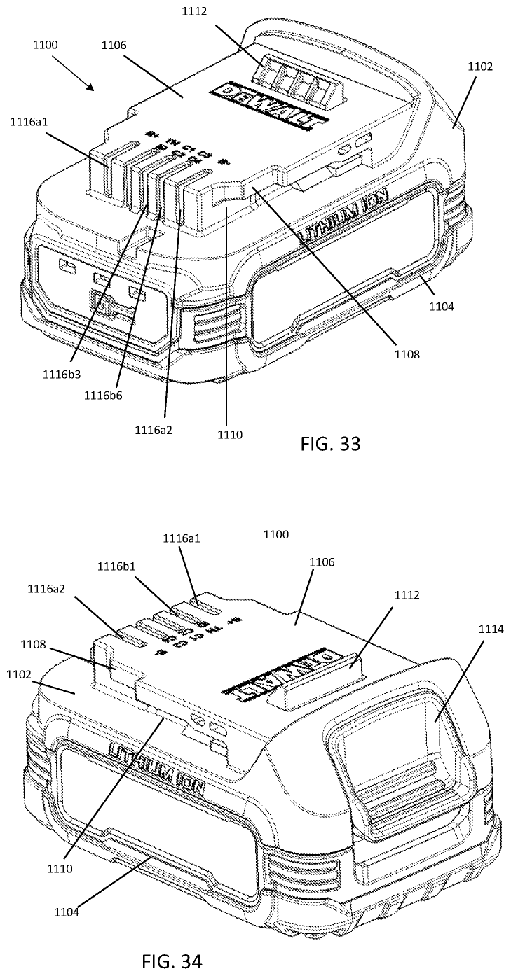

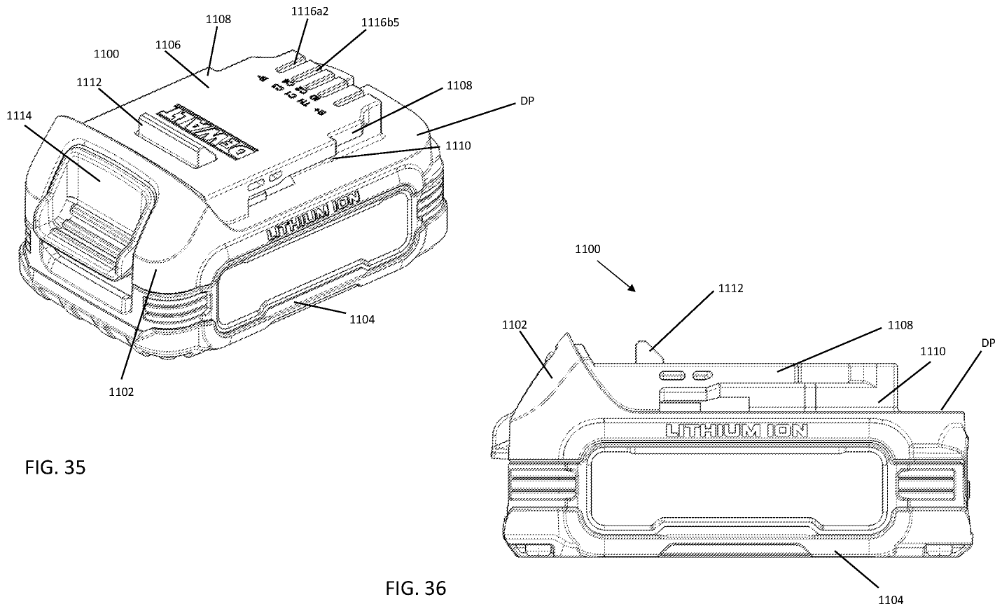

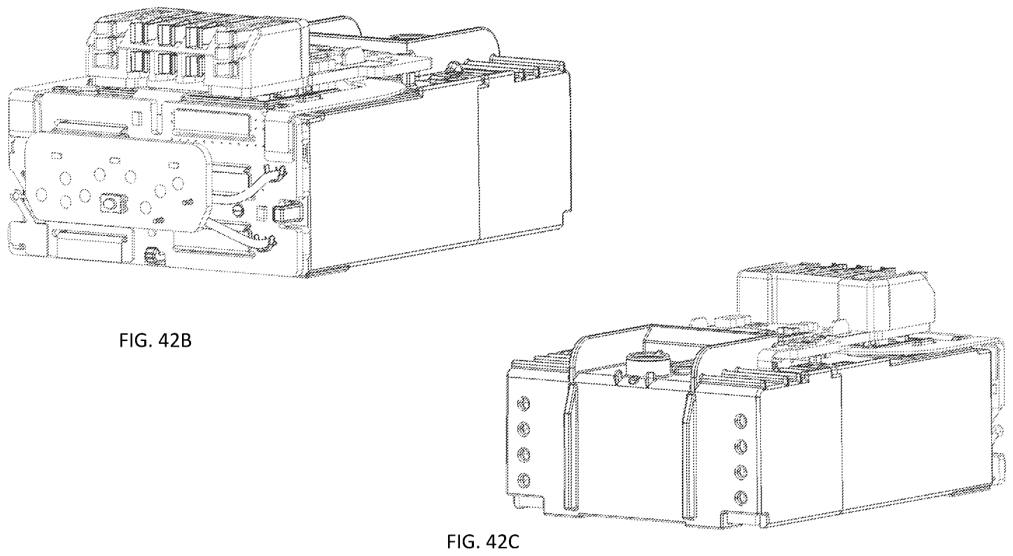

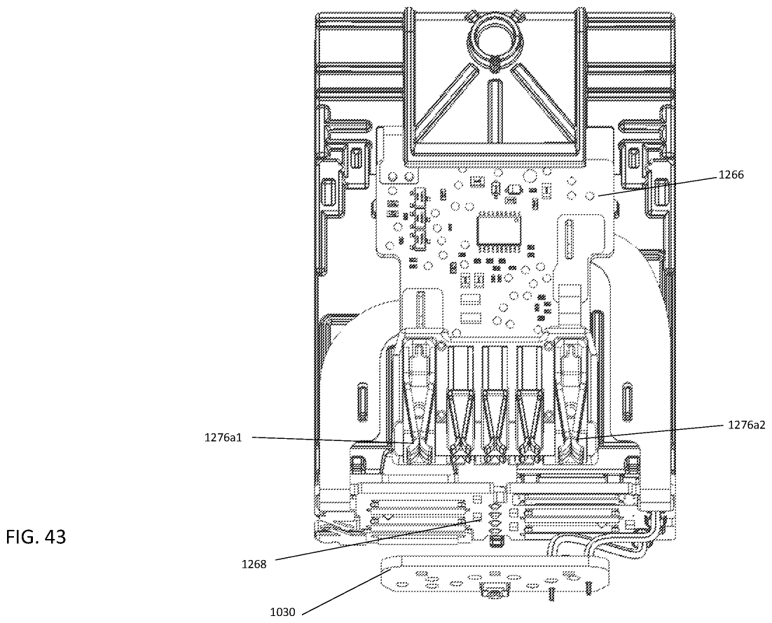

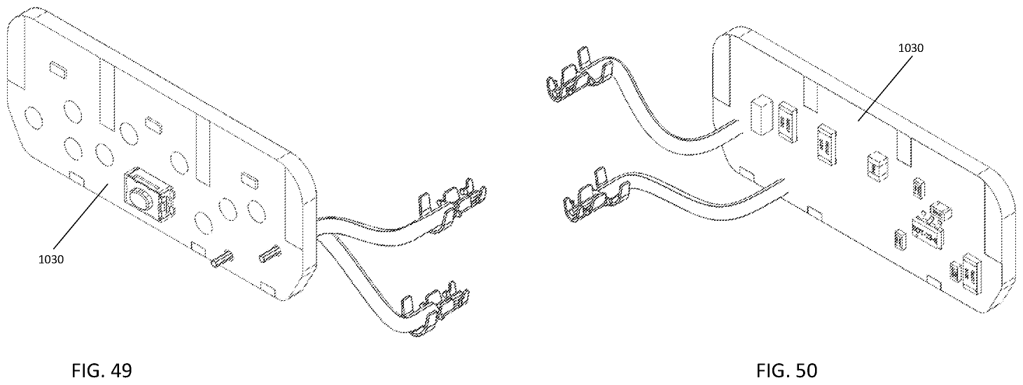

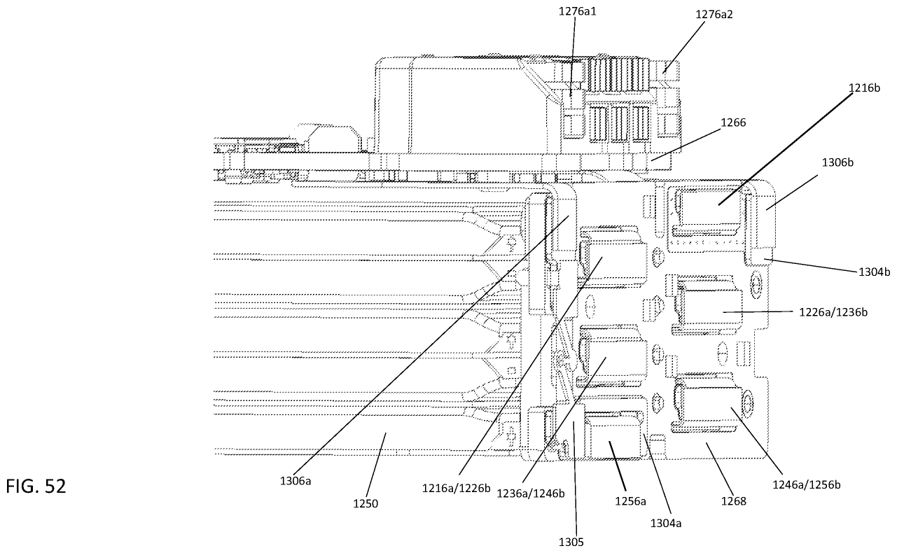

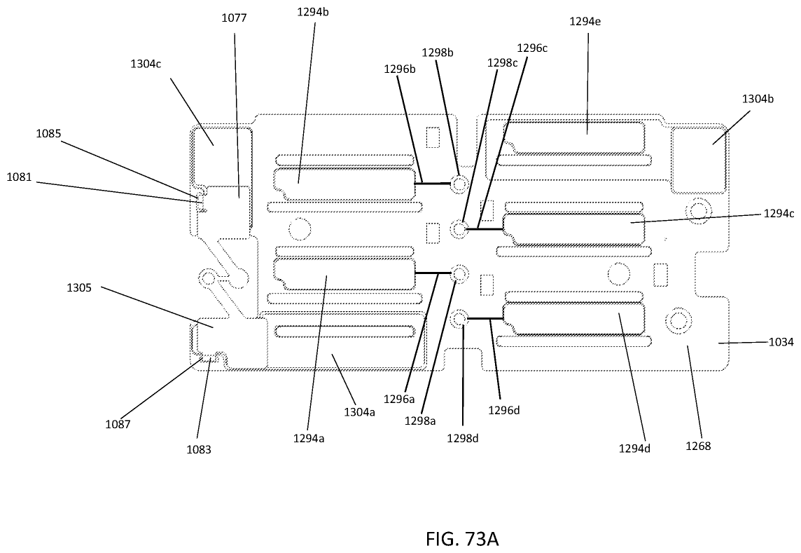

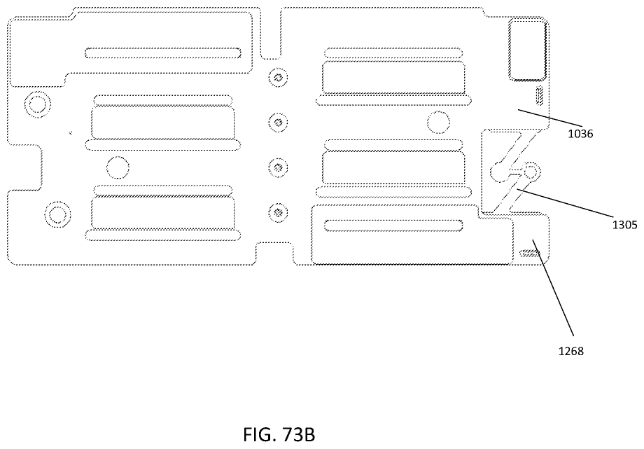

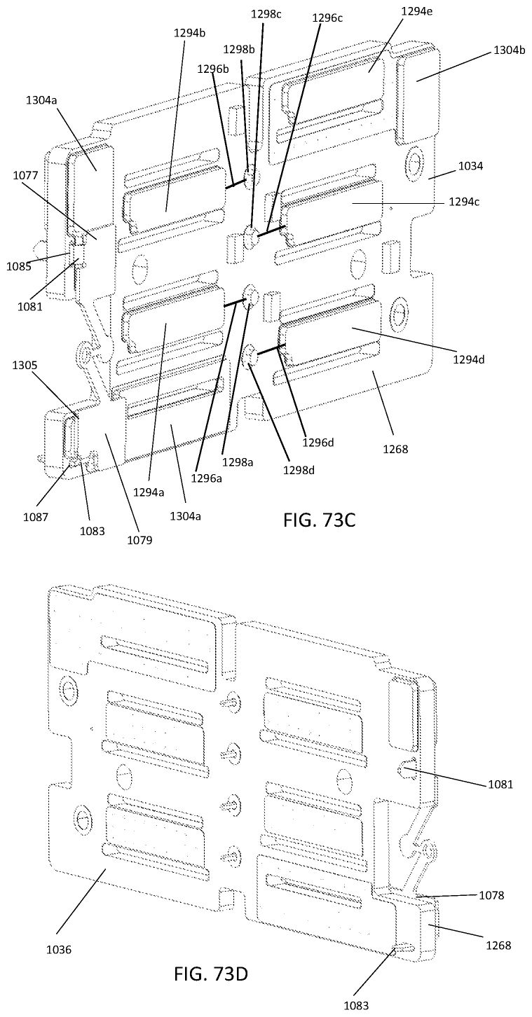

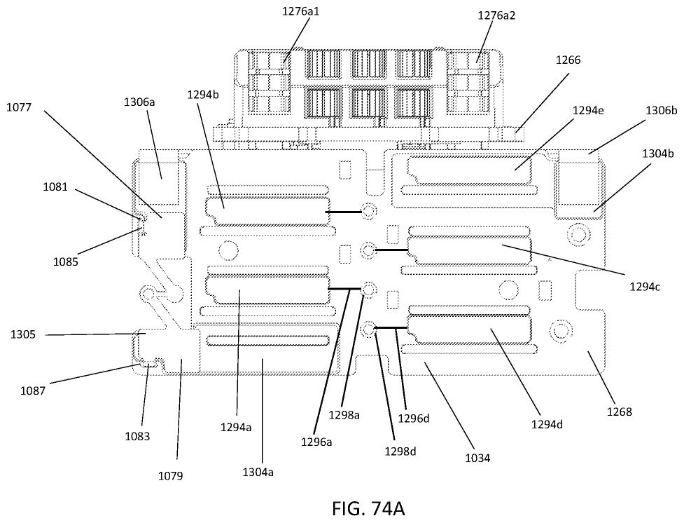

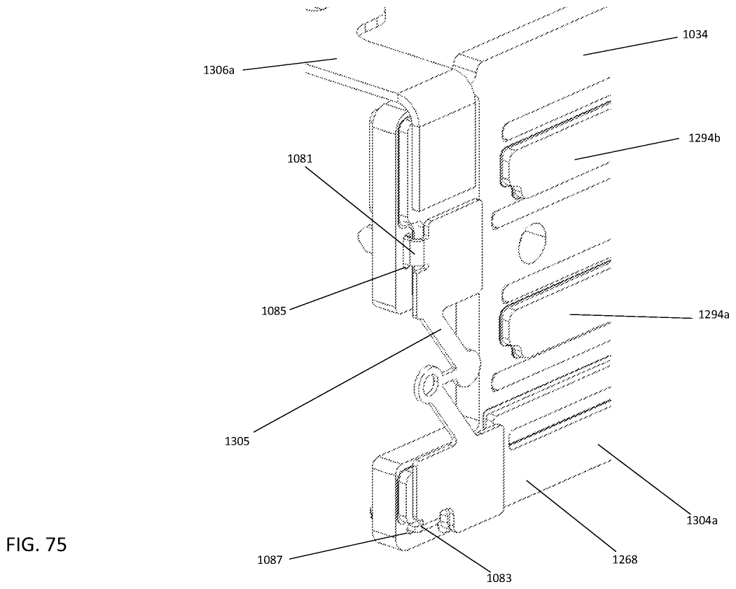

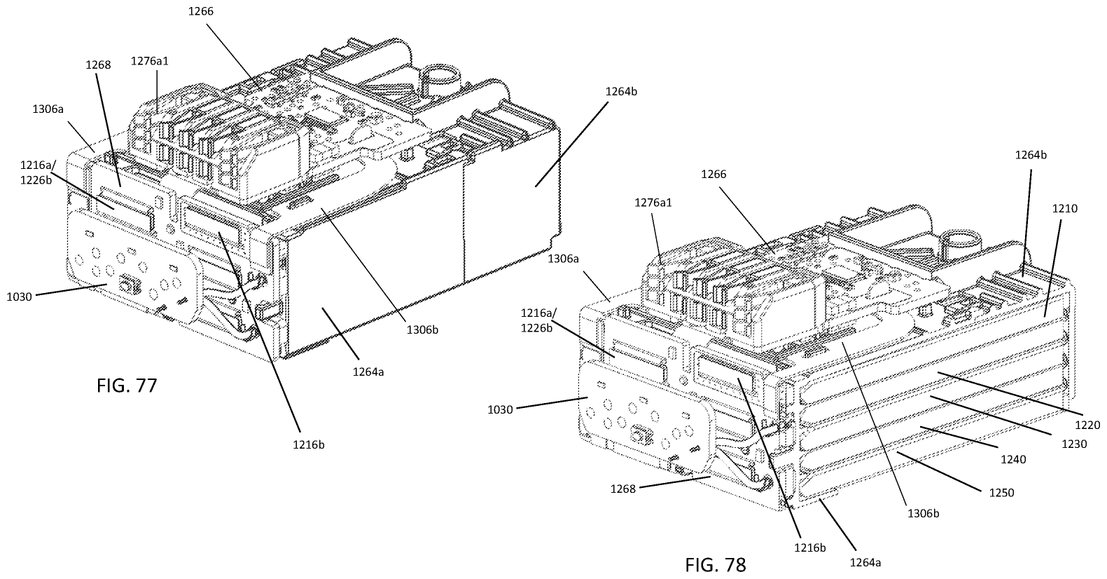

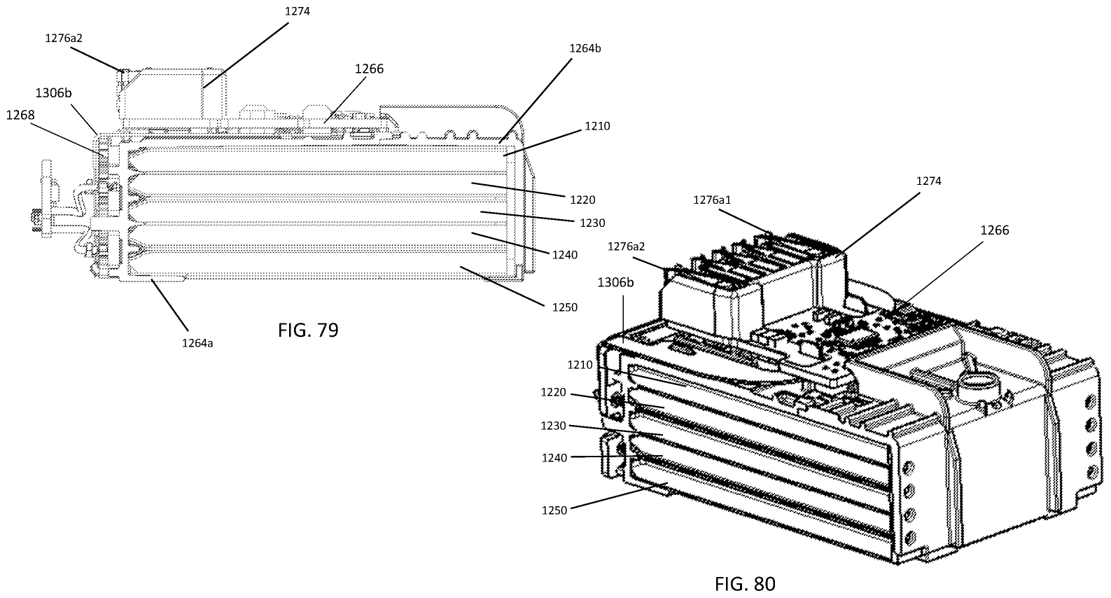

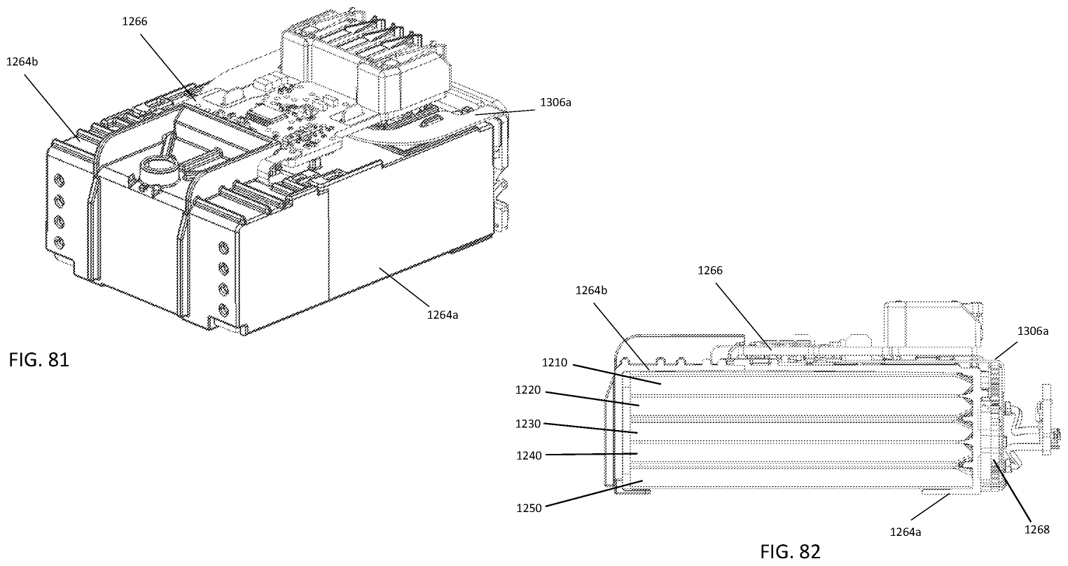

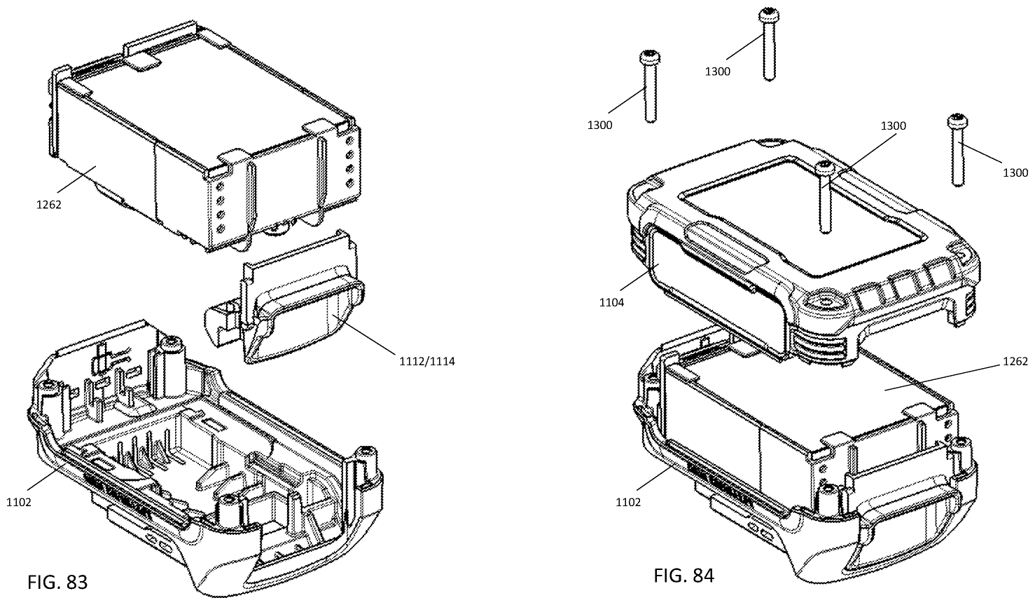

Referring to FIGS. 33-84, there is disclosed another example embodiment of a battery pack 1100 according to the present patent application. The battery pack 1100 includes a housing. As is well known in the art the housing may be constructed of a plastic material. The housing may include an upper portion or housing 1102 and lower portion or housing 1104. The upper portion 1102 and the lower portion 1104 may be connected by screws or other fastening means, as is well known in the art. When the upper portion 1102 and the lower portion 1104 are joined, an interior cavity is formed. The battery pack 1100 may include an interface 1106 for mechanically and electrically coupling the battery pack 1100 to a power tool 1002 (as shown in FIGS. 85-91) that is to be powered by the battery pack 1100. The interface 1106 may include a set of rails 1108 and a set of grooves 1110. In the illustrated example, the battery pack 1100 includes a pair of rails 1108 (one rail on each side of the battery pack 1100) and a pair of grooves 1110 (one on each side of the battery pack 1100). The grooves 1110 receive corresponding rails of the power tool 1002 when the battery pack 1100 slidingly engages/couples with the power tool 1002.

The interface 1106 also includes a latch 1112 that is configured to move into and out of the cavity upon depression of a user actuated latch button 1114. The latch 1112 is configured to be received in a catch of the power tool 1002 when the battery pack 1100 is fully engaged with/coupled to the power tool 1002. In order to disengage/decouple the battery pack 1100 from the power tool 1002, the user actuated latch button 1114 is depressed to release the latch 1114 from the power tool catch. The battery pack 1100 can then be removed from the power tool 1002.

The interface 1106 also includes a set of slots 1116 in the upper housing 1102. The slots 1116 provide an opening in the upper housing 1102 for a set of (power) tool terminals 1024 of the power tool 1002 to mate with a set of battery pack terminals 1276 of the battery pack 1100. These battery pack terminals 1276 are discussed in more detail below. The set of slots 1116 includes a first subset of slots 1116a which provide access to power terminals 1276a1, 1276a2 of the battery pack 1100 and a second subset of slots 1116b which provide access to sense (or signal) terminals 1276b of the battery pack 1100. The first subset of slots 1116a may include a first slot 1116a1 for access to a positive battery pack power terminal 1276a1 and a second slot 1116a2 for access to a negative battery pack power terminal 1276a2. The second subset of slots 1116b may include six slots 1116b1, 1116b2, 1116b3, 1116b4, 116b5, 1116b6 for access to battery pack sense terminals including a thermistor (TH) terminal, an identification (ID), a first intercell terminal (C1), a second intercell terminal (C2), a third intercell terminal (C3) and a fourth intercell terminal (C4), respectively—discussed in more detail below.

The example battery cells illustrated in FIGS. 9A, 9B, 9C, and 9D, and described in detail above may also be used in this example battery pack. As such, the battery cells 200 described above will not be described again here. However, they will be referred to as battery cells 1200 or individual battery cells 1210, 1220, 1230, 1240, and/or 1250 with respect this example embodiment.

In one example embodiment, the battery pack 1100 is electrically connected/coupled to the power tool 1002 through the set of battery pack terminals 1276 disposed within the battery pack housing 1102/1104 and the set of (power) tool terminals 1024 disposed on the power tool 1002. That is, in one example embodiment, the set of battery pack terminals 1276 are electrically connectable to the set of power tool terminals 1024 of the power tool 1002.

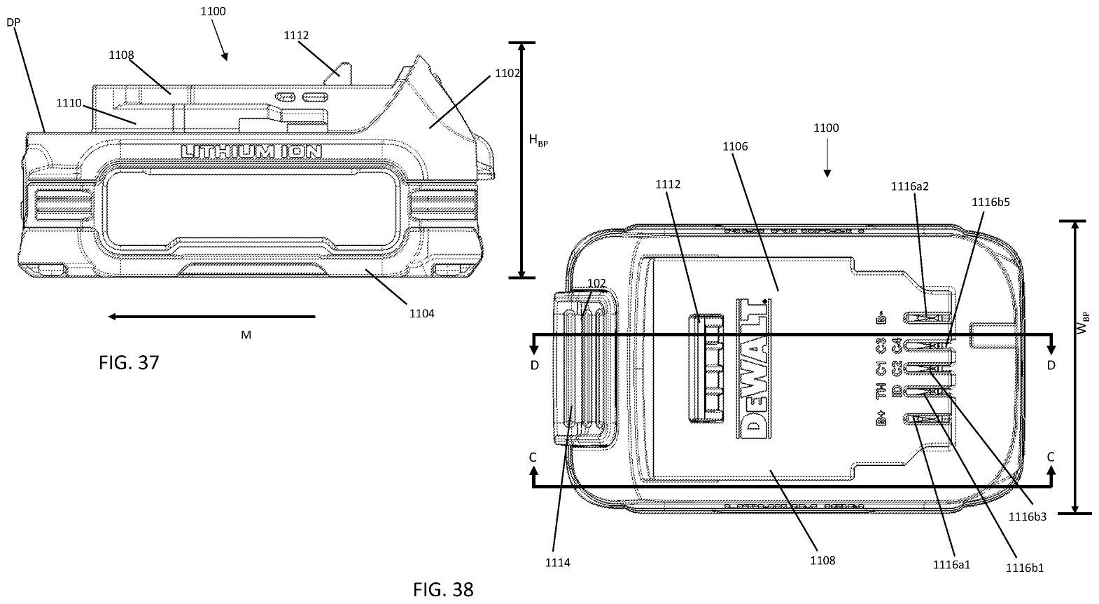

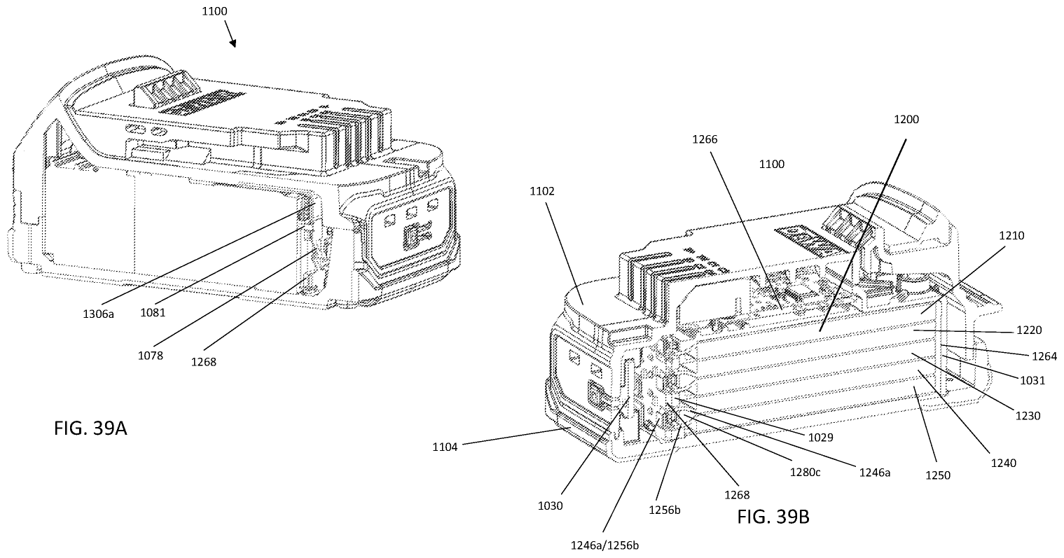

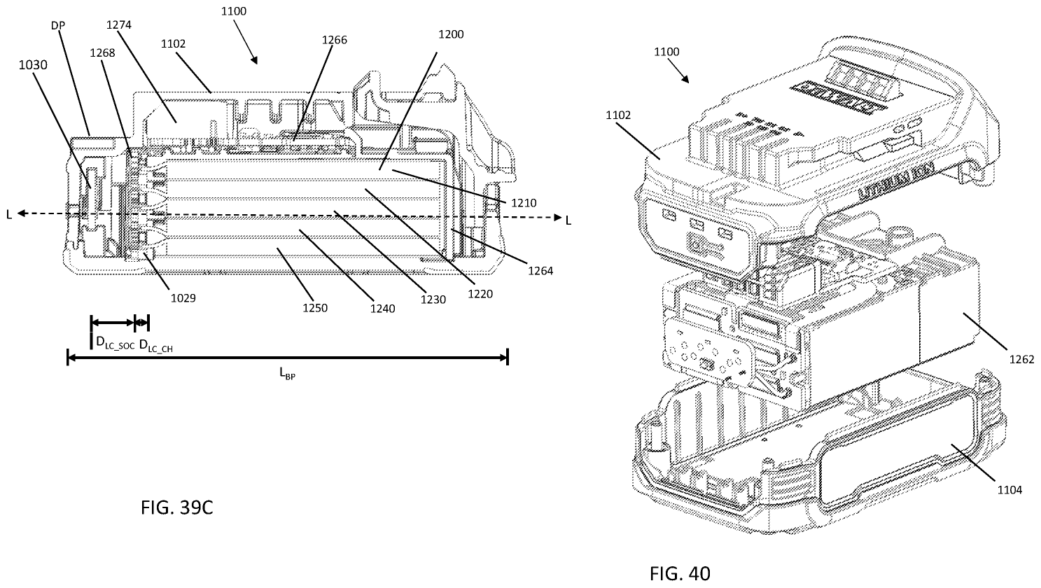

In one example embodiment, referring to FIGS. 37-38 and 39C, the battery pack 1100 has a length dimension L_{BP} (as shown in FIG. 39C), a width dimension W_{BP} (as shown in FIG. 38), and a height dimension H_{BP} (as shown in FIG. 37). In one example embodiment, a plane includes the length dimension L_{BP} and the width dimension W_{BP}. In one example embodiment, the height dimension H_{BP} and the width dimension W_{BP} are smaller than the length dimension L_{BP} of the battery pack 1100. In one example embodiment, the width dimension W_{BP} and the height dimension H_{BP} of the battery pack 1100 are perpendicular to the length dimension L_{BP}.

In one embodiment, the length dimension L_{BP} of the battery pack 1100 is parallel to a mating direction M (see FIG. 37). The mating direction M is a direction along which the battery pack 1100 is moved towards the power tool 1002 (as shown in FIGS. 85-91) other when coupling or operatively connecting the power tool 1002 and the battery pack 1100 to each other. The mating direction is parallel to a longitudinal direction L-L (shown in FIG. 39C) of the battery pack 1100. The width dimension W_{BP} and the height dimension H_{BP} of the battery pack 1100 are perpendicular to the mating direction M.

In one example embodiment, the battery pack 1100 has a datum/reference plane DP as shown in FIG. 39C. The datum plane DP is generally parallel to the battery cells 1200 of the battery pack 1100 (i.e., when in their assembled configuration) and is also generally parallel to a bottom surface of the battery pack 1100. The datum plane generally extends parallel to the mating direction M or longitudinal direction L-L of the battery pack 1100. The battery cells 1200 of the battery pack 1100 are positioned below the datum plane, while the battery pack power terminals 1276a1, 1276a2 of the battery pack 1100 are positioned above the datum plane.

In one example embodiment, referring to FIGS. 39B and 39C, the battery pack 1100 includes a first or primary printed circuit board (PCB) 1266, a second or secondary PCB 1268, and a third or tertiary PCB 1030. In one embodiment, the first/primary PCB 1266 is interchangeably referred to as a Battery Management System PCB (BMSPCB) 1266. In one embodiment, the second/secondary PCB 1268 is interchangeably referred to as a lead collection PCB (LCPCB) 1268. In one embodiment, the third/tertiary PCB 1030 is interchangeably referred to as a state of charge PCB (SOCPCB) 1030. Two or more of the BMSPCB 1266, the LCPCB 1268 and the SOCPCB 1030 may be coupled together and may be referred to as a battery management system module. A core pack 1262 (as shown and described below with respect to FIGS. 40-46) of the battery pack 1100 may include these three PCBs 1266, 1268 and 1030 therein. A battery management system module may be coupled to a cell holder (as described below) in a variety of manners.

That is, in one example embodiment, referring to FIGS. 39B and 39C, the battery pack 1100 includes three different/separate printed circuit boards, i.e., the first/primary PCB/BMSPCB 1266, the second/secondary PCB/LCPCB 1268, and the SOCPCB 1030. In one example embodiment, each of three printed circuit boards are interconnected to each other. The three printed circuit boards may be interconnected to each other by a flexible circuit, wires or other connectors. In one example embodiment, each of these printed circuit boards may be replaced by other types of circuits, including but not limited to flexible printed circuits.

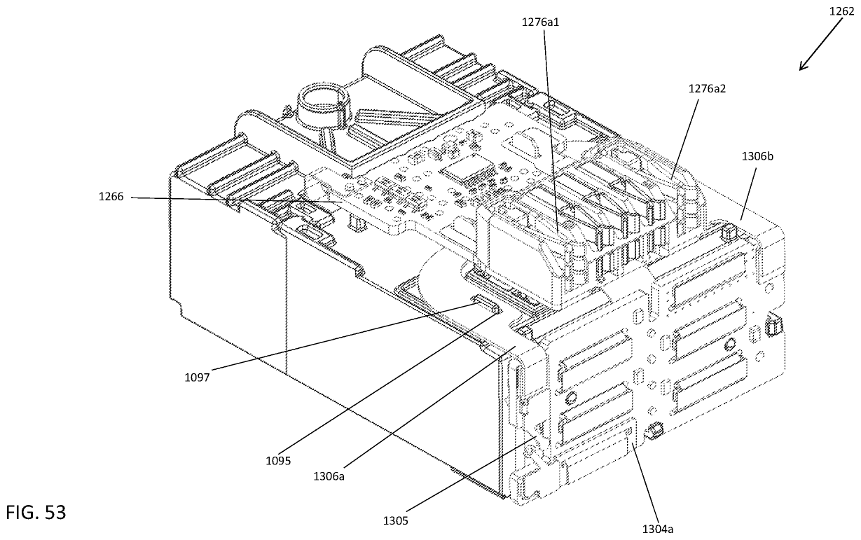

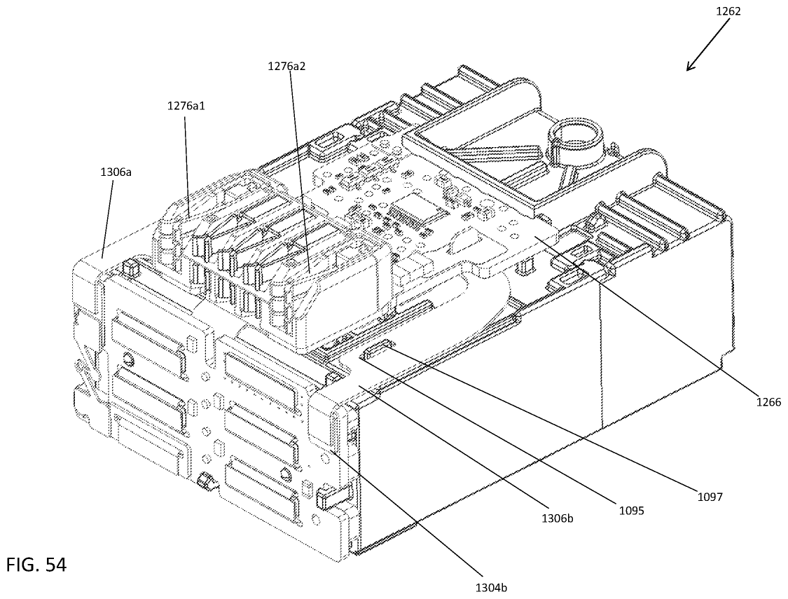

In one example embodiment, each of three printed circuit boards have their own functionality. In one example embodiment, the LCPCB 1268 is configured to receive battery cell tabs therethrough and facilitate the connection between the battery cells 1200 and the battery terminals 1276a1, 1276a2 (through power paths shown and described in FIGS. 53-54). In one example embodiment, the SOCPCB 1030 is configured to determine a state of charge of one or more battery cells 1200 in the battery pack 1100. In one example embodiment, the BMSPCB 1266 is configured to control the operation of the battery pack 1100.

In one example embodiment, the SOCPCB 1030, the BMSPCB 1266, and the LCPCB 1268 each is configured to mechanically support and electrically connect electronic components using conductive connection(s). In one example embodiment, the electronic components are generally soldered onto the respective printed circuit board to mechanically fasten and electrically connect the electronic components to the respective printed circuit board. In one example embodiment, the SOCPCB 1030, the BMSPCB 1266, and the LCPCB 1268 each have their own controller, control unit or processor mechanically fastened and electrically connected to the respective printed circuit board.

In one example embodiment, the SOCPCB 1030, the BMSPCB 1266, and the LCPCB 1268 each may include other components (e.g., electronic components), as may be appreciated by a person of ordinary skill in the art, mounted thereto or incorporated therein.

Referring to FIGS. 39B and 39C, the BMSPCB 1266 is generally parallel to the planes having the respective length and width dimensions of each of the battery cells 1200 and/or the battery pack 1100. In one example embodiment, the BMSPCB 1266 is along a substantially horizontal plane. In one example embodiment, the BMSPCB 1266 is generally parallel to the datum/reference plane DP of the battery pack 1100. In one example embodiment, the BMSPCB 1266 extends along the mating direction M.

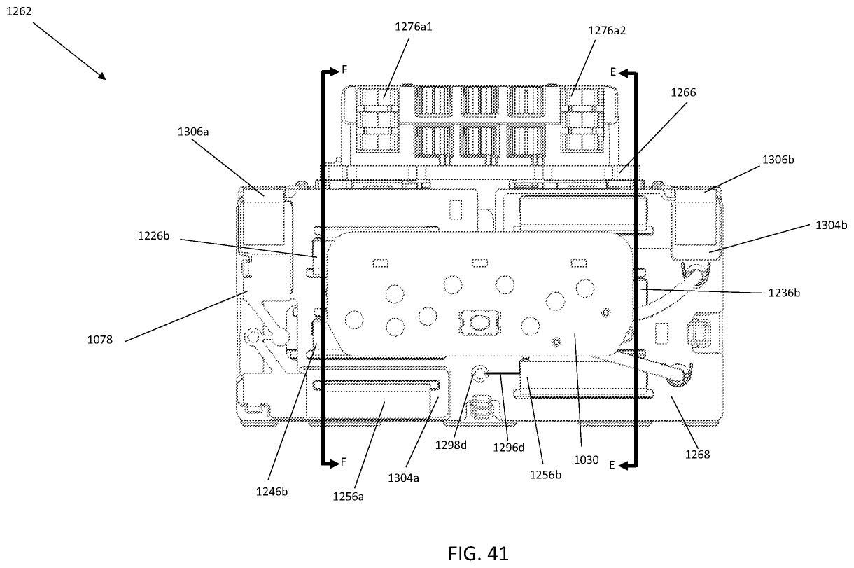

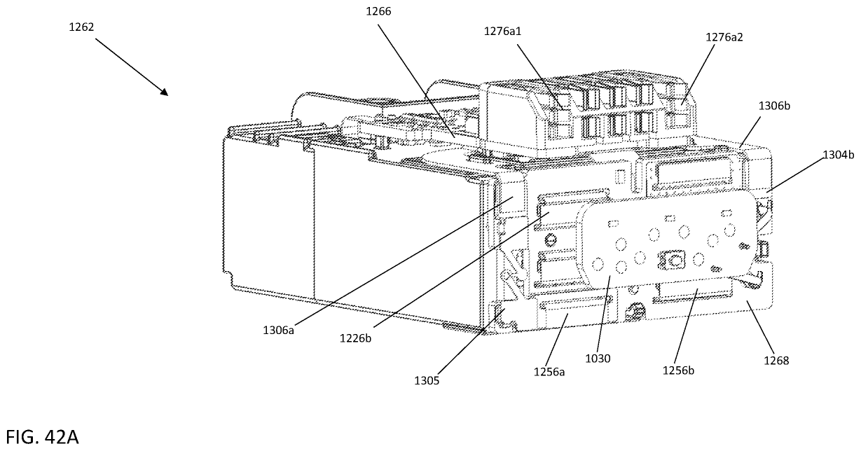

In one example embodiment, the terminal block 1274 (i.e., having the battery terminals 1276a1, 1276a2 as shown in FIG. 41) of the battery pack 1100 is mounted to/on the BMSPCB 1266. In one example embodiment, the BMSPCB 1266 is mounted on/affixed to the cell holder 1264 of the battery pack 1100.

In one example embodiment, the BMSPCB 1266 is configured for monitoring and controlling the operation of the battery pack 1100. In one example embodiment, the BMSPCB 1266 is configured to monitor voltage, current and/or temperature at various locations of the battery pack 1100. In one example embodiment, the BMSPCB 1266 is configured to monitor voltage, current and/or temperature of each battery cell 1200 of the battery pack 1100. In one example embodiment, the BMSPCB 1266 is configured to be operatively connected to voltage sensors, current sensors and/or temperature sensors that are disposed in various locations and/or operatively connected to each battery cell 1200 of the battery pack 1100 and receive voltage information, current information and temperature information from these sensors.

In one example embodiment, the BMSPCB 1266 is configured to process the received voltage information to control the operation of the battery pack 1100 if the received voltage information falls outside a predetermined voltage threshold. In one example embodiment, the BMSPCB 1266 is configured to process the received current information to control the operation of the battery pack 1100 if the received current information falls outside a predetermined current threshold. In one example embodiment, the BMSPCB 1266 is configured to process the received temperature information to control the operation of the battery pack 1100 if the received temperature information falls outside a predetermined temperature threshold.

In one example embodiment, the BMSPCB 1266 is also configured to shut down the charging or discharging of the battery pack 1100 and/or each battery cell 1200 of the battery pack 1100 if the received voltage, current and/or temperature information falls outside their respective predetermined thresholds. In one example embodiment, the BMSPCB 1266 is configured to shut down the charging or discharging of the battery pack 1100 and/or each battery cell 1200 of the battery pack 1100 in case of an overload or a short circuit. In one example embodiment, the LCPCB 1268 is configured to shut down the charging or discharging of the battery pack 1100 and/or each battery cell 1200 of the battery pack 1100 in case of an overload or a short circuit by the fuse 1305.

In one example embodiment, the LCPCB 1268 is generally perpendicular to the planes having the respective length and width dimensions of each of the battery cells 1200 and/or the battery pack 1100. In one example embodiment, the LCPCB 1268 and the SOCPCB 1030 are generally parallel to each other and each are generally perpendicular to the BMSPCB 1266. In one example embodiment, the LCPCB 1268 is generally perpendicular to the datum/reference plane DP of the battery pack 1100 and is positioned below the datum/reference plane DP of the battery pack 1100. In one example embodiment, the LCPCB 1268 is along a substantially vertical plane.

In one example embodiment, the LCPCB 1268 is generally parallel to the SOCPCB 1030. That is, as shown in FIGS. 39B and 39C, the LCPCB 1268 and the SOCPCB 1030 are generally parallel to each other but they are spaced apart from each other by a distance D_{LC_SOC}. In one example embodiment, the distance D_{LC_SOC} between the LCPCB 1268 and the SOCPCB 1030 is in a range from approximately 11.9 mm to approximately 14.5 mm. In one example embodiment, the distance D_{LC_SOC} between the LCPCB 1268 and the SOCPCB 1030 is in a range from approximately 12.5 mm to approximately 13.9 mm. In one example embodiment, the distance D_{LC_SOC} between the LCPCB 1268 and the SOCPCB 1030 is approximately 13.2 mm.

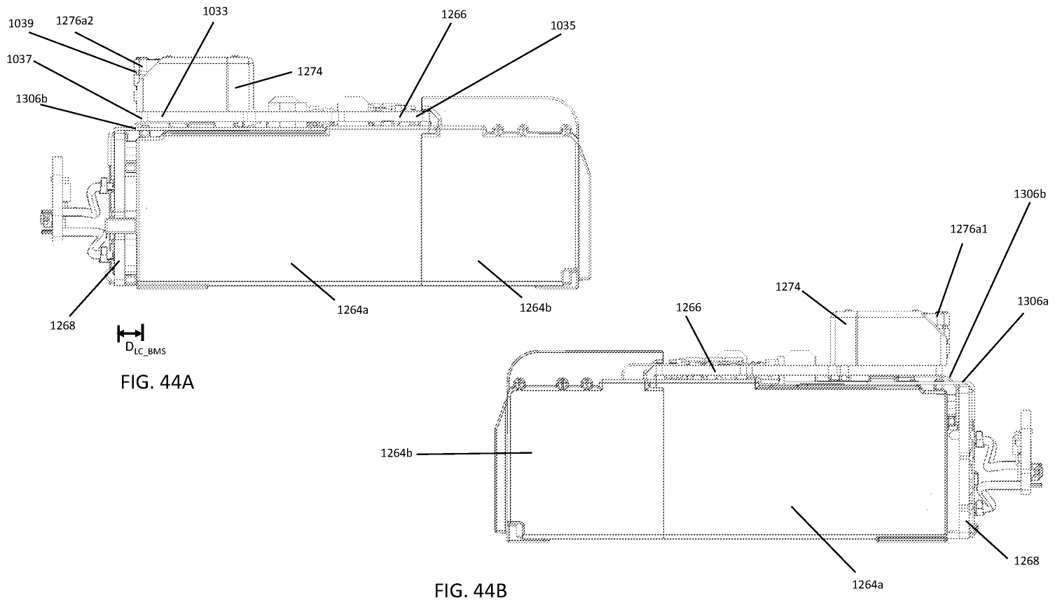

In one example embodiment, as shown in FIGS. 39B and 39C, the LCPCB 1268 is configured to be disposed forward of a front wall 1029 of the cell holder 1264 and positioned at a distance D_{LC_CH}, along a longitudinal axis L-L (as shown in FIG. 39C) of the battery pack 1100, from the battery pack power terminals 1276a1, 1276a2. In one example embodiment, the distance D_{LC_CH}, along a longitudinal axis L-L (as shown in FIG. 39C) of the battery pack 1100, between LCPCB 1268 and the battery pack power terminals 1276a1, 1276a2 is in a range from approximately 3.7 mm to approximately 4.5 mm. In one example embodiment, the distance D_{LC_CH}, along a longitudinal axis L-L (as shown in FIG. 39C) of the battery pack 1100, between the LCPCB 1268 and the battery pack power terminals 1276a1, 1276a2 is in a range from approximately 3.9 mm to approximately 4.3 mm. In one example embodiment, the distance D_{LC_CH}, along a longitudinal axis L-L (as shown in FIG. 39C) of the battery pack 1100, between the LCPCB 1268 and the battery pack power terminals 1276a1, 1276a2 is approximately 4.1 mm. In one example embodiment, the distance is measured from an end 1039 (see FIG. 44A) of the battery pack power terminals 1276a1, 1276a2.

In one example embodiment, referring to FIGS. 39B and 39C, the SOCPCB 1030 is generally perpendicular to the planes having the respective length and width dimensions of each of the battery cells 1200 (shown in FIG. 39B) and/or the battery pack 1100. In one example embodiment, the SOCPCB 1030 is generally parallel to the LCPCB 1268. That is, as shown in FIGS. 39B and 39C, the LCPCB 1268 and the SOCPCB 1030 are generally parallel to each other but they are spaced apart from each other by the distance D_{LC_SOC}. The distance D_{LC_SOC} is discussed in detail above with respect to the LCPCB 1268 and will not be described here again. In one example embodiment, the SOCPCB 1030 is along a substantially vertical plane. In one example embodiment, the SOCPCB 1030 is perpendicular to the datum/reference plane DP of the battery pack 1100 and is positioned below the datum/reference plane DP of the battery pack 1100.

In one example embodiment, as shown in FIGS. 39B and 39C, the SOCPCB 1030 is configured to be disposed forward, along the mating direction M of the battery pack 1100 and the power tool 1002, of the LCPCB 1268, the front wall 1029 of the cell holder 1264 and the battery cells 1200. In one example embodiment, the SOCPCB 1030 is configured to be disposed forward, along the longitudinal axis (L-L) (shown in FIG. 39C) of the battery pack 1100 or the mating direction M, of the battery pack power terminals 1276a1, 1276a2 and the BMSPCB 1266.

In one example embodiment, the SOCPCB 1030 includes a circuit including a processor and a sensor. In one example embodiment, the sensor of the SOCPCB 1030 is configured to measure a state of charge of the battery pack 1100 and/or a state of charge of one or more battery cells 1200 in the battery pack 1100. In one example embodiment, the SOCPCB 1030 is configured to determine a state of charge of the battery pack 1100 and/or a state of charge of one or more battery cells 1200 in the battery pack 1100.

In one example embodiment, as shown in FIG. 39B-39C, the plurality of battery cells 1200 includes a first battery cell 1210 and a second battery cell 1220. In the illustrated example embodiment, the plurality of battery cells 1200 disposed in the battery pack housing 1102/1104 include five pouch-type battery cells 1210-1250. A person of ordinary skill in the art would readily appreciate that the plurality of battery cells 1200 disposed in the battery pack housing 1102/1104 may include more or fewer pouch battery cells, depending upon the requirements of the battery pack or an associated tool platform.

In one example embodiment, each of the battery cells 1200 (as shown in FIG. 39B) has a length dimension L (as shown in FIG. 9C), a width dimension W (as shown in FIG. 9A), and a height/thickness dimension H1 (as shown in FIG. 9D). In one example embodiment, a plane includes the length dimension L and the width dimension W. In one example embodiment, the height/thickness dimension H1 and the width dimension W are smaller than the length dimension L of the battery cell. In one example embodiment, the width dimension W and the height/thickness dimension H1 of the battery cell are perpendicular to the length dimension L. The battery cells 1200 of the battery pack 1100, when assembled, are parallel to the datum/reference plane DP.

In one example embodiment, each battery cell 1210-1250 includes any or all the features of the battery cells described (above and below) in other example embodiments in the present parent application. For example, the details about the battery cell and its tabs are described in detail with respect to FIGS. 9A-9D above and, therefore, they will not be described in detail here again.

In one example embodiment, the battery pack 1100 may include the battery cells 1200 having a pouch form factor, sometimes referred to as a pouch format or pouch configuration or pouch geometric shape. In one example embodiment, the battery cells 1200 of the battery pack 1100 are pouch-type battery cells.

In one example embodiment, a string of battery cells—battery cells may be simply referred to as cells—is a plurality of cells connected in series. For example, a set of battery cells may include two or more battery cells connected in series. In another example embodiment, a set of battery cells may include two strings of battery cells connected in parallel. In another example embodiment, a set of battery cells my include three strings of battery cells connected in parallel. In yet another example embodiment, the battery pack has a configuration including a block of battery cells. One way to describe these battery cell configurations—and by extension a battery pack including these battery cells configurations—is by the number of battery cells of the string connected in series (X), the number of strings of battery cells connected in parallel (Y), and the number of blocks of battery cells (Z). In other words, in fixed voltage battery packs, the battery packs can be referred to as XSYZP where S stands for series and P stands for parallel.

In one example embodiment, the battery cells 1200 are in a XS1P configuration. In one example embodiment, the battery cells 1200 are in a XS2P configuration. In one example embodiment, the battery cells 1200 are in a XS3P configuration. The X will be replaced by the number of battery cells in a string. For example, if battery pack includes a single string of battery cells and the single string of battery cells includes five battery cells connected in series, the battery cell configuration may be referred to as 5S1P. And, if the battery pack includes two strings of battery cells and the first string includes five battery cells connected in series and the second string includes five battery cells connected in series and the two strings are connected to each other in parallel, the battery cell configuration may be referred to as 5S2P. And, if the battery pack includes three strings of battery cells and the first string includes five battery cells connected in series, the second string includes five battery cells connected in series, and the third string includes five battery cells connected in series and the three strings are connected to each other in parallel, the cell configuration may be referred to as 5S3P.

Referring to FIG. 40, the example battery pack 1100 includes a core pack 1262 that resides in the cavity created by the joining of the upper housing 1102 and the lower housing 1104 of the battery pack 1100. In one example embodiment, the core pack 1262 includes a cell holder 1264. For example, the details about the core pack 1262 and/or the cell holder 1264 are described in detail with respect to FIGS. 11A-20B above and, therefore, they will not be described in detail here again. In one example embodiment, the cell holder 1264 includes at least a front wall 1029 and a rear wall 1031.

Referring to FIGS. 41-46, there is illustrated an example core pack 1262, in accordance with the present disclosure. FIG. 41 illustrates a front elevation view of the core pack 1262.

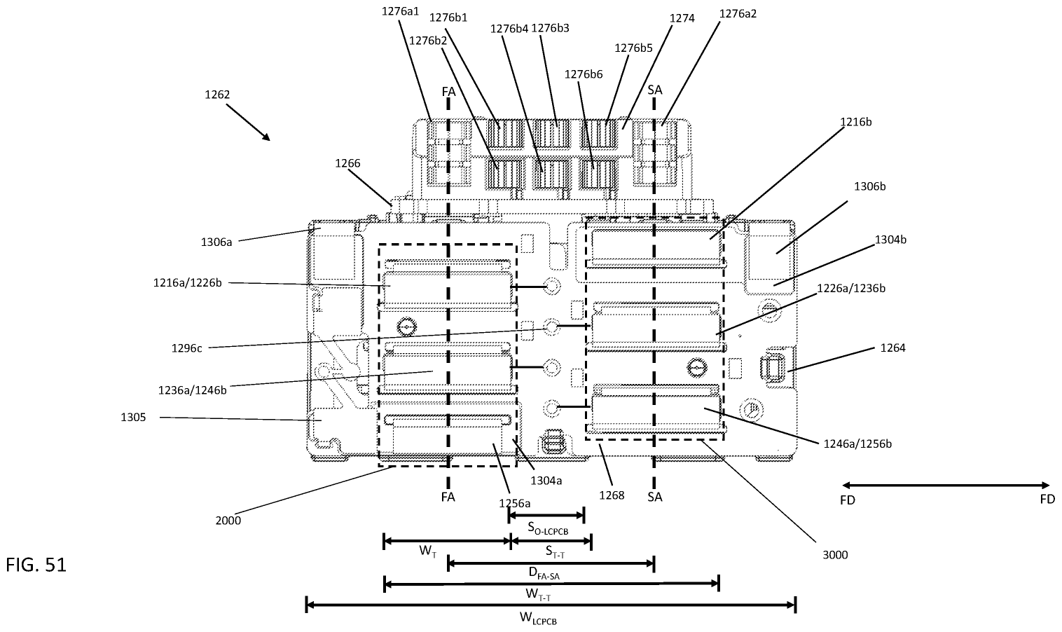

FIG. 44A illustrates a first side elevation view of the core pack 1262. FIG. 44B illustrates a second side elevation view of the core pack 1262. In one example embodiment, as shown in FIGS. 44A and 44B, the BMSPCB 1266 includes a first end portion 1033 and a second end portion 1035 opposing the first end portion 1033. In one example embodiment, the battery pack power terminals 1276a1, 1276a2 are disposed at the first end portion 1033 of the BMSPCB 1266. In one example embodiment, the first end portion 1033 of the BMSPCB 1266 is closer to the LCPCB 1268 and the second end portion 1035 is away from the LCPCB 1268. In one example embodiment, the first end portion 1033 of the BMSPCB 1266 is also closer to cell tabs 1216a, 1216b, 1226a, 1226b, 1236a, 1236b, 1246a, 1246b, 1256a, 1256b (shown in FIG. 51) of the battery cells 1200.

In one example embodiment, as shown in FIG. 44A, the LCPCB 1268 is positioned at a distance D_{LC-BMS}, along the longitudinal axis L-L or the mating direction M of the battery pack 1100, from the first end portion 1033 of the BMSPCB 1266. In one example embodiment, the distance D_{LC-BMS} is in a range from approximately 3.7 mm to approximately 4.5 mm. In one example embodiment, the distance D_{LC-BMS} is in a range from approximately 3.9 mm to approximately 4.3 mm. In one example embodiment, the distance D_{LC-BMS} is approximately 4.1 mm. In one example embodiment, the distance D_{LC-BMS} is measured from an end 1037 of the first end portion 1033 of the BMSPCB 1266.

In one example embodiment, the end 1037 of the first end portion 1033 of the BMSPCB 1266 is at approximately the same position, along the longitudinal axis L-L/mating direction M of the battery pack 1100, as the end 1039 of the battery pack power terminals 1276a1, 1276a2. In such an example embodiment, the LCPCB 1268 is positioned at approximately the same distance, along the longitudinal axis L-L of the battery pack 1100, from both the BMSPCB 1266 and the battery pack power terminals 1276a1, 1276a2. In another example embodiment, the end 1037 of the first end portion 1033 of the BMSPCB 1266 is at a different position, along the longitudinal axis L-L of the battery pack 1100, as the end 1039 of the battery pack power terminals 1276a1, 1276a2. In such an example embodiment, the LCPCB 1268 is positioned at different distances, along the longitudinal axis L-L of the battery pack 1100, from the BMSPCB 1266 and from the battery pack power terminals 1276a1, 1276a2.

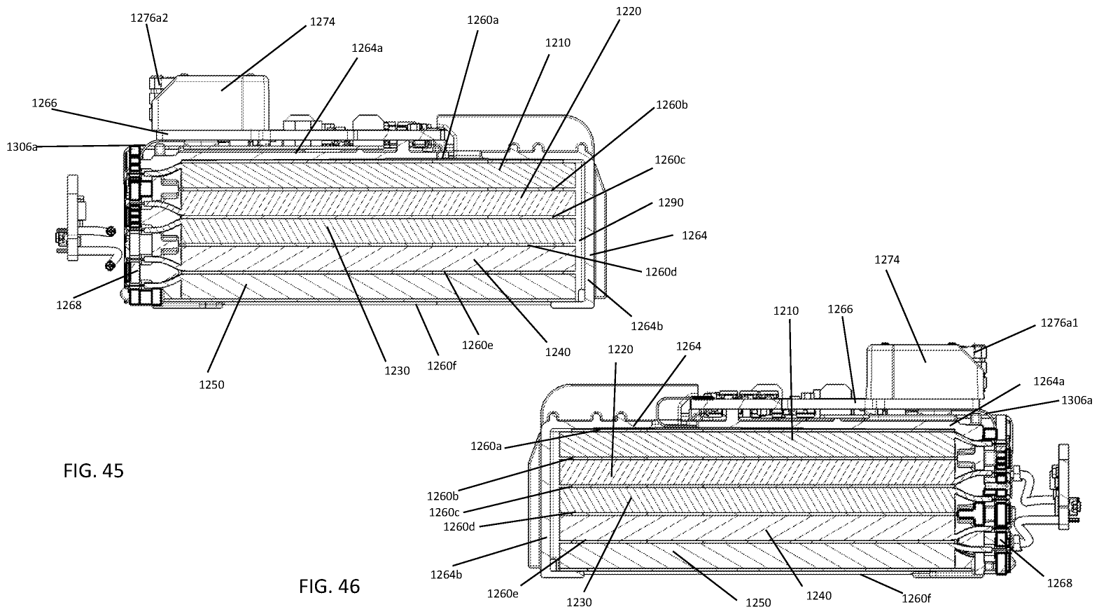

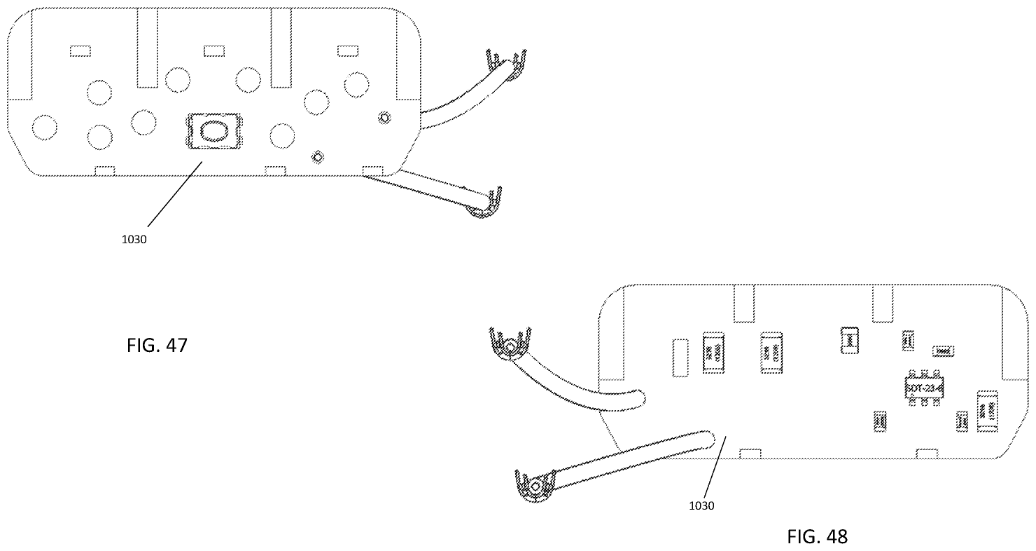

FIG. 45 illustrates a first section view of the core pack 1262 taken along section line E-E of FIG. 41 and FIG. 46 illustrates a second section view of the core pack 1262 taken along section line F-F of FIG. 41. Referring to FIGS. 47-50, there is illustrated an example SOCPCB 1030. Referring to FIGS. 51-54, there is illustrated the example core pack 1262 without the SOCPCB 1030.

In the illustrated, example embodiment of FIGS. 45-46, the cell holder 1264 of the core pack 1262 may include a first, front (or forward) portion (or housing) 1264a and a second, rear (or rearward) portion (or housing) 1264b. The first portion 1264a and the second portion 1264b mate to form the cell holder housing at a mating (parting) line. The cell holder 1264 may have a generally rectangular box shape having five walls. The cell holder 1264 may include a front (forward) wall, a rear (rearward) wall, a top wall, a first side wall and a second side wall. Each wall may include an outer surface and an inner surface. The inner surface of the walls forms a cavity of the cell holder. The cell holder housing may have other generally similar shapes and still fall within the scope of the present patent application.

Also, referring to FIGS. 45-46, the core pack 1262 may also include a set of pouch battery cells 1200. In the illustrated embodiment, the core pack 1262 includes a set of five pouch battery cells 1210, 1220, 1230, 1240, 1250 and six insulating layers 1260a-1260f. Each battery cell of the set of battery cells 1200 are as described above. Alternate embodiments of the core pack 1262 may include more or fewer pouch battery cells and more or fewer insulating layers, depending upon the requirements of the battery pack or an associated tool platform. The features and advantages of the instant disclosure are not limited by the number of battery cells in the core pack. In addition, the battery cells may be of a double cup configuration instead of the single cup configuration illustrated in the figures.

As shown in FIG. 51, the core pack 1262 may include a terminal block 1274. The terminal block 1274 may be mounted to the primary PCB 1266. The terminal block 1274 may hold a set of battery pack terminals 1276 in a fixed relation to each other. The set of battery pack terminals 1276 may include a (first) subset of terminals 1276a (power terminals) and a (second) subset of terminals 1276b (sense (or signal)). The subset of sense terminals 1276b may include a thermistor terminal (TH) 1276b1, an identification terminal (ID) 1276b2, a first intercell terminal (C1) 1276b3, a second intercell terminal (C2) 1276b4, a third intercell terminal (C3) 1276b5, and a fourth intercell terminal (C4) 1276b6.

In one example embodiment, referring to FIGS. 39B-39C, 41 and 51, the set of battery pack terminals 1276a are electrically connected to the plurality of battery cells 1200. The set of battery pack terminals 1276a comprises a first battery pack power terminal 1276a1 and a second battery pack power terminal 1276a2. In one example embodiment, one of the battery pack power terminals 1276a1, 1276a2 is a positive battery pack power terminal and the other of the battery pack power terminals 1276a1, 1276a2 is a negative battery pack power terminal. In one example embodiment, the battery pack terminals 1276a are generally soldered onto the BMSPCB 1266 to mechanically fasten and electrically connect the battery pack terminals 1276a to the BMSPCB 1266.

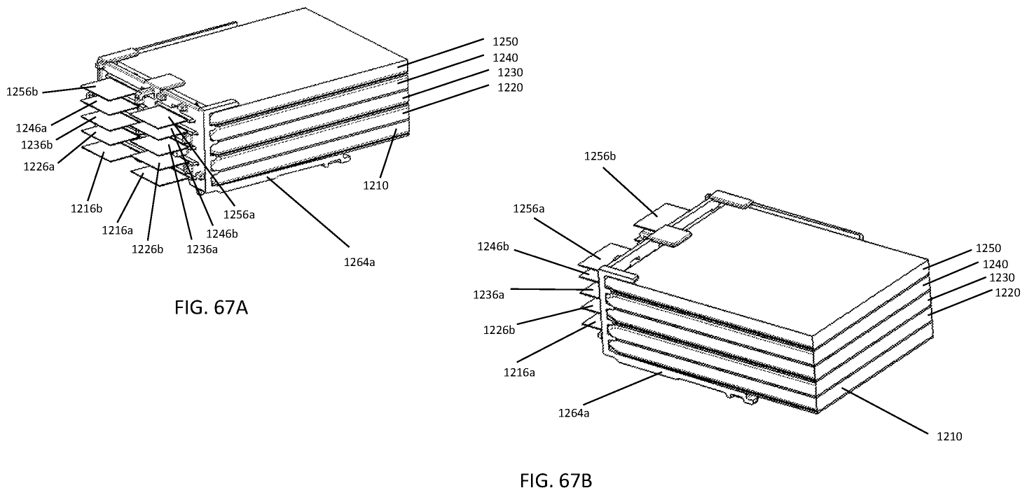

In one example embodiment, as shown in FIG. 67A, each of the plurality of battery cells 1200 has a first tab and a second tab. For example, a first battery cell 1210 of the plurality of battery cells 1200 has a first tab 1216a and a second tab 1216b. And, a second battery cell 1220 of the plurality of battery cells 1200 has a first tab 1226a and a second tab 1226b. The first tab 1216a of the first battery cell 1210 may be a positive tab and have a first tab width dimension W_{T} (extending in the direction FD-FD) and the second tab 1216b of the first battery cell 1210 may be negative tab and have a second tab width dimension W_{T} (extending in the direction FD-FD). The first tab width dimension W_{T} may be different than the second tab width dimension W_{T}. The first tab width dimension W_{T} may be less than the second tab width dimension W_{T}. The first tab 1226a of the second battery cell 1220 may be a positive tab and have a first tab width dimension W_{T} (extending in the direction FD-FD) and the second tab 1226b of the second battery cell 1220 may be a negative tab and have a second tab width dimension W_{T} (extending in the direction FD-FD). The first tab width dimension W_{T} of the first tab 1226a of the second battery cell 1220 may be the same as the first tab width dimension W_{T} of the first tab 1216a of the first battery cell 1210 and the second tab width dimension W_{T} of the second tab 1226b of the second battery cell 1220 may be the same as the second tab width dimension W_{T} of the second tab 1216b of the first battery cell 1210. In an example embodiment, the first tab 1216a of the first battery cell 1210 has a first tab width dimension W_{T} of approximately 12 mm, the second tab 1216b of the first battery cell 1210 has a second tab width dimension W_{T} of approximately 14 mm, the first tab 1226a of the second battery cell 1220 has a first tab width dimension W_{T} of approximately 12 mm, and the second tab 1226b of the second battery cell 1220 has a second tab width dimension W_{T} of approximately 14 mm. In one example embodiment, the first tab width dimension W_{T} of the cells 1200 may be in a range of approximately 10.8 mm to approximately 13.2 mm. In one example embodiment, the first tab width dimension W_{T} may be in a range of approximately 11.4 mm to 12.6 mm. In one example embodiment, the second tab width dimension W_{T} of the cells 1200 may be in a range of approximately 12.6 mm to approximately 15.4 mm. In one example embodiment, the second tab width dimension W_{T} may be in a range of approximately 13.3 mm to 14.7 mm.

In one example embodiment, as shown in FIG. 51, the battery pack 1100 has a tab-to-tab width W_{T-T}. In one example embodiment, the width W_{T-T}, is taken along a first direction FD-FD. In this example embodiment, the width W_{T-T} extends from a first outer or outside end or side of a tab in a first column of tabs 2000 of one of the cells of the set of cells 1200 to an outer side of a second tab in the second column of tabs 3000 of the one of the cells of the set of cells 1200. In one example embodiment, the width W_{T-T} may be taken from the outer side of a first (positive) tab of a cell, e.g., tab 1216a of cell 1210, to the outer side of a second (negative) tab of the cell, e.g., tab 1216b of cell 1210. This width may be referred to as a positive tab-to-negative tab width W_{T-T}. In one example embodiment, the positive tab-to-negative tab width W_{T-T} of the battery pack 1100 may be in a range from approximately 32.4 mm to approximately 39.6 mm. In one example embodiment, the positive tab-to-negative tab width W_{T-T} of the battery pack 1100 may be in a range from approximately 34.2 mm to approximately 37.8 mm. In one example embodiment, the positive tab-to-negative tab width, W_{T-T} of the battery pack 1100 may be approximately 3§ 0.0 mm.

Alternatively, the width W_{T-T} may be taken from the outer side of a second (negative) tab of a cell, e.g., tab 1226b of cell 1220, to the outer side of a second (negative) tab of another cell, e.g., tab 1216b of cell 1210. This width may be referred to as a negative tab-to-negative tab width W_{T-T}. In one example embodiment, the negative tab-to-negative tab width W_{T-T} of the battery pack 1100 may be in a range from approximately 33.3 mm to approximately 40.7 mm. In one example embodiment, the negative tab-to-negative tab width W_{T-T} of the battery pack 1100 may be in a range from approximately 35.2 mm to approximately 38.8 mm. In one example embodiment, the negative tab-to-negative tab width, W_{T-T} of the battery pack 1100 may be approximately 37.0 mm.

Alternatively, the width W_{T-T} may be taken from the outer side of a first (positive) tab of a cell, e.g., tab 1216a of cell 1210, to the outer side of a first (positive) tab of another cell, e.g., tab 1226a of cell 1220. This width may be referred to as a positive tab-to-positive tab width W_{T-T}. In one example embodiment, the positive tab-to-positive tab width W_{T-T} of the battery pack 1100 may be in a range from approximately 31.5 mm to approximately 38.5 mm. In one example embodiment, the positive tab-to-negative tab width W_{T-T} of the battery pack 1100 may be in a range from approximately 33.2 mm to approximately 36.8 mm. In one example embodiment, the positive tab-to-negative tab width, W_{T-T} of the battery pack 1100 may be approximately 35.0 mm. In one example embodiment, the tab-to-tab width W_{T-T} of the battery pack 1100 is less than the width dimension W_{LCPCB} of the LCPCB 1268.

In one example embodiment, as shown in FIG. 51, there is a spacing S_{T-T} between the battery cell tabs in column 2000 and the battery cell tabs in column 3000. In one example embodiment, the spacing S_{T-T}, is taken along a first direction FD-FD. In this example embodiment, the spacing S_{T-T} extends from an inner or inside end or side of a tab in the first column of tabs 2000 of one of the cells of the set of cells 1200 to an inner end of a tab in the second column of tabs 3000 of the one of the cells of the set of cells 1200. In one example embodiment, the first tab of a cell 1200 may have a width different than the second tab of the cell 1200. In one example embodiment, the width of the first tab may be less than the width of the second tab. In one example embodiment, the first tab may be a positive tab and the second tab may be a negative tab. In one example embodiment, the spacing S_{T-T} may be taken from the inner side of a first (positive) tab of a cell, e.g., tab 1216a of cell 1210, to the inner side of a second (negative) tab of the cell, e.g., tab 1216b of cell 1210. This spacing may be referred to as a positive tab-to-negative tab spacing S_{T-T}. In one example embodiment, the positive tab-to-negative tab spacing S_{T-T} of the battery pack 1100 may be in a range from approximately 9.0 mm to approximately 11.0 mm. In one example embodiment, the positive tab-to-negative tab spacing S_{T-T} of the battery pack 1100 may be in a range from approximately 9.5 mm to approximately 10.5 mm. In one example embodiment, the positive tab-to-negative tab spacing S_{T-T} of the battery pack 1100 may be approximately 10.0 mm.

Alternatively, the spacing S_{T-T} may be taken from the inner side of a second (negative) tab of a cell, e.g., tab 1226b of cell 1220, to the inner side of a second (negative) tab of another cell, e.g., tab 1216b of cell 1210. This spacing may be referred to as a negative tab-to-negative tab spacing S_{T-T}. In one example embodiment, the negative tab-to-negative tab spacing S_{T-T} of the battery pack 1100 may be in a range from approximately 8.1 mm to approximately 9.9 mm. In one example embodiment, the negative tab-to-negative tab spacing S_{T-T} of the battery pack 1100 may be in a range from approximately 8.6 mm to approximately 9.4 mm. In one example embodiment, the negative tab-to-negative tab spacing S_{T-T} of the battery pack 1100 may be approximately 9.0 mm.

Alternatively, the spacing S_{T-T} may be taken from the inner side of a first (positive) tab of a cell, e.g., tab 1216a of cell 1210, to the inner side of a first (positive) tab of another cell, e.g., tab 1226a of cell 1220. This spacing may be referred to as a positive tab-to-positive tab spacing S_{T-T}. In one example embodiment, the positive tab-to-positive tab spacing S_{T-T} of the battery pack 1100 may be in a range from approximately 9.9 mm to approximately 12.1 mm. In one example embodiment, the positive tab-to-positive tab spacing S_{T-T} of the battery pack 1100 may be in a range from approximately 10.4 mm to approximately 11.6 mm. In one example embodiment, the positive tab-to-positive tab spacing S_{T-T} of the battery pack 1100 may be approximately 11.0 mm. These values of the spacing between the battery cell tabs S_{T-T} are merely examples

In one example embodiment, as shown in FIG. 51, the spacing between the openings (that are configured to receive the battery cell tabs) in the LCPCB 1268 S_{O-LCPCB} is approximately 4.7 mm. This value of the spacing between the openings in the LCPCB 1268 S_{O-LCPCB} is exemplary. In one example embodiment, the spacing between the openings (that are configured to receive the battery cell tabs) in the LCPCB 1268 S_{O-LCPCB} is in a range from approximately 4.5 mm to approximately 4.9 mm. In one example embodiment, the spacing between the openings (that are configured to receive the battery cell tabs) in the LCPCB 1268 S_{O-LCPCB} is in a range from approximately 4.2 mm to approximately 5.2 mm.

In one example embodiment, as shown in FIG. 51, the width dimension W_{LCPCB} of the LCPCB 1268 is approximately 54.0 mm. In one example embodiment, the width dimension W_{LCPCB} of the LCPCB 1268 is in a range from approximately 51.3 mm to approximately 56.7 mm. In one example embodiment, the width dimension W_{LCPCB} of the LCPCB 1268 is in a range from approximately 48.6 mm to approximately 59.4 mm.

In one example embodiment, the width dimension W_{LCPCB} of the LCPCB 1268 is greater than the tab-to-tab width W_{T-T} of the battery pack 1100. In yet another example embodiment, the width dimension W_{LCPCB} of the LCPCB 1268 is greater than the tab-to-tab width W_{T-T} of the battery pack 1100 by approximately 17 mm. In one example embodiment, the width dimension W_{LCPCB} of the LCPCB 1268 is greater than the tab-to-tab width W_{T-T} of the battery pack 1100 by a range from approximately 16.2 mm to approximately 17.9 mm. In one example embodiment, the width dimension W_{LCPCB} of the LCPCB 1268 is greater than the tab-to-tab width W_{T-T} of the battery pack 1100 by a range from approximately 15.3 mm to approximately 18.7 mm.

In one example embodiment, the planes (having the respective length and width dimensions) of each of the battery cells 1200 and/or the battery pack 1100 are substantially horizontal and are parallel to each other.

As illustrated in FIGS. 51, 67A, 76A, 76B, 76D, 76E, the tabs 1216a, 1216b, 1226a, 1226b, 1236a, 1236b, 1246a, 1246b, 1256a, 1256b of the battery cells 1200 extend through associated/corresponding slots of the cell holder 1264 and the lead collection PCB 1268. After battery cells 1200 have been placed in the cell holder 1264 and the tabs 1216a, 1216b, 1226a, 1226b, 1236a, 1236b, 1246a, 1246b, 1256a, 1256b have been inserted through the associated slots of the cell holder 1264 and the lead collection PCB 1268, the tabs 1216a, 1216b, 1226a, 1226b, 1236a, 1236b, 1246a, 1246b, 1256a, 1256b are folded to be combined with a tab of an adjacent battery cell. Specifically, the second tab 1246b of the fourth cell 1240 is combined with the first tab 1236a of the third cell 1230 (combination 11) and the second tab 1226b of the second cell 1220 is combined with the first tab 1216a of the first cell 1210 (combination 12). The two combinations of tabs 11, 12 along with the first tab 1256a of the fifth cell 1250 forms a first column of tabs 2000. Similarly, the first tab 1246a of the fourth cell 1240 is combined with the second tab 1256b of the fifth cell 1250 (combination 13) and the second tab 1236b of the third cell 1230 is combined with the first tab 1226a of the second cell 1220 (combination 14). The two combinations of tabs 13, 14 along with the second tab 1216b of the first cell 1210 forms a second column of tabs 3000.

In one example embodiment, as shown in FIG. 51, the first battery pack power terminal 1276a1 is aligned with a first tab 1216a of the first battery cell 1210 and a second tab 1226b of the second battery cell 1220. In one example embodiment, the second battery pack power terminal 1276a2 aligned with a first tab 1226a of the second battery cell 1220 and a second tab 1216b of the first battery cell 1210.

In one example embodiment, referring to FIG. 51, the first battery pack power terminal 1276a1 is aligned with the first tab 1216a of the first battery cell 1210 and the second tab 1226b of the second battery cell 1220 along a first axis FA-FA in a direction generally perpendicular to the length (e.g., L as shown in FIG. 9C) and the width (e.g., W as shown in FIG. 9A) of the battery cells 1200 and/or the length (e.g., L_{BP} as shown in FIG. 39C) and the width (e.g., W_{BP} as shown in FIG. 38) of the battery pack 1100. In one example embodiment, the first axis FA-FA is in a direction generally perpendicular to the plane including the length (e.g., L as shown in FIG. 9C) and the width (e.g., W as shown in FIG. 9A) of the battery cells 1200 and/or the plane including the length (e.g., L_{BP} as shown in FIG. 39C) and the width (e.g., W_{BP} as shown in FIG. 38) of the battery pack 1100. In one example embodiment, the first axis FA-FA is also generally parallel to the height (e.g., H1 as shown in FIG. 9D) of the battery cells 1200 and/or the height (e.g., H_{BP} as shown in FIG. 37). In one example embodiment, the first axis FA-FA is also generally perpendicular to the mating direction M and the datum/reference plane DP.

In one example embodiment, also referring to FIG. 51, the second battery pack power terminal 1276a2 is aligned with the second tab 1216b of the first battery cell 1210 and the first tab 1226a of the second battery cell 1220 along a second axis SA-SA in a direction generally perpendicular to the length (e.g., L as shown in FIG. 9C) and the width (e.g., W as shown in FIG. 9A) of the battery cells 1200 and/or the length (e.g., L_{BP} as shown in FIG. 39C) and the width (e.g., W_{BP} as shown in FIG. 38) of the battery pack 1100. In one example embodiment, the second axis SA-SA is in a direction generally perpendicular to the plane including the length (e.g., L as shown in FIG. 9C) and the width (e.g., W as shown in FIG. 9A) of the battery cells 1200 and/or the plane including the length (e.g., L_{BP} as shown in FIG. 39C) and the width (e.g., W_{BP} as shown in FIG. 38) of the battery pack 1100. In one example embodiment, the second axis SA-SA is also generally parallel to the height (e.g., H1 as shown in FIG. 9D) of the battery cells 1200 and/or the height (e.g., H_{BP} as shown in FIG. 37). In one example, embodiment, the first axis FA-FA is generally perpendicular to the mating direction M and the datum/reference plane DP.

In one example embodiment, as shown in FIG. 51, the first axis FA-FA and the second axis SA-SA are generally parallel to each other. In one example embodiment, the first axis FA-FA and the second axis SA-SA are spaced apart by a distance D_{FA-SA}. In one example embodiment, the distance D_{FA-SA} between the first axis FA-FA and the second axis SA-SA is in a range from approximately 20.7 mm to approximately 25.3 mm. In one example embodiment, the distance D_{FA-SA} between the first axis FA-FA and the second axis SA-SA is in a range from approximately 21.9 mm to approximately 24.2 mm. In one example embodiment, the distance D_{FA-SA} between the first axis FA-FA and the second axis SA-SA is approximately 23 mm. In one example embodiment, the distance D_{FA-SA} between the first axis FA-FA and the second axis SA-SA is same as a center to center distance between the first battery pack power terminal 1276a1 and the second battery pack power terminal 1276a2.

In one example embodiment, the first tab 1216a of the first battery cell 1210 is a positive tab, the second tab 1216b of the first battery cell 1210 is a negative tab, the second tab 1226b of the second battery cell 1220 is a negative tab, and the first tab 1226a of the second battery cell 1220 is a positive tab.

In one example embodiment, the first axis FA-FA passes through the first column of tabs 2000 such that portions of the first column of tabs 2000 are equally positioned on both sides of the first axis FA-FA. In one example embodiment, the second axis SA-SA passes through the second column of tabs such that portions of the second column of tabs 3000 are equally positioned on both sides of the second axis SA-SA.

In one example embodiment, the combination of the first tab 1216a/1226a and the second tab 1216b/1226b of each of the two battery cells 1210 or 1220 are adjacent to each other in a first direction FD-FD. In one example embodiment, the first direction FD-FD is generally perpendicular to the first axis FA-FA and the second axis SA-SA. In one example embodiment, the first direction FD-FD is generally parallel to the plane including the length (e.g., L as shown in FIG. 9C) and the width (e.g., W as shown in FIG. 9A) of the battery cells 1200 and/or the plane including the length (e.g., L_{BP} as shown in FIG. 39C) and the width (e.g., W_{BP} as shown in FIG. 38) of the battery pack 1100. In one example embodiment, the first direction FD-FD is also generally perpendicular to the height (e.g., H1 as shown in FIG. 9D) of the battery cells 1200 and/or the height (e.g., H_{BP} as shown in FIG. 37).

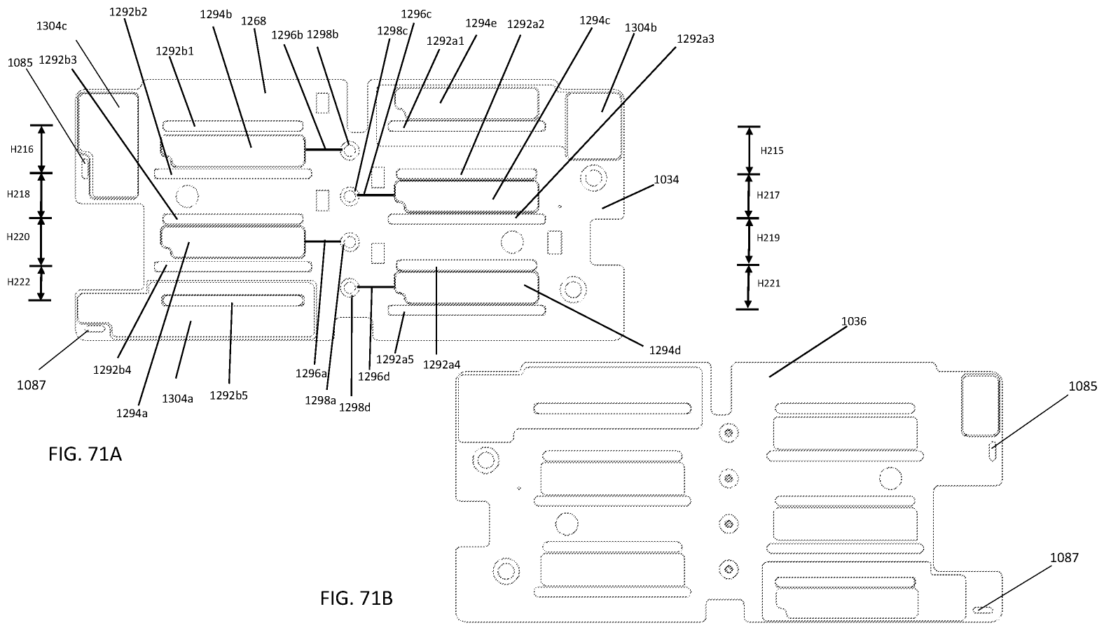

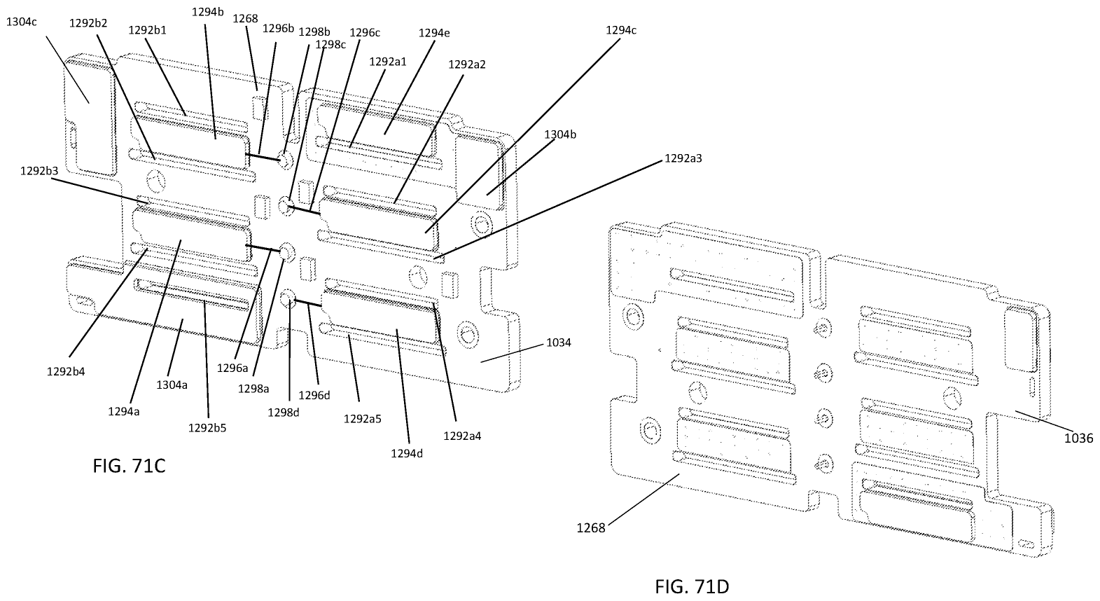

In one example embodiment, as shown in FIGS. 51 and 71A-71D, the battery pack 1100 includes the lead collection printed circuit board LCPCB 1268. In one example embodiment, the LCPCB 1268 has an array of PCB slots 1292 extending from the first side/front surface 1034 of the PCB 1268 to the second side/rear surface 1036 of the PCB 1268. In one example embodiment, the array of PCB slots 1292 has a first column 1292a of PCB slots 1292 along the second axis SA-SA and the second column 1292b of PCB slots 1292 along the first axis FA-FA and generally parallel to and adjacent to the first column 1292a of PCB slots 1292. In one example embodiment, each slot of the array of PCB slots 1292 of the LCPCB 1268 is configured to receive a corresponding tab of the battery cells 1200 of the battery pack 1100.

In one example embodiment, the width W_{LCPCB}, along the first direction FD-FD, of the printed circuit board is in a range from approximately 48.6 mm to approximately 59.4 mm. In one example embodiment, the width W_{LCPCB}, along the first direction FD-FD, of the LCPCB is in a range from approximately 51.3 mm and approximately 56.7 mm. In one example embodiment, the width W_{LCPCB}, along the first direction FD-FD, of the printed circuit board is approximately 54.0 mm.

In one example embodiment, referring to FIG. 51, a fuse 1305, which may be a surface-mount electronic fuse or a metal-strap fuse, is provided on the current path of the first metallic pad 1304a for overcurrent protection. The overcurrent may be generally due to overload, short circuit, battery damage, and/or other faults in the battery pack 1100. In one example embodiment, the current path of the first metallic pad 1304a is shown in FIGS. 51-53 and the fuse 1305 is provided on the current path of the first metallic pad 1304a. In another example embodiment, a fuse is provided on the current path of the second metallic pad 1304b for overcurrent protection.

In one example embodiment, the fuse 1305 is configured to cut-off an over-discharging current or an overcharging current, if the discharging current is outside a predetermined discharging current threshold or if the charging current is outside a predetermined charging current threshold.

In one example embodiment, the fuse 1305 is made of a copper material. In another example embodiment, the fuse 1305 is made of a C11000 copper material. In one example embodiment, the fuse 1305 is made other fuse materials as would be appreciated by a person of ordinary skill in the art. In one example embodiment, the fuse 1305 is a physical fuse. In one example embodiment the fuse 1305 is a passive overcurrent protection element.

In one example embodiment, referring to FIGS. 53-54, the fuse 1305 is positioned forward of the battery pack power terminals 1276a1 and 1276a2. In one example embodiment, the fuse 1305 is positioned forward of the battery cells 1200 of the battery pack 1100. Here forward refers to moving in the mating direction M of the power tool 1002 and the battery pack 1100, and towards the power tool 1002 (e.g., from the battery pack 1100). In one example embodiment, referring to FIGS. 53-54, the fuse 1305 is positioned generally orthogonal to the battery cells 1200 of the battery pack 1100.

The fuse 1305 is positioned between the LCPCB 1268 and a front of the battery pack housing along the longitudinal direction of the battery pack 1100. The fuse 1305 is positioned between the battery cells 1200 and the front of the battery pack housing along the longitudinal direction of the battery pack 1100. The front side of the housing (or just the front of the housing) is that side of the battery pack housing that comes closer to (approaches) an associated power tool first as the battery pack 1100 moves toward the power tool 1002 along the mating direction M.

FIGS. 53-54 show two power paths (e.g., a positive power path and a negative power path) of the battery pack 1100. In one example embodiment, the positive power path of the battery pack 1100 starts at slot 1292b5 of the second column of slots 1292b, follows the metallic pad 1304a to the fuse 1305 for a horizontal distance (e.g., parallel to the width W_{BP} of the battery pack 1100) of approximately 3.48 mm. The positive power path of the battery pack 1100 then follows a path along the length of the fuse 1305 and along the length of a first portion of a first connector member 1306a for a vertical distance (e.g., parallel to the height H_{BP} of the battery pack 1100) of approximately 19.9 mm. The positive power path of the battery pack 1100 then follows a path along the remaining length of the first connector member 1306a (including the length of an intermediate portion of the first connector member 1306a of approximately 2.4 mm and the length of the second portion of the first connector member 1306a of approximately 22.3 mm (i.e., 12.9 mm+9.4 mm) to the BMSPCB 1266. The positive power path of the battery pack 1100 then follows a path along the BMSPCB 1266 of approximately 26.8 mm (i.e., 1.6 mm+0.8 mm+24.4 mm) to the positive battery pack power terminal 1276a1 to complete the positive power path of the battery pack 1100. These values/distances noted above are simply examples and, in another example embodiment, these values/distances are up to 10 percent greater than or up to 10 percent less than the value described above.

In one example embodiment, referring to FIG. 54, the negative power path of the battery pack 1100 starts at slot 1292a1 of the first column of slots 1292a, follows the metallic pad 1304b to a first portion of a second connector member 1306b for a horizontal distance (e.g., parallel to the width W_{BP} of the battery pack 1100) of approximately 12.5 mm. The negative power path of the battery pack 1100 then follows a path along the remaining length of the second connector member 1306b (including the length of an intermediate portion of the second connector member 1306b of approximately 3.4 mm (i.e., 2.4 mm+1 mm) and the length of the second portion of the second connector member 1306b of approximately 49.1 mm (i.e., 35.2 mm+13.9 mm) to the BMSPCB 1266. The negative power path of the battery pack 1100 then follows a path along the BMSPCB 1266 of approximately 37.9 mm (i.e., 1.6 mm+0.8 mm+35.5 mm) to the negative battery pack power terminal 1276a2 to complete the negative power path of the battery pack 1100. These values/distances noted above are simply examples and, in another example embodiment, these values/distances are up to 10 percent greater than or up to 10 percent less than the value described above.

In one example embodiment, the fuse 1305 is positioned on the positive power path of the battery pack 1100. In such an example embodiment, the positive power path of the battery pack 1100 extends from the bottom most slot 1292b5 of the second column of slots 1292b to the left most battery pack terminal 1276a1 and the negative power path of the battery pack 1100 extends from the top most slot 1292a1 of the first column of slots 1292a to the right most battery pack terminal 1276a2 (with the fuse positioned on the positive power path of the battery pack 1100).

In one example embodiment, the thickness of each of the first connector member 1306a and the second connector member 1306b is approximately 0.5 mm. This thickness value is simply an example and, in another example embodiment, this value is up to 10 percent greater than or up to 10 percent less than the value described above. In one example embodiment, each of the first connector member 1306a and the second connector member 1306b includes the first portion that extends along the height dimension H_{BP} of the battery pack 1100, the second portion that extends along the plane having the length dimension L_{BP} (entire length of the battery pack 1100 is not shown in FIGS. 53-54) and the width dimension W_{BP} of the battery pack 1100, and the intermediate portion that connects the first and second portions. In one example embodiment, each of the first connector member 1306a and the second connector member 1306b includes alignment portions 1095 that are configured to align with alignment portions 1097 of the battery pack 1100 so as to align the first connector member 1306a and the second connector member 1306b with the battery pack 1100.

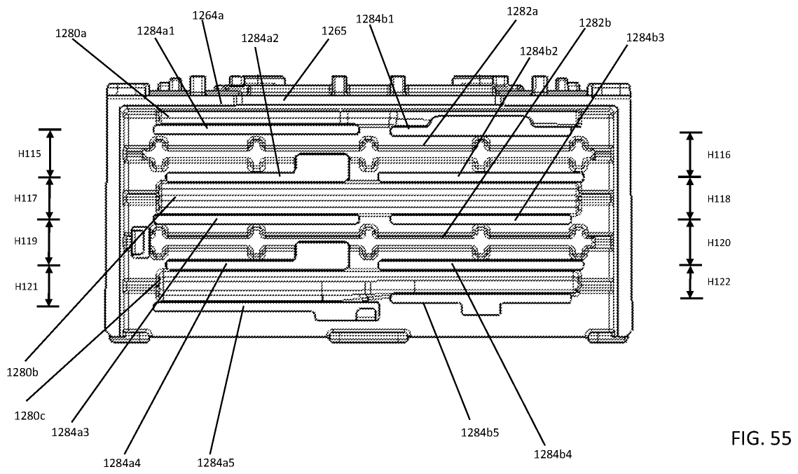

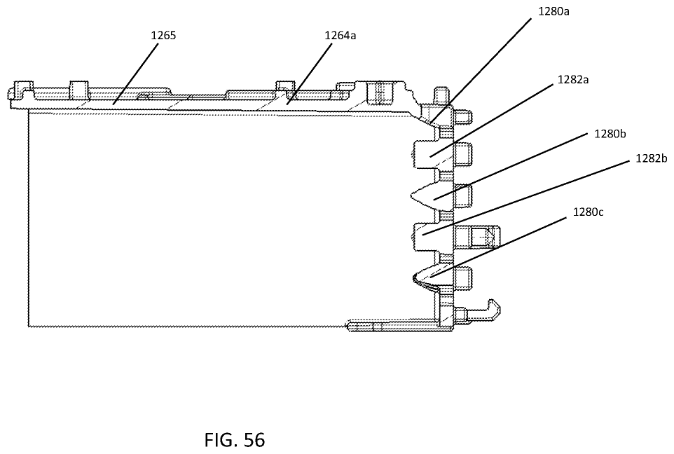

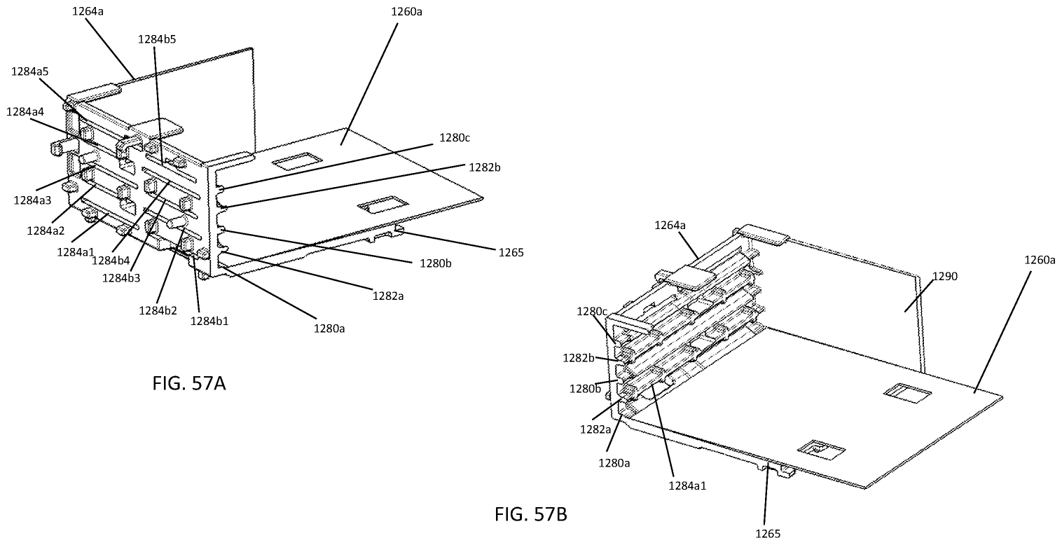

As illustrated in FIGS. 55-67B, an example embodiment of the cell holder 1264 may include an array/system of ribs extending from the inner surface of the front wall into the cell holder cavity. The ribs may be formed integrally with the cell holder front wall (in other words formed when the cell holder front portion is created) or the ribs may be discrete elements that are attached to the front wall. The cell holder 1264 may include a board support wall 1265. As illustrated in FIG. 56, the board support wall 1265 is towards the top of the page. However, as illustrated in FIGS. 57-67, the board support wall 1265 is towards the bottom of the page. In other words, the cell holder 1264 is rotated about a horizontal axis from FIGS. 55 and 56 to FIGS. 57-67.

The example array of ribs may include a first set (system) of ribs 1280 of a first type and a second set (system) of ribs 1282 of a second type. The ribs of the first set of ribs 1280 are interposed with the ribs of the second set of ribs 1282 in an alternating fashion. As illustrated in FIGS. 55 and 56, the cell holder 1264 includes a first rib 280a (the first rib 1280a being a 1/1 rib), a second rib 1280b, and a third rib 1280c of the first set of ribs 1280 and a first rib 1282a and a second rib 1282b of the second set of ribs 1282. The first rib 1280a of the first set of ribs 1280 is positioned at a top end (from the perspective of FIGS. 55 and 56) of the cell holder 1264a, the second rib 1280b of the first set of ribs 1280 is between the first rib 1282a of the second set of ribs 1282 and the second rib 1282b of the second set of ribs 1282, and the third rib 1280c of the first set of ribs 1280 is positioned between the second rib of the second set of ribs 1282 and a bottom end (from the perspective of FIGS. 55 and 56) of the cell holder 1264a. The first rib 1282a of the second set of ribs 1282 is positioned between the first rib 1280a of the first set of ribs 1280 and the second rib 1280b of the first set of ribs 1280 and the second rib 1282b of set second of ribs 1282 is positioned between the second rib 1280b of the first set of ribs 1280 and the third rib 1280c of the first set of ribs 1280.

The forward wall also includes an array of slots 1284. Each slot extends from the internal surface of the forward wall to an external surface of the forward wall. Each slot of the array of slots 1284 are sized and configured to receive a tab of one of the battery cells of the set of battery cells 1200 upon inserting one of the battery cells of the set of battery cells 1200 into the cell holder 1264. The array of slots 1284 includes a first column of slots 1284a and a second column of slots 1284b.

As illustrated in FIG. 55, the first column of slots 1284a of the array of slots 1284 includes a first slot 1284a1 between the first rib 1280a of the first set of ribs 1280 and the first rib 1282a of the second set of ribs 1282, a second slot 1284a2 between the first rib 1282a of the second set of ribs 1282 and the second rib 1280b of the first set of ribs 1280, a third slot 1284a3 between the second rib 1280b of the first set of ribs 1280 and the second rib 1282b of the second set of ribs 1282, a fourth slot 1284a4 between the second rib 1282b of the second set of ribs 1282 and the third rib 1280c of the first set of ribs 1280, and a fifth slot 1284a5 below the third rib 1280c of the first set of ribs 1280.

As illustrated in FIG. 55, the second column of slots 1284b of the array of slots 1284 includes a first slot 1284b1 between the first rib 1280a of the first set of ribs 1280 and the first rib 1282a of the second set of ribs 1282, a second slot 1284b2 between the first rib 1282a of the second set of ribs 1282 and the second rib 1280b of the first set of ribs 1280, a third slot 1284b3 between the second rib 1280b of the first set of ribs 1280 and the second rib 1282b of the second set of ribs 1282, a fourth slot 1284b4 between the second rib 1282b of the second set of ribs 1282 and the third rib 1280c of the first set of ribs 1280, and a fifth slot 1284b5 below the third rib 1280c of the first set of ribs 1280.

The slots of the first column of slots 1284a are aligned vertically. A distance (H115) separates a major axis of the first slot 1284a1 of the first column of slots 1284a and a major axis of the second slot 1284a2 of the first column of slots 1284a. A distance (H117) separates the major axis of the second slot 1284a2 of the first column of slots 1284a and a major axis of the third slot 1284a3 of the first column of slots 1284a. A distance (H119) separates the major axis of the third slot 1284a3 of the first column of slots 1284a and a major axis of the fourth slot 1284a4 of the first column of slots 1284a. A distance (H121) separates the major axis of the fourth slot 1284a4 of the first column of slots 1284a and a major axis of the fifth slot 1284a5 of the first column of slots 1284a. The distances H115, H1117, H119, and H121 may be equal to, greater than, or less than each other.

The slots of the second column of slots 1284b are also aligned vertically. A distance (H116) separates a major axis of the first slot 1284b1 of the second column of slots 1284b and a major axis of the second slot 1284b2 of the second column of slots 1284b. A distance (H118) separates the major axis of the second slot 1284b2 of the second column of slots 1284b and a major axis of the third slot 1284b3 of the second column of slots 1284b. A distance (H120) separates the major axis of the third slot 1284b3 and a major axis of the fourth slot 1284b4 of the second column of slots 1284b. A distance (H122) separates the major axis of the fourth slot 1284b4 of the second column of slots 1284b and a major axis of the fifth slot 1284b5 of the second column of slots 1284b. The distances H116, H118, H120, and H122 may be equal to, greater than, or less than each other.

The first column of slots 1284a is generally parallel to the second column of slots 1284b.

The distance H115 may be equal to, greater than, or less than the distance H116. The distance H119 may be equal to, greater than, or less than the distance H120. The distance H118 may be equal to, greater than, or less than the distance H117. The distance H122 may be equal to, greater than, or less than the distance H121. The distance H115 may be equal to, greater than, or less than the distance H117 and the distance H119 may be equal to, greater than, or less than the distance H121. The distance H118 may be equal to, greater than, or less than the distance H116 and the distance H122 may be equal to, greater than, or less than the distance H120.

FIGS. 57-70 illustrate an assembly process of the core pack 1262. The first side wall of the front housing 1264a and the rear housing 1264b of the cell holder 1264 has been removed from these figures to better illustrate the assembly process. A second side wall 1290 of the front housing 1264a is shown in these figures.

As illustrated in FIGS. 57A and 57B, the assembly process begins with providing a front portion or front housing 1264a of the cell holder 1264. It should be noted that, in this example embodiment, the front housing 1264a of the cell holder 1264, has been rotated 180 degrees about a horizontal axis as compared to the illustration of the front housing 1264a in FIGS. 55 and 56. As such, what was the top in FIGS. 55 and 56 is now the bottom in FIGS. 57-69. As shown, the front portion 1264a includes the array of ribs including the first set of ribs 1280 and the second set of ribs 1282. The front wall of the front housing 1264a also includes the array of slots including the first column of slots 1284a and the second column of slots 1284b. A first insulating layer 1260a is inserted into the front portion 1264a of the cell holder 1264.

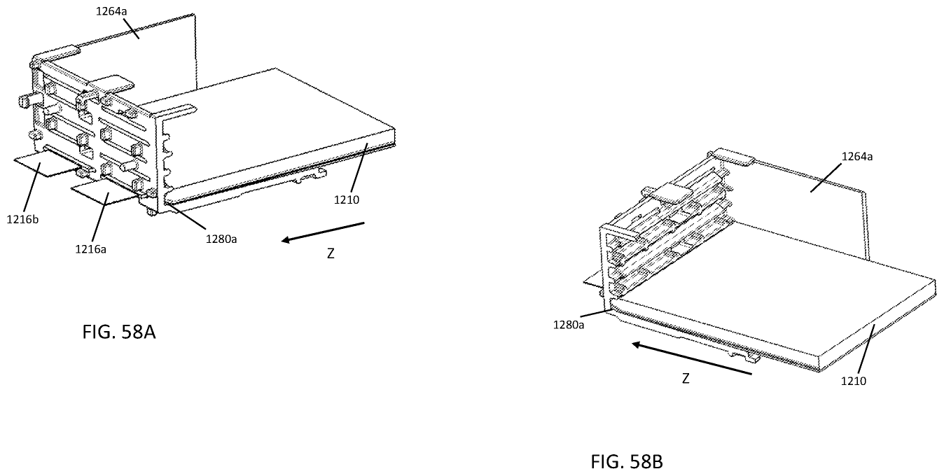

As illustrated in FIGS. 58A and 58B, a first pouch battery cell 1210 is inserted or slid into the front housing 1264a in a direction Z generally parallel to the top wall 1265 of the front housing 1264a and generally perpendicular to the front wall 1029 of the front housing 1264a. The first tab (the negative tab in this embodiment) 1216b of the first battery cell 1210 is received in the first slot 1284a1 of the first column of slots 1284a. Simultaneously, the second tab (the positive tab in this embodiment) 1216a of the first battery cell 1210 is received in the first slot 1284b1 of the second column of slots 1284b. As such, the tabs 1216a and 1216b of the first battery cell 1210 are offset from each in a direction generally perpendicular to the top and bottom walls of the cell holder 1264.

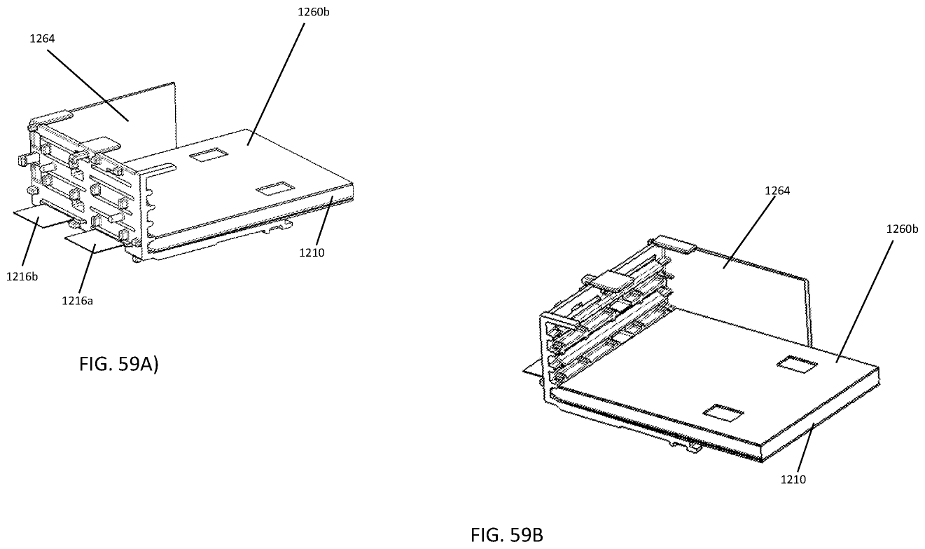

As illustrated in FIGS. 59A and 59B, a second insulating layer 1260b is inserted or slid into the front housing 1264a in the direction Z. The insulating layer 1260b sits against the back of the first battery cell 1210. The insulating layer 1260b abuts the rear face/wall of the first rib 1282a of the second set of ribs 1282. The insulating layer 1260b has a height generally equal to the height of the rear wall of the first rib 1282a of the second set of ribs 1282.

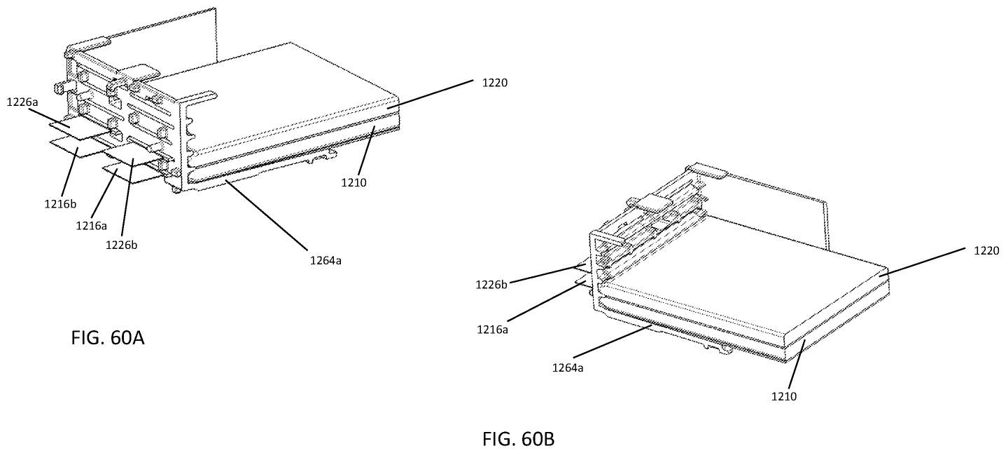

As illustrated in FIGS. 60A and 60B, a second pouch battery cell 1220 is inserted or slid into the front housing 1264a in the direction Z. The first tab (the positive tab in this embodiment) 1226a of the second battery cell 1220 is received in the second slot 1284a2 of the first column of slots 1284a.

Simultaneously, the second tab (the negative tab in this embodiment) 1226b of the second battery cell 1220 is received in the second slot 1284b2 of the second column of slots 1284b. As such, the tabs 1226a and 1226b of the second battery cell 1220 are offset from each in the direction generally perpendicular to the top and bottom walls of the cell holder 1264.

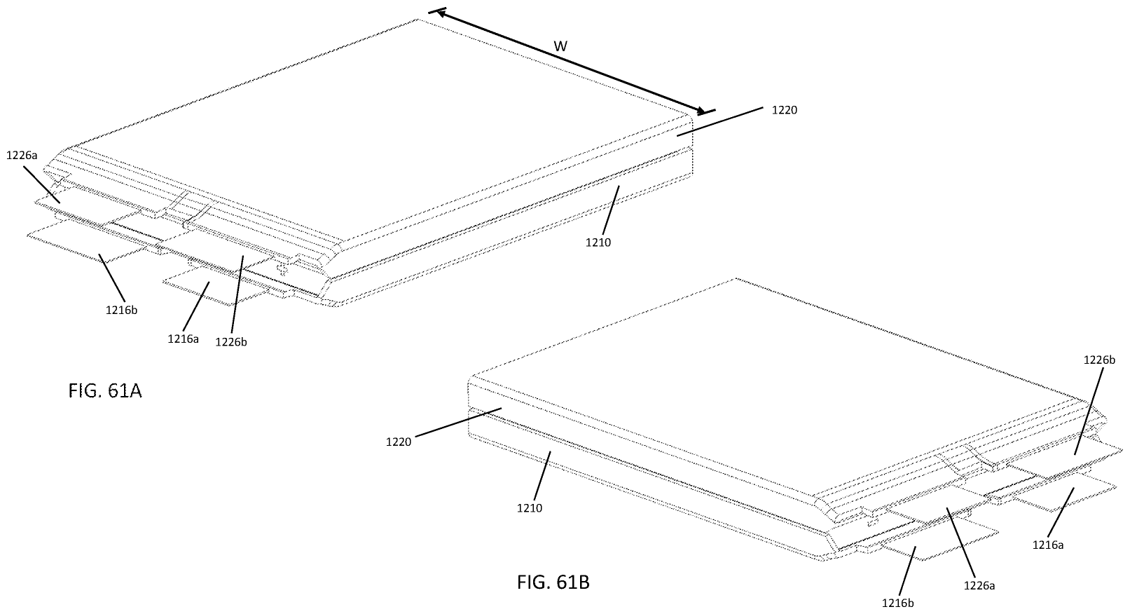

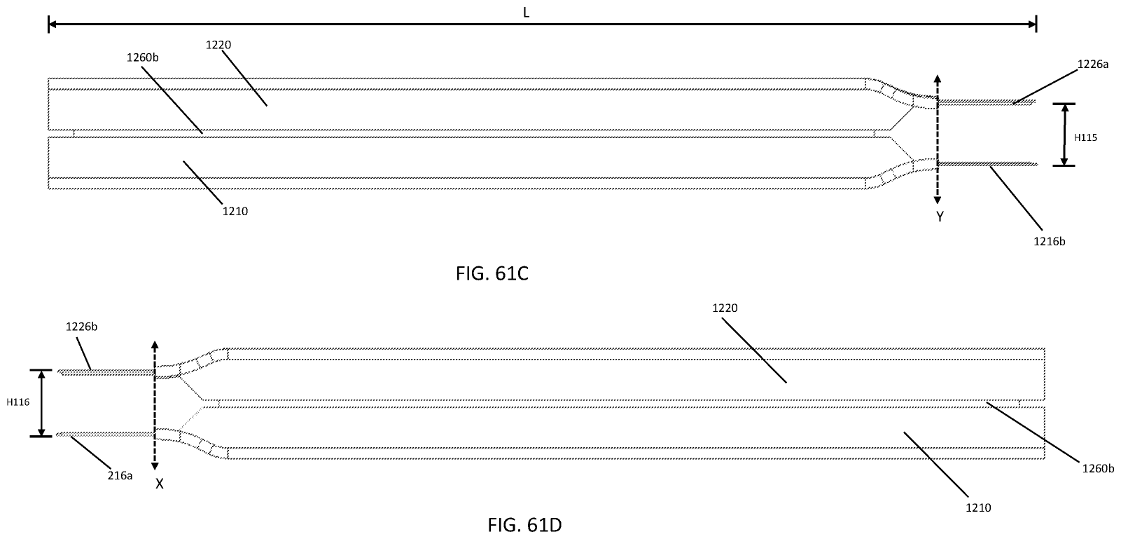

FIGS. 61A, 61B, 61C, and 61D illustrate battery cells 1210 and 1220 and the insulating layer 1260b as they are positioned in the cell holder 1264 with the cell holder 1264 removed. In other words, the cell tabs 1216a, 1216b, 1226a, and 1226b are shown as they are affected by the cell holder 1264. More particularly, the cell tabs 1216a and 1226b are shown separated by the distance H116 and the cell tabs 1216b and 1226a are shown separated by the distance H115. As illustrated in FIGS. 61A, 61B, 61C and 61D, the first tab 1216b of the first battery cell 1210 and the first tab 1226a of the second battery cell 1220 are aligned along the axis X and the second tab 1216a of the first battery cell 1210 and the second tab 1226b of the second battery cell 1220 are aligned along the axis Y.

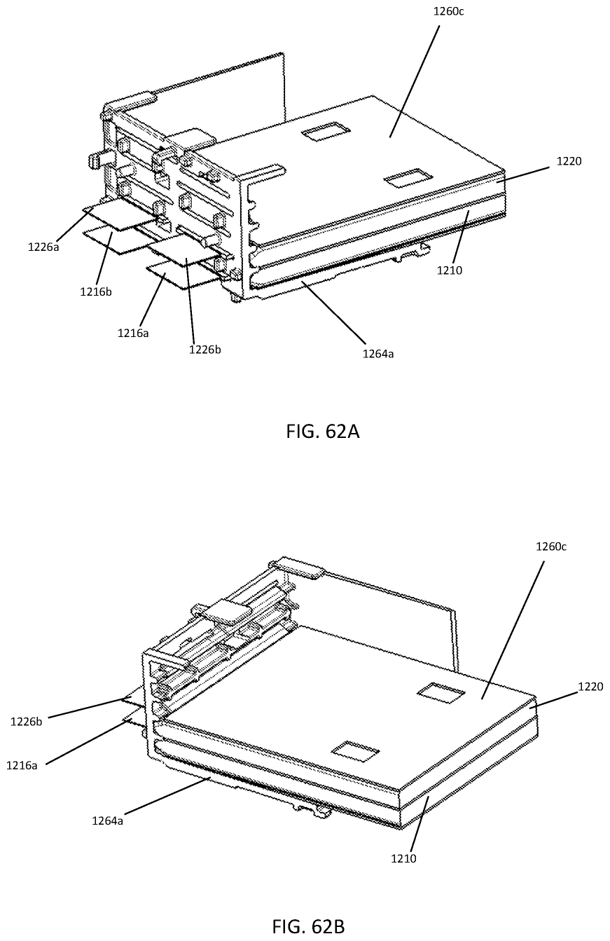

As illustrated in FIGS. 62A and 62B, a third insulating layer 1260c is inserted or slid into the front housing 1264a in the direction Z. The insulating layer 1260c sits against the back of the first battery cell 1220. The insulating layer 1260c abuts the rear face/wall of the second rib 1280b of the first set of ribs 1280. The insulating layer 1260c has a height generally equal to the height of the rear wall of the second rib 1280b of the first set of ribs 1280.

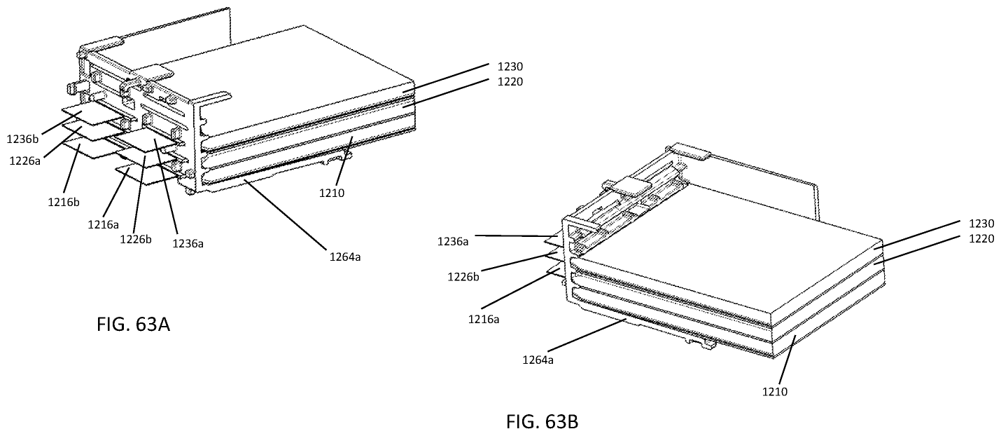

As illustrated in FIGS. 63A and 63B, a third pouch battery cell 1230 is inserted or slid into the front housing 1264a in the direction Z. The first tab (the negative tab in this embodiment) 1236b of the third battery cell 1230 is received in the third slot 1284a3 of the first column of slots 1284a. Simultaneously, the second tab (the positive tab in this embodiment) 1236a of the third battery cell 1230 is received in the third slot 1284b3 of the second column of slots 1284b. As such, the tabs 1236a and 1236b of the third battery cell 1230 are offset from each in a direction generally perpendicular to the top and bottom walls of the cell holder 1264.

The first tab 1236b of the third battery cell 1230 is aligned with the first tab 1226a of the second battery cell 1220 and the first tab 1216b of the first battery cell 1210 along the axis X and the second tab 1236a of the third battery cell 1230 is aligned with the second tab 1226b of the second battery cell 1220 and the second tab 1216a of the first battery cell 1210 along the axis Y.

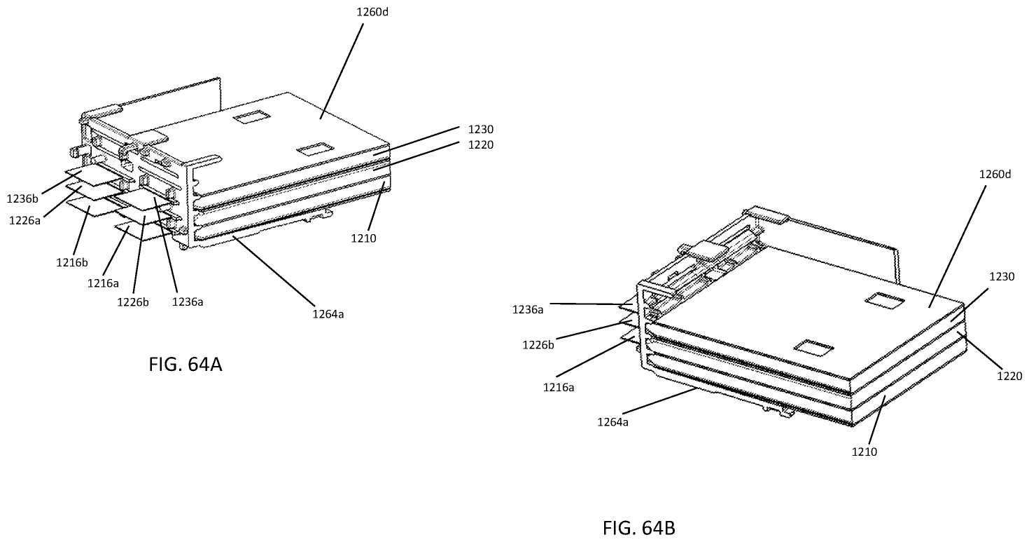

As illustrated in FIGS. 64A and 64B, a fourth insulating layer 1260d is inserted or slid into the front housing 1264a in the direction Z. The fourth insulating layer 1260d sits against the face of the third battery cell 1230. The fourth insulating layer 1260d abuts the rear face/wall of the second rib 1282b of the second set of ribs 1282. The fourth insulating layer 1260d has a height generally equal to the height of the rear wall of the second rib 1282b of the second set of ribs 1282.

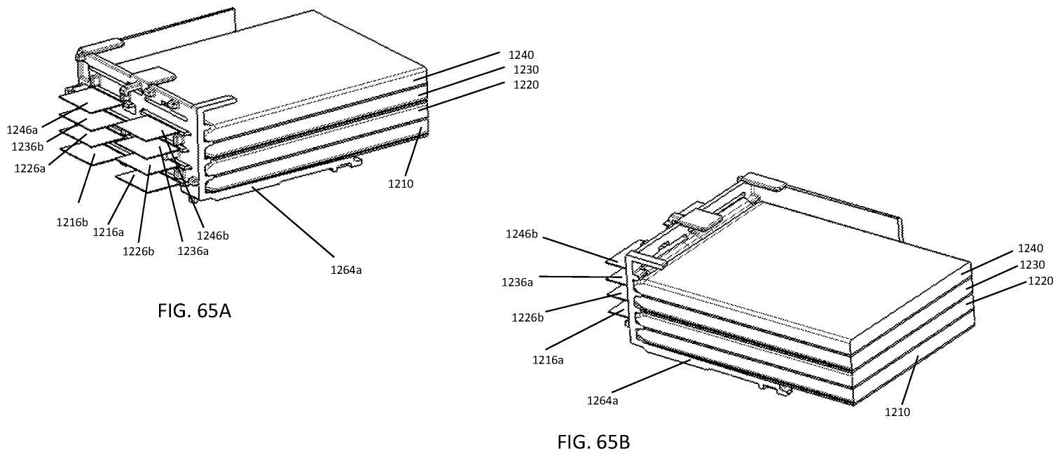

As illustrated in FIGS. 65A and 65B, a fourth pouch battery cell 1240 is inserted or slid into the front housing 1264a in the direction Z. The first tab (the positive tab in this embodiment) 1246a of the fourth battery cell 1240 is received in the fourth slot 1284a4 of the first column of slots 1284a.

Simultaneously, the second tab (the negative tab in this embodiment) 1246b of the fourth battery cell 1240 is received in the fourth slot 1284b4 of the second column of slots 1284b. As such, the tabs 1246a and 1246b of the fourth battery cell 1240 are offset from each in the direction generally perpendicular to the top and bottom walls of the cell holder 1264.

The first tab 1246a of the fourth battery cell 1240 is aligned with the first tab 1236b of the third battery cell 1230, the first tab 1226a of the second battery cell 1220 and the first tab 1216b of the first battery cell 1210 along the axis X and the second tab 1246b of the fourth battery cell 1240 is aligned with the second tab 1236a of the third battery cell 1230, the second tab 1226b of the second battery cell 1220 and the second tab 1216a of the first battery cell 1210 along the axis Y.

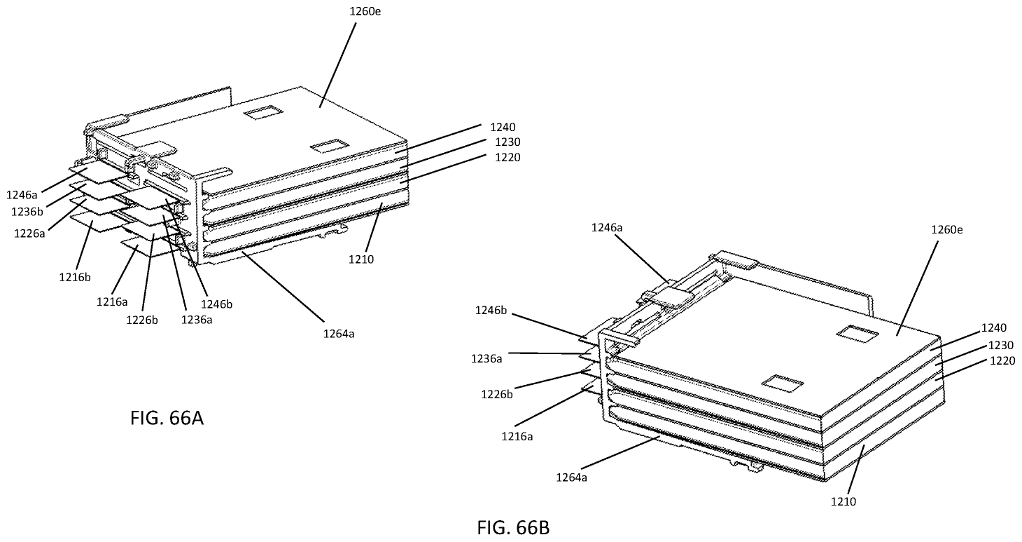

As illustrated in FIGS. 66A and 66B, a fifth insulating layer 1260e is inserted or slid into the front housing 1264a in the direction Z. The fifth insulating layer 1260e sits against the back of the fourth battery cell 1240. The fifth insulating layer 1260e abuts the rear face/wall of the third rib 1280c of the first set of ribs 1280. The fifth insulating layer 1260e has a height generally equal to the height of the rear wall of the third rib 1280c of the first set of ribs 1280.

As illustrated in FIGS. 67A and 67B, a fifth pouch battery cell 1250 is inserted or slid into the front housing 1264a in the direction Z. The first tab (the negative tab in this embodiment) 1256b of the fifth battery cell 1250 is received in the fifth slot 1284a5 of the first column of slots 1284a.

Simultaneously, the second tab (the positive tab in this embodiment) 1256a of the third battery cell 1250 is received in the fifth slot 1284b5 of the second column of slots 1284b. As such, the tabs 1256a and 1256b of the fifth battery cell 1250 are offset from each in a direction generally perpendicular to the top and bottom walls of the cell holder 1264.

The first tab 1256b of the fifth battery cell 1250 is aligned with the first tab 1246a of the fourth battery cell 1240, the first tab 1236b of the third battery cell 1230, the first tab 1226a of the second battery cell 1220 and the first tab 1216b of the first battery cell 1210 along the axis X and the second tab 1256a of the fifth battery cell 1250 is aligned with the second tab 1246b of the fourth battery cell 1240, the second tab 1236a of the third battery cell 1230, the second tab 1226b of the second battery cell 1220 and the second tab 1216a of the first battery cell 1210 along the axis Y.

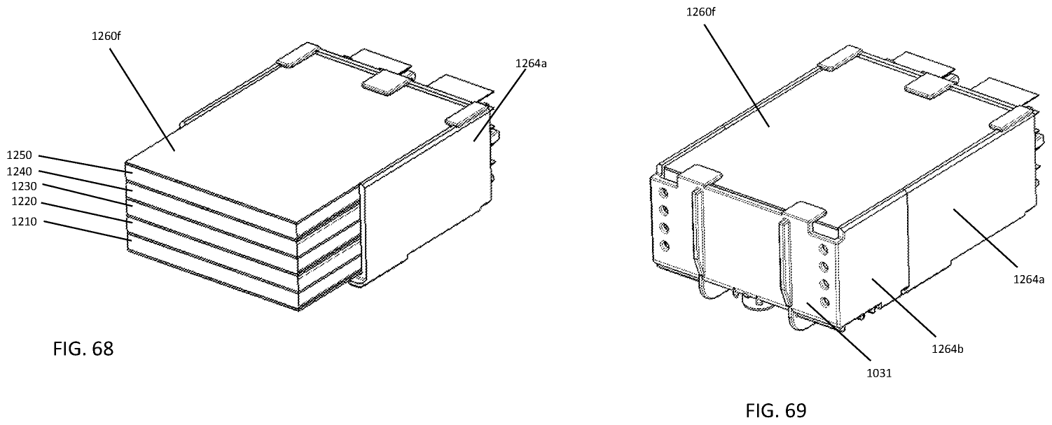

As illustrated in FIG. 68, a sixth insulating layer 1260f is inserted or slid into the front housing 1264a in the direction Z. The fifth insulating layer 1260e sits against the back of the fourth battery cell 1250.

The front portion 1264a of the cell holder 1264 is now full. In alternate embodiments, the set of battery cells 1200 and the insulating layers 1260 may be stacked prior to being inserted into the front portion of the cell holder and then inserted as stack or cartridge.

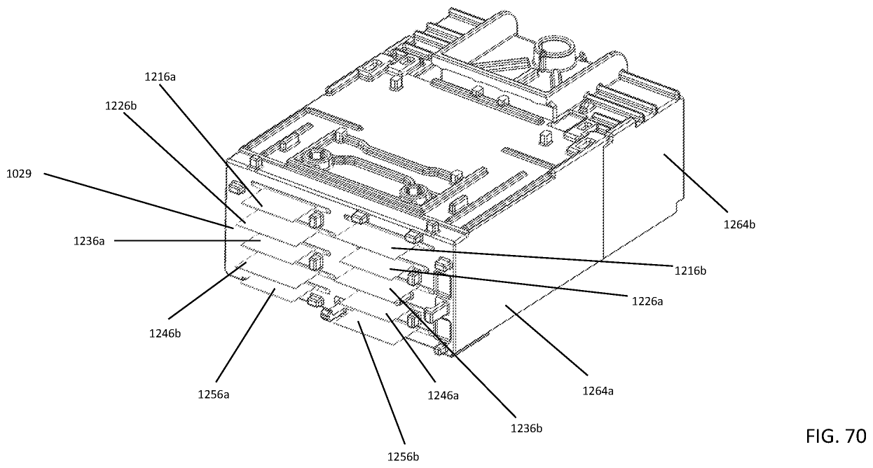

As illustrated in FIGS. 69 and 70, the rear portion 1264b is then placed over the rear ends of the battery cells of the set of battery cells 1200 and the insulating portions 1260 and coupled to the front portion 1264a of the cell holder 1264.

FIGS. 71A, 71B, 71C, and 71D illustrate an example embodiment of a secondary printed circuit board (PCB) 1268 of the core pack 1262. The secondary PCB 1268 includes a front surface 1034 and a rear surface 1036.

The PCB 1268 includes a first column of slots 1292a. The slots 1292a1, 1292a2, 1292a3, 1292a4, 1292a5 of the first column of slots 1292a extend from the rear surface 1036 of the PCB 1268 to the front surface 1034 of the PCB 1268.

A distance H215 separates a major axis of the first slot 1292a1 and a major axis of the second slot 292a2 of the first column of slots 1292a. A distance H217 separates the major axis of the second slot 1292a2 and a major axis of the third slot 1292a3 of the first column of slots 1292a. A distance H219 separates the major axis of the third slot 1292a2 and a major axis of the fourth slot 1292a4 of the first column of slots 1292a. A distance H221 separates the major axis of the fourth slot 1292a4 and a major axis of the fifth slot 1292a5 of the first column of slots 1292a.

The PCB 1268 includes a second column of slots 1292b. The slots 1292b1, 1292b2, 1292b3, 1292b4, 1292b5 of the second column of slots 1292b extend from the rear surface 1036 of the PCB 1268 to the front surface 1304 of the PCB 1268.

A distance H216 separates a major axis of the first slot 1292b1 and a major axis of the second slot 1292b2 of the second column of slots 1292b. A distance H218 separates the major axis of the second slot 1292b2 and a major axis of the third slot 1292b3 of the second column of slots 1292b. A distance H220 separates the major axis of the third slot 1292b2 and a major axis of the fourth slot 1292b4 of the second column of slots 1292b. A distance H222 separates the major axis of the fourth slot 1292b4 and a major axis of the fifth slot 1292b5 of the second column of slots 1292b.

The distances H215, H216, H217, H218, H219, H220, H221, and H222 form a set of distances H. Each of the distances in the set of distances may be equal to, greater than, or less than each of the other distances in the set of distances H.

The LCPCB 1268 may also include a plurality of metallic pads. A first metallic pad 1304a surrounds the fifth slot 1292b5 of the second column of slots 1292b. A second metallic pad 1304b is adjacent to the first slot 1292a1 of the first column of slots 1292a. A third metallic pad 1294a is positioned between the fourth slot 1292b4 and the third slot 1292b3 of the second column of slots 1292b. A fourth metallic pad 1294b is positioned between the second slot 1292b2 and the first slot 1292b1 of the second column of slots 1292b. A fifth metallic pad 1294c is positioned between the second slot 1292a2 and the third slot 1292a3 of the first column of slots 1292a. A sixth metallic pad 1294d is positioned between the fourth slot 1292a4 and the fifth slot 1292a4 of the first column of slots 1292a. A sixth metallic pad 1294e is positioned above the first slot 1292a1 of the first column of slots 1292a.

The LCPCB 1268 may also include a plurality of metallic traces. A first metallic trace 1296a runs from the third metallic pad 1294a to a via 1298a. A second metallic trace 1296b runs from the fourth metallic pad 1294b to a via 1298b. A third metallic trace 1296c runs from the fifth metallic pad 1294c to a via 1298c. A fourth metallic trace 1296d runs from the sixth metallic pad 1294d to a via 1298d.

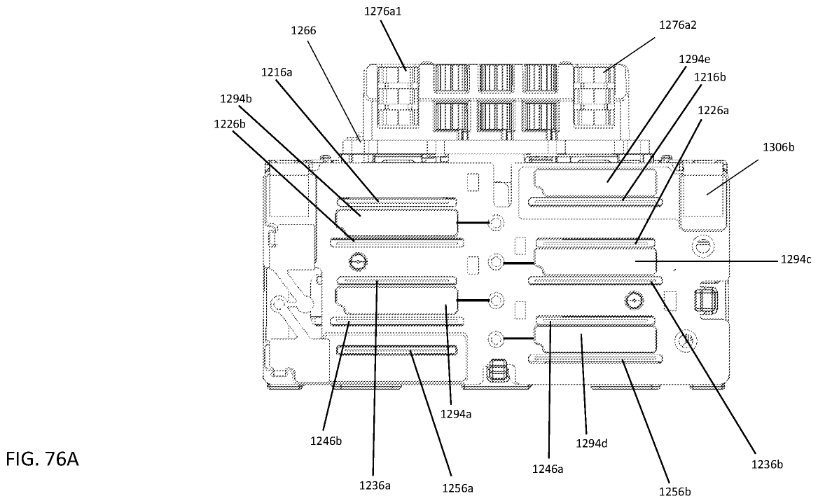

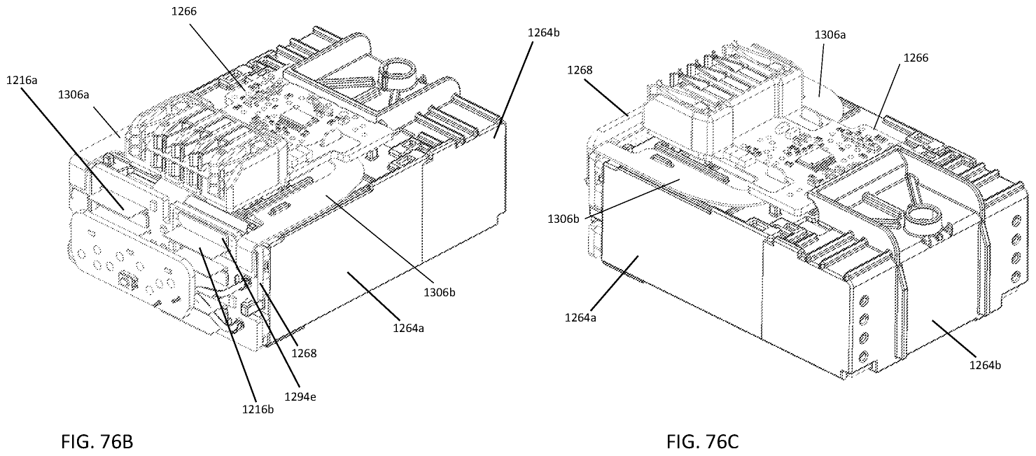

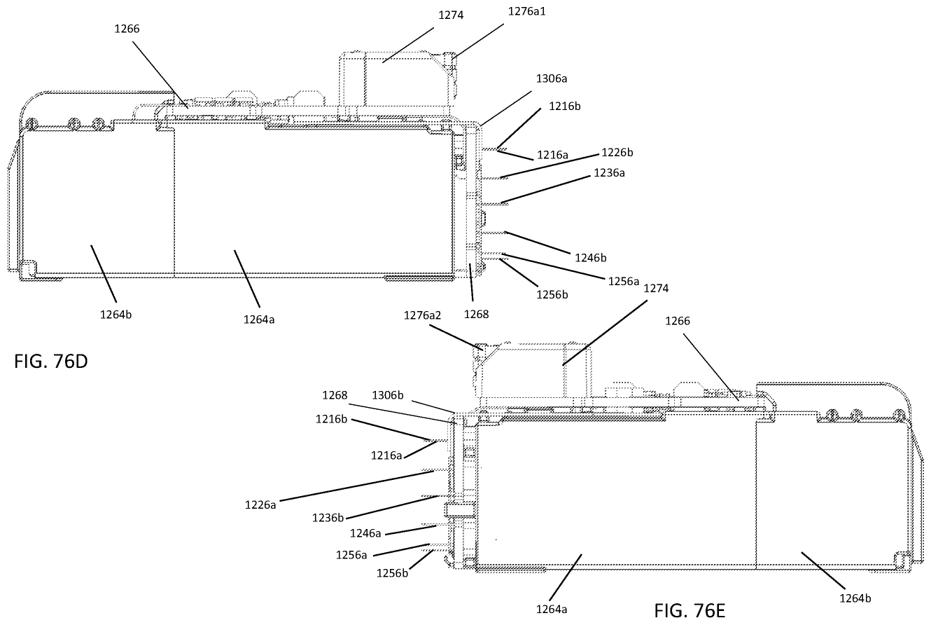

As illustrated in FIGS. 76A-76E, the rear surface 1036 of the LCPCB 1268 is mounted upon/affixed to the front wall 1029 of the front portion 1264a of the cell holder 1264. The first column of slots 1292a of the LCPCB 1268 correspond to and align with the first column of slots 1284a of the front portion 1264a of the cell holder 1264 and the second column of slots 1292b of the LCPCB 1268 correspond to and align with the second column of slots 1284b of the front portion 1264a of the cell holder 1264. In alternate embodiments the LCPCB 1268 may be held in place relative to the cell holder 1264 by a fixture on an internal surface of the battery pack housing.

Referring to FIG. 76A, when the LCPCB 1268 is mounted upon/affixed to the front portion 1264a of the cell holder 1264 the tabs 1216b, 1226a, 1236b, 1246a and 1256b of the first battery cell 1210, the second battery cell 1220, the third battery cell 1230, fourth battery cell 1240, and the fifth battery cell 1250, respectively, are received in the first slot 1292a1, the second slot 1292a2, the third slot 1292a3, the fourth slot 1292a4, and the fifth slot 1292a5 of the first column of slots 1292a of the LCPCB 1268, respectively. And, when the LCPCB 1268 is mounted upon/affixed to the front portion 1264a of the cell holder 1264 the tabs 1216a, 1226b, 1236a, 1246b and 1256a of the first battery cell 1210, the second battery cell 1220, the third battery cell 1230, fourth battery cell 1240, and the fifth battery cell 1250, respectively, are received in the first slot 1292b1, the second slot 1292b2, the third slot 1292b3, the fourth slot 1292b4, and the fifth slot 1292b5 of the second column of slots 1292 of the LCPCB 1268, respectively.

As illustrated in FIGS. 41-46, 51-54, and 77-82, the ends of the cell tabs are folded to connect to an associated metallic pad. Specifically, the second cell tab 1256a of the fifth battery cell 1250 (the most positive cell tab once all of the battery cells of the set of battery cells 1200 are connected in series) is folded to overlap the first metallic pad 1304a. The first cell tab 1216b of the first battery cell 1210 (the most negative cell tab once all of the battery cells of the set of battery cells 1200 are connected in series) is folded to overlap the second metallic pad 1304b. The second cell tab 1246b of the fourth battery cell 1240 and the second cell tab 1236a are folded to overlap each other and the third metallic pad 1294a. The second cell tab 1226b of the second battery cell 1220 and the second cell tab 1216a of the first battery cell 1210 are folded to overlap each other and the fourth metallic pad 1294b. The first cell tab 1226a of the second battery cell 1220 and the first cell tab 1236b of the third battery cell 1230 are folded to overlap each other and the fifth metallic pad 1294c. The first cell tab 1246a of the fourth battery cell 1240 and the first cell tab 1256b of the fifth battery cell 1250 are folded to overlap each other and the sixth metallic pad 1294d.

Thereafter, the folded tabs are electrically coupled to the corresponding metallic pads. Specifically, the tab 1256a is electrically coupled to metallic pad 1304a, the tab 1216b is electrically coupled to metallic pad 1304b, the tabs 1236a and 1246b are electrically coupled to metallic pad 1294a, the tabs 1216a and 1226b are electrically coupled to metallic pad 1294b, the tabs 1226a and 1236b are electrically coupled to metallic pad 1294c and the tabs 1246a and 1256b are electrically coupled to metallic pad 1294d. The electric coupling may be accomplished through welding, e.g., laser welding, sonic welding or by mechanical connections.

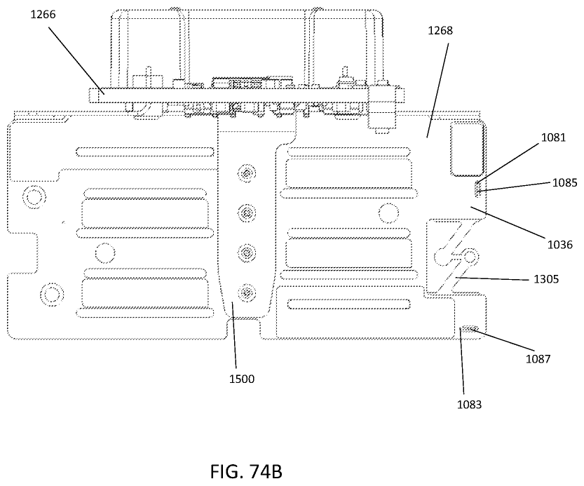

As illustrated, for example, in FIGS. 76B and 76C, the BMSPCB 1266 is mounted on/affixed to the cell holder 1264. A connector 1306a, e.g., a wire or metal strap, connects the first metallic pad 304a (through a fuse, as described in more detail below) to the positive power terminal 1276a1 and a connector 1306b, e.g., a wire or metal strap, connects the second metallic pad 1304b to the negative power terminal 1276a2. A connector 1500 (see, FIG. 74B), for example, a flexible PCB, connects the vias 1298a, 1298b, 1298c, 1298d of the LCPCB 1268 to corresponding first, second, third and fourth vias on the BMSPCB 266. The first, second, third and fourth vias on the BMSPCB 266 may be electrically coupled to the third intercell terminal 1276b5, the first intercell terminal 1276b3, the second intercell terminal 1276b4, and the fourth intercell terminal 1276b6, respectively.

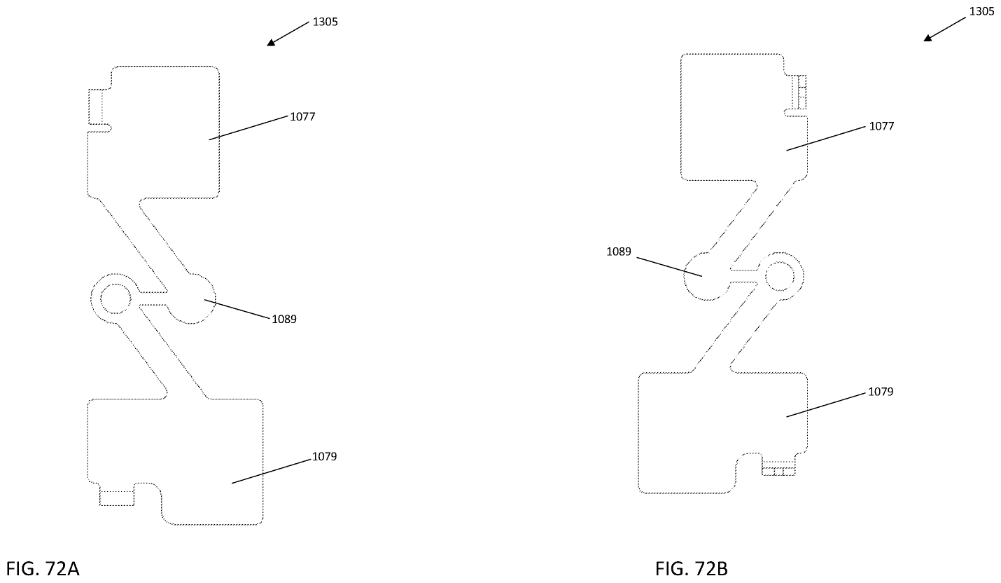

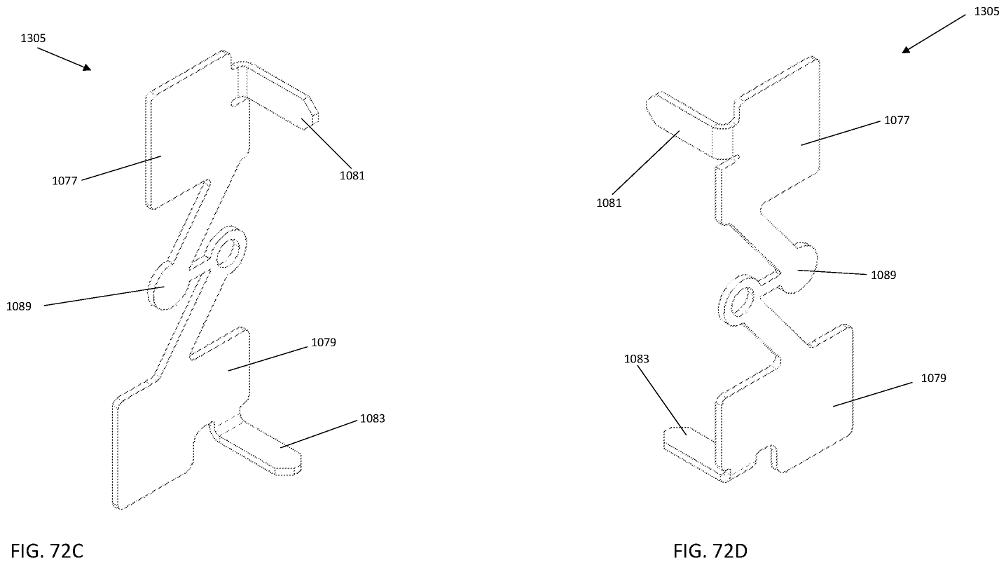

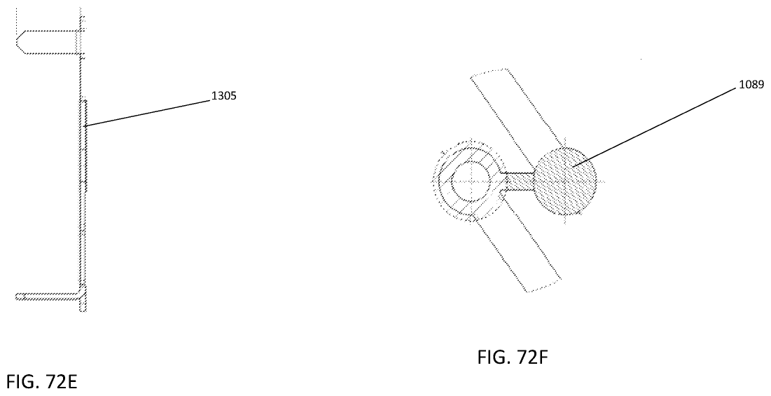

In one example embodiment, the fuse 1305 is configured to be connected to the LCPCB 1268. In one example embodiment, referring to FIGS. 72A-72F, the fuse 1305 includes engagement portions 1081, 1083 that are configured to engage with engagement portions (sometimes referred to as vias) 1085, 1087 of the LCPCB 1268 to connect the fuse 1305 to the LCPCB 1268. In one example embodiment, as shown in FIG. 74A, one end portion 1077 of the fuse 1305 is configured to be connected to the connector 1306a and the other end portion 1079 of the fuse 1305 is configured to be connected to the metallic pad 1304a.

In one example embodiment, as shown in FIGS. 72A-72F, the fuse 1305 includes fuse element(s) 1089 disposed between the end portions 1077 and 1079 of the fuse 1305. In one example embodiment, the fuse element 1089 is configured to break/melt to open the circuit through the fuse 1305 and to prevent any electrical component damage in the battery pack 1100. In another example embodiment, the fuse element 1089 includes a resistor element that is configured to heat up and increase the resistance so as to suppress the current flowing through the circuit to be protected.

In one example embodiment, the fuse 1305 is attached to the LCPCB 1268 using a laser welding procedure or other similar attachment/connection procedures. That is, in one example embodiment, the fuse 1305 is laser welded to copper pads, which are then reflow soldered to the LCPCB 1268. In one example embodiment, the fuse 1305 is part of the LCPCB 1268 and is welded to the LCPCB 1268 at the same time as the cell connections to the LCPCB 1268.

Once the core pack 262 is completed, it is placed in the lower housing 104. Thereafter, the upper housing 102 is placed over the core pack 262 and coupled to the lower housing 104.

This method of assembly of the battery pack 1100 is but one example. The steps may be completed in an alternate order. For example, the secondary LCPCB 1268 may be affixed to the front portion 1264a of the cell holder 1264 prior to inserting any of the battery cells of the set of battery cells 200. As such, upon inserting the battery cells 210, 220, 230, 240, and 250 into the front portion 1264a of the cell holder 1264, the various tabs would be inserted through both a corresponding slot 284 of the front portion 1264a of the cell holder 1264 and a corresponding slot 292 of the secondary LCPCB 1268.

In one example embodiment, the present patent application provides battery packs for power tools. In one example embodiment, the present patent application provides battery packs with pouch-type battery cells for the power tools. In one example embodiment, the present patent application provides battery packs for other power devices.

FIGS. 85-91 show various views of the power tool 1002. As a person of ordinary skill in the art would appreciate, example embodiments include a cordless (battery operated) power tool/device 1002. In one example embodiment, the power tool 1002 is a power screwdriver, a power fastener/fastening tool, a power driver, a power drill, a power expansion tool, a power reciprocating saw, a power circular saw, a power leaf blower, a power vacuum cleaner, a power hedge trimmer, a power lawn mower, a power string trimmer, and/or other power tools/devices. In the illustrated example embodiment, the power tool 1002 is a cordless power drill/screwdriver. In one example embodiment, the power tool 1002 is a portable device.

In one example embodiment, referring to FIGS. 85-91, the power tool 1002 includes a power tool housing 1004, a motor assembly 1006, a (multi-speed) transmission assembly 1008, a clutch mechanism 1010, a chuck 1012, a trigger assembly 1014, and a handle 1016. A battery pack 1100 is coupled to the power tool 1002. In one example embodiment, the battery pack 1100 is a rechargeable high power battery pack that comprises a plurality of battery cells 1200 (see FIG. 39B), for example. The battery pack 1100 may be a separate and removable battery pack.

In one example embodiment, the trigger assembly 1014 and the battery pack 1100 are mechanically coupled to the handle 1016 of the power tool 1002 and are electrically coupled to the motor assembly 1006 in a conventional manner that is not specifically shown but which would be readily apparent to a person of ordinary skill in the art. A person of ordinary skill in the art will understand that several of the components of the power tool 1002, such as the motor assembly 1006, the transmission assembly 1008, the clutch mechanism 1010, the chuck 1012, the trigger assembly 1014 and the handle 1016, are conventional in nature and therefore need not be discussed in significant detail in the present patent application. Reference may be made to a variety of publications for a more complete understanding of the conventional features of the power tool 1002. One example of such a publication is U.S. Pat. No. 5,897,454, the disclosure of which is hereby incorporated by reference in its entirety.

In one example embodiment, the power tool 1002 includes the controller/control circuit 1022. In one example embodiment, the control circuit 1022 is disposed in the power tool housing 1004 and is operably connected to a set of power tool terminals 1024 and to the motor assembly 1006 to control power delivery to the motor 1006 from the battery pack 1100. In one example embodiment, the controller 1022 is further defined as a microcontroller. In other example embodiments, the controller 1022 may be part of, or include an electronic circuit, an Application Specific Integrated Circuit (ASIC), a processor (shared, dedicated, or group) and/or memory (shared, dedicated, or group) that execute one or more software or firmware programs, a combinational logic circuit, and/or other suitable components that provide the described functionality.

In one example embodiment, the load may include the motor 1006 disposed in the power tool housing 1004. The motor 1006 includes an output shaft that is operably coupled to drive a power tool accessory (e.g., a tool bit/element such as a drill bit, an expansion bit, a screwdriver bit, a cutting wheel, a grinding wheel and/or other tool elements). In one example embodiment, the motor 1006 generally consumes greater current under heavy motor loads. In one example embodiment, at light motor loads, current is low and watts out (WO) is low. In one example embodiment, at higher motor loads, current is high and WO is high. In one example embodiment, a switch may be a mechanical or an electronic switch (such as a field effect transistor (FET), SCR or other transistor device) that connects the battery pack 1100 to the motor 1006.

In one example embodiment, the power tool 1002 includes a receptacle for receiving the battery pack 1100. The receptacle includes an interface for mating with the battery pack 1100. The receptacle is configured with one interface for receiving one removable, rechargeable battery pack from a set of battery packs. In another example embodiment, the power tool 1002 is configured to both mechanically and electrically couple/connect/engage with the battery pack 1100.

In one example embodiment, the power tool 1002 may be coupled to a single battery pack 1100. In one example embodiment, the power tool 1002 includes multiple battery packs 1100. In one example embodiment, the battery pack 1100 comprise a plurality of battery cells 1200 (as shown in FIG. 39B). In one example embodiment, the set of battery packs includes multiple battery packs 1100 have a generally equivalent nominal voltage but with different volumetric sizes that all share a common interface to couple/mate/engage/connect with one or more power devices, such as cordless power tools and battery chargers. That is, the common interface includes the same structural feature(s) on each battery pack 1100 in the set of battery packs that allows the battery packs to mate with or engage/connect/couple, both mechanically and electrically, to one or more power devices, such as cordless power tools 1002 and/or to one or more battery pack chargers or charging stations.

In one example embodiment, the multiple battery packs 1100 with the equivalent nominal voltage but with different volumetric sizes and other battery pack characteristics provide users different solutions for use with the cordless power tools 1002. In one example embodiment, the variation in volumetric sizes and other battery pack characteristics for a set of battery packs 1100 with the same nominal voltage for use with one or more cordless power tools 1002 provides a solution to meet user needs and desires. In one example embodiment, the battery pack 1100 is configured to be coupled to a battery charger (not shown). In one example embodiment, the battery charger includes a power supply that is disposed in a battery charger housing. In one example embodiment, the battery charger may also include a battery charger control module to control charging of the battery pack 1100. In one example embodiment, the battery charger may be a corded charger that is configured to deliver power to one or more of the battery packs 1100 in the set of battery packs 1100 to recharge the battery packs 1100. In one example embodiment, the battery charger is a single port charger, a charger with more than the two ports, or a multi-port charger. In one example embodiment, the battery charger includes a receptacle for receiving the battery pack 1100 therein. In one example embodiment, the receptacle of the battery charger includes an interface (port) for mating with the battery pack 1100. In one example embodiment, each charger receptacle is configured to receive one removable, rechargeable battery pack 1100 from the set of battery packs 1100. The charger is compatible with each of the battery packs 1100 in the set of battery packs 1100 and is capable of recharging battery packs having a range of nominal voltages.

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Numerous modifications may be made to the example implementations described above. These and other implementations are within the scope of this application.

Although the present patent application has been described in detail for the purpose of illustration, it is to be understood that such detail is solely for that purpose and that the present patent application is not limited to the disclosed example embodiments, but, on the contrary, is intended to cover modifications and equivalent arrangements that are within the spirit and scope of the appended claims. In addition, it is to be understood that the present patent application contemplates that, to the extent possible, one or more features of any example embodiment can be combined with one or more features of any other example embodiment.

What is claimed is:

1. A battery pack, including:
a battery pack housing operably connectable to a power tool;
a cell holder comprising at least a front wall and a rear wall;
at least two pouch-type battery cells disposed in the cell holder, the at least two pouch-type battery cells including a first battery cell and a second battery cell, each of the first battery cell and the second battery cell has a first tab and a second tab;
a set of battery pack terminals electrically connectable to a set of power tool terminals of the power tool and electrically connected to the first battery cell and the second battery cell; and
a lead collection printed circuit board (LCPCB), the LCPCB having an array of LCPCB slots extending from a first side of the LCPCB to a second side of the LCPCB, wherein the tabs of the first battery cell and the second battery cell are received in the array of LCPCB slots, and
wherein the LCPCB is configured to be disposed forward of the front wall of the cell holder and positioned at a predetermined distance, along a longitudinal axis of the battery pack, from the set of battery pack terminals.

2. The battery pack of claim 1, wherein the predetermined distance is in a range from approximately 3.7 mm to approximately 4.5 mm.

3. The battery pack of claim 2, wherein the predetermined distance is in a range from approximately 3.9 mm to approximately 4.3 mm.

4. The battery pack of claim 3, wherein the predetermined distance is approximately 4.1 mm.

5. The battery pack of claim 1, further comprising a battery management system printed circuit board (BMSPCB) that is configured to control the operation of the battery pack,
wherein the BMSPCB includes a first end portion and a second end portion opposing the first end portion, and
wherein the set of battery pack terminals are disposed on the first end portion of the BMSPCB.

6. The battery pack of claim 5, wherein the LCPCB is positioned at a second predetermined distance, along the longitudinal axis of the battery pack, from the first end portion of the BMSPCB.

7. The battery pack of claim 6, wherein the second predetermined distance is same as the predetermined distance,
wherein the second predetermined distance is in a range from approximately 3.7 mm to approximately 4.5 mm.

8. The battery pack of claim 7, wherein the second predetermined distance is in a range from approximately 3.9 mm to approximately 4.3 mm.

9. The battery pack of claim 8, wherein the second predetermined distance is approximately 4.1 mm.

10. The battery pack of claim 9, wherein the second predetermined distance is different from the predetermined distance.

11. The battery pack of claim 1, further comprising a state of charge printed circuit board (SOCPCB) that is configured to determine a state of charge of one or more battery cells in the battery pack, and
wherein the SOCPCB is configured to be disposed forward of the LCPCB and the front wall of the cell holder.

12. The battery pack of claim 11, wherein the SOCPCB and the LCPCB are generally parallel to each other and are separated by a predetermined distance from each other, and
wherein the predetermined distance between the SOCPCB and the LCPCB is in a range from approximately 11.9 mm to approximately 14.5 mm.

13. The battery pack of claim 12, wherein the predetermined distance between the SOCPCB and the LCPCB is in a range from approximately 12.6 mm to approximately 13.9 mm.

14. The battery pack of claim 13, wherein the predetermined distance between the SOCPCB and the LCPCB is approximately 13.2 mm.

15. A battery pack, including:
a battery pack housing operably connectable to a power tool;
at least two pouch-type battery cells disposed in battery pack housing, the at least two pouch-type battery cells including a first battery cell and a second battery cell, each of the first battery cell and the second battery cell has a first tab and a second tab;
a set of battery pack terminals electrically connectable to a set of power tool terminals of the power tool and electrically connected to the first battery cell and the second battery cell;
a lead collection printed circuit board (LCPCB), the LCPCB having an array of LCPCB slots extending from a first side of the LCPCB to a second side of the LCPCB, wherein the tabs of the first battery cell and the second battery cell are received in the array of LCPCB slots;
a state of charge printed circuit board (SOCPCB) configured to determine a state of charge of one or more battery cells in the battery pack; and
a battery management system printed circuit board (BMSPCB) configured to control the operation of the battery pack.

16. The battery pack of claim 15, wherein the SOCPCB is configured to be disposed forward of the LCPCB;
wherein the SOCPCB and the LCPCB are generally parallel to each other and are separated by a predetermined distance from each other, and
wherein the predetermined distance between the SOCPCB and the LCPCB is in a range from approximately 11.9 mm to approximately 14.5 mm.

17. The battery pack of claim 16, wherein the predetermined distance between the SOCPCB and the LCPCB is in a range from approximately 12.6 mm to approximately 13.9 mm.

18. The battery pack of claim 17, wherein the predetermined distance between the SOCPCB and the LCPCB is approximately 13.2 mm.

19. The battery pack of claim 15, wherein the SOCPCB and the LCPCB are generally parallel to each other and are perpendicular to the BMSPCB.

20. The battery pack of claim 15, wherein the BMSPCB includes a first end portion and a second end portion opposing the second end portion, and
wherein the set of battery pack terminals are disposed on the first end portion of the BMSPCB.

21. The battery pack of claim 20, wherein the LCPCB is positioned at a predetermined distance, along a longitudinal axis of the battery pack, from the first end portion of the BMSPCB.

22. The battery pack of claim 21, wherein the predetermined distance is in a range from approximately 3.7 mm to approximately 4.5 mm.

23. The battery pack of claim 22, wherein the predetermined distance is in a range from approximately 3.9 mm to approximately 4.3 mm.

24. The battery pack of claim 23, wherein the predetermined distance is approximately 4.1 mm.
